(19) United States
(12) Patent Application Publication
(10) Pub. No.: US 2019/0347569 A1
(43) Pub. Date: Nov. 14, 2019

(54) NEGOTIATION SYSTEM

(71) Applicant: ECHELON MARKETS INC., Wilmington, DE (US)

(72) Inventors: Craig Allen Breed, New York, NY (US); Michael Thomas Walterman, St. George, UT (US)

(21) Appl. No.: 16/294,318

(22) Filed: Mar. 6, 2019

Related U.S. Application Data
(63) Continuation of application No. 15/402,168, filed on Jan. 9, 2017, now abandoned.
(60) Provisional application No. 62/276,825, filed on Jan. 9, 2016.

(51) Int. Cl. G06N 20/00; G06Q 50/18

(52) U.S. Cl. CPC G06N 20/00; G06Q 50/188

(57) ABSTRACT

A computer system that creates a deal space graphical user interface which is particular to each negotiation and displays on a 2-dimensional graph the degree of satisfaction for each side for all possible deal structures is provided. The deal space system provided shows how to simultaneously alter agreement terms to increase overall satisfaction for each side, making it easy for a user to see win-win tradeoffs.

### CROSS-REFERENCE TO RELATED APPLICATIONS

This application is a continuation of U.S. application Ser. No. 15/402,168 filed Jan. 9, 2017; which claims the benefit of U.S. Provisional Application No. 62/276,825, filed Jan. 9, 2016, the disclosures of which are hereby incorporated by reference in their entireties.

### BACKGROUND

People negotiate all over the world about many things and with many objectives. Most common negotiations are simple and about only one issue—price. However, there exists a group of complex negotiations that involve a multitude of issues. These multi-faceted negotiations typically occur in business contexts where multiple factors interact.

As the number of issues in a negotiation increases, the possible ways the final agreement could be struck increases rapidly. With just three issues, the number is already beyond human computational ability resulting in inefficiencies. For example, there are currently large inefficiencies in negotiated private capital markets, as reflected in their lower pricing multiples compared to those of public markets. This inefficiency is due in part to poor information functioning and ability to create efficient transaction structures. Human negotiators are not able to converse quickly and sufficiently well to fully explore and find all the tradeoffs they would both have no reason to not jointly pursue.

What is needed in the art of negotiation is a negotiation playing computer system that advises a negotiator as they conduct their negotiation in order to obtain a better outcome than possible using human skills alone.

### SUMMARY OF THE INVENTION

In general, the foregoing and other objects are achieved with the invention as follows:

In one aspect, the invention is in a computer system that creates a deal space graphical user interface which is particular to each negotiation and displays on a 2-dimensional graph the degree of satisfaction for each side for all possible deal structures. Said deal space shows how to simultaneously alter agreement terms to increase overall satisfaction for each side, making it easy for a user to see win-win tradeoffs more easily.

In another aspect, the invention is in a computer system that creates a deal dashboard graphical user interface which gives a user control and understanding over their negotiation position at any point of the negotiation. The deal dashboard is capable of suggesting bidding strategies, and presents strategies the counter-party is unlikely to understand, and therefore unlikely to effectively counter or recognize. The deal dashboard in a further aspect provides advance prediction of a counter-party's moves allowing user to plan in advance. In a still further aspect, the deal space displays the interest efficient frontier where all win-win tradeoffs are incorporated. Preferably, agreements lie along or close to the interest efficient frontier.

In yet further aspects, bidding strategies are suggested and preferably include staying out of the avoidable zone and terrain leveraging in ratchet bidding.

In an additional aspect the invention is in a computer system that provides a negotiating advantage when used by one party. Furthermore, when used collaboratively the computer system provides interest efficient transactions.

### BRIEF DESCRIPTION OF THE DRAWINGS

FIGS. 1A and 1B are depictions of the deal space in accordance with an embodiment of the present invention.

FIGS. 2A and 2B are depictions of bid projections in accordance with an embodiment of the present invention.

FIG. 3 is a depiction of deal space utility plots in accordance with an embodiment of the present invention.

FIG. 4 is a depiction of the handling of inefficient counter bids in accordance with an embodiment of the present invention.

FIG. 5 is a depiction of the avoidable zone in accordance with an embodiment of the present invention.

FIG. 6 is a depiction of the ratchet bidding strategy in accordance with an embodiment of the present invention.

FIG. 7 is a depiction of deal space utility plots in accordance with an embodiment of the present invention.

FIG. 8 is a depiction of two phase negotiation process in accordance with an embodiment of the present invention.

FIG. 9 is a depiction of a general overview of a negotiation strategy in accordance with an embodiment of the present invention.

FIG. 10 is a depiction of concessions and bidding in accordance with an embodiment of the present invention.

FIG. 11 is a depiction of the zone of possible agreement (ZOPA) and value creation in accordance with an embodiment of the present invention.

FIG. 12 is a depiction of bidding objectives in accordance with an embodiment of the present invention.

FIG. 13 is a depiction of game theory as applied in accordance with an embodiment of the present invention.

FIG. 14 is a depiction of ways to improve deals in accordance with an embodiment of the present invention.

FIG. 15 is a depiction of ways to improve deals in accordance with an embodiment of the present invention.

FIG. 16 is a depiction of deal cloud width (weightings and issues) in accordance with an embodiment of the present invention.

FIG. 17 is a depiction of subset agreement in accordance with an embodiment of the present invention.

FIG. 18 is a depiction of interior point, moving to frontier, and dividing value in accordance with an embodiment of the present invention.

FIG. 19 is a depiction of the internal rate of return mapping into utility and opportunity space in accordance with an embodiment of the present invention.

FIG. 20 is a depiction of fear and greed theory in accordance with an embodiment of the present invention.

FIG. 21 is a depiction of trust theory in accordance with an embodiment of the present invention.

FIG. 22 is a depiction of theories in accordance with an embodiment of the present invention.

FIG. 23 is a depiction of a tie between auctions and negotiations graphs in accordance with an embodiment of the present invention.

FIG. 24 is a depiction of negotiation auctions in accordance with an embodiment of the present invention.

FIG. 25 is a depiction of auction algorithms in accordance with an embodiment of the present invention.

FIG. 26 is a depiction of auction algorithms in accordance with an embodiment of the present invention.

FIG. 27 is a depiction of value driven by markets in accordance with an embodiment of the present invention.

FIG. 28 is a depiction of strategic dispositions in accordance with an embodiment of the present invention.

FIG. 29 is a depiction of private ordering in accordance with an embodiment of the present invention.

FIG. 30 is a depiction of market failure in accordance with an embodiment of the present invention.

FIG. 31 is a depiction of hybrid market in accordance with an embodiment of the present invention.

FIG. 32 is a depiction of subjective markets in accordance with an embodiment of the present invention.

FIG. 33 is a depiction of a strategic buyer's exchange in accordance with an embodiment of the present invention.

FIG. 34 is a depiction of artificial morality in accordance with an embodiment of the present invention.

FIG. 35 is a depiction of inductive steps in accordance with an embodiment of the present invention.

FIG. 36 is a depiction of negotiation prediction in accordance with an embodiment of the present invention.

FIGS. 37A and 37B are depictions of using forecast deals in accordance with an embodiment of the present invention.

FIG. 38 is a depiction of integrative bargaining in accordance with an embodiment of the present invention.

FIG. 39 is a depiction of concession logic in accordance with an embodiment of the present invention.

FIG. 40 is a depiction of kinked utility curves in accordance with an embodiment of the present invention.

FIG. 41 is a depiction of points and bargaining insights in accordance with an embodiment of the present invention.

FIG. 42 is a depiction of negotiation flow in accordance with an embodiment of the present invention.

FIG. 43 is a depiction of integrative bargaining in accordance with an embodiment of the present invention.

FIG. 44 is a depiction of persuasion on reservation in accordance with an embodiment of the present invention.

FIG. 45 is a depiction of fairness in accordance with an embodiment of the present invention.

FIG. 46 is a depiction of levels of negotiation in accordance with an embodiment of the present invention.

FIG. 47 is a depiction of overall negotiation flow in accordance with an embodiment of the present invention.

FIG. 48 is a depiction of intermediary engagement to marketing a seller client in accordance with an embodiment of the present invention.

FIG. 49 is a depiction of buyer assessment and negotiation preparation in accordance with an embodiment of the present invention.

FIG. 50 is a depiction of buyer assessment and negotiation preparation in accordance with an embodiment of the present invention.

FIG. 51 is a depiction of negotiation flows in accordance with an embodiment of the present invention.

FIG. 52 is a depiction of the opening bids process in accordance with an embodiment of the present invention.

FIG. 53 is a depiction of bidding in accordance with an embodiment of the present invention.

FIGS. 54A and 54B are depictions of considered economic reality (CER) in accordance with an embodiment of the present invention.

FIG. 55 is a depiction of considered economic reality (CER) in accordance with an embodiment of the present invention.

FIGS. 56A and 56B are depictions of a communication game in accordance with an embodiment of the present invention.

FIG. 57 is a depiction of reflective equilibrium in accordance with an embodiment of the present invention.

FIG. 58 is a depiction of a strategic game overview in accordance with an embodiment of the present invention.

FIG. 59 is a depiction of integrative bargaining in accordance with an embodiment of the present invention.

FIG. 60 is a depiction of a strategic rationality system in accordance with an embodiment of the present invention.

FIG. 61 is a depiction of integrative bargaining in accordance with an embodiment of the present invention.

FIG. 62 is a depiction of intentions, goals and commitments in accordance with an embodiment of the present invention.

FIG. 63 is a depiction of distributive bargaining rules in accordance with an embodiment of the present invention.

FIG. 64 is a depiction of distributive bargaining in accordance with an embodiment of the present invention.

FIG. 65 is a depiction of distributive bargaining in accordance with an embodiment of the present invention.

FIG. 66 is a depiction of effective behavior in accordance with an embodiment of the present invention.

FIG. 67 is a depiction of bargaining in accordance with an embodiment of the present invention.

FIG. 68 is a depiction of learning in accordance with an embodiment of the present invention.

FIG. 69 is a depiction of application of CER in accordance with an embodiment of the present invention.

FIG. 70 is a depiction of joint reasoning in accordance with an embodiment of the present invention.

FIG. 71 is a depiction of handling difficult opponents in accordance with an embodiment of the present invention.

FIG. 72 is a depiction of state of nature versus cooperative deal society in accordance with an embodiment of the present invention.

FIG. 73 is a depiction of discount factors in accordance with an embodiment of the present invention.

FIG. 74 is a depiction of the economics of bisecting the middle M&A market in accordance with an embodiment of the present invention.

FIG. 75 is a depiction of cooperation network factors in accordance with an embodiment of the present invention.

FIG. 76 is a depiction of methods of closing an initial agreement gap in accordance with an embodiment of the present invention.

FIG. 77 is a depiction of a collaborative networked market in accordance with an embodiment of the present invention.

FIG. 78 is a depiction of matrices concerning fear and greed in accordance with an embodiment of the present invention.

FIG. 79 is a depiction of a transition from a deal space to a matrix in accordance with an embodiment of the present invention.

FIGS. 80A-80E are depictions of paired pathways in accordance with an embodiment of the present invention.

FIG. 81 is a depiction of paired pathways in accordance with an embodiment of the present invention.

FIG. 82 is a depiction of bidding paths in accordance with an embodiment of the present invention.

FIG. 83 is a depiction of a slider tool in accordance with an embodiment of the present invention.

FIG. 84 is a depiction of paired pathways in accordance with an embodiment of the present invention.

FIG. 85 is a depiction of a transition from a matrix to a tree in accordance with an embodiment of the present invention.

FIG. 86 is a depiction of tree nodes in accordance with an embodiment of the present invention.

FIG. 87 is a depiction of efficiency gain in accordance with an embodiment of the present invention.

FIG. 88 is a depiction of transition from a matrix to a tree in accordance with an embodiment of the present invention.

FIG. 89 is a depiction of fear and greed driven games in accordance with an embodiment of the present invention.

FIG. 90 is a depiction of an expected expanding frontier in accordance with an embodiment of the present invention.

FIG. 91 is a depiction of suggested bid cases in accordance with an embodiment of the present invention.

FIG. 92 is a depiction of negotiation reasoning in accordance with an embodiment of the present invention.

FIG. 93 is a depiction of derivatives in accordance with an embodiment of the present invention.

FIG. 94 is a depiction of ZOPA and two bid points in accordance with an embodiment of the present invention.

FIG. 95 is a depiction of movement logic in accordance with an embodiment of the present invention.

FIG. 96 is a depiction of movement strategy in accordance with an embodiment of the present invention.

FIG. 97 is a depiction of an index to a game theory in accordance with an embodiment of the present invention.

FIG. 98 is a depiction of a party's attempt to convince another in accordance with an embodiment of the present invention.

FIG. 99 is a depiction of comparing theories for bringing norms into solutions of prisoner's dilemma in accordance with an embodiment of the present invention.

FIG. 100 is a depiction of a transaction example in accordance with an embodiment of the present invention.

FIG. 101 is a depiction of transaction example in accordance with an embodiment of the present invention.

FIG. 102 is a depiction of transaction example in accordance with an embodiment of the present invention.

FIGS. 103A and 103B are depictions of transaction example in accordance with an embodiment of the present invention.

FIG. 104 is a depiction of transaction example in accordance with an embodiment of the present invention.

FIGS. 105A and 105B are depictions of transaction example in accordance with an embodiment of the present invention.

FIG. 106 is a depiction of transaction example in accordance with an embodiment of the present invention.

FIG. 107 is a depiction of transaction example in accordance with an embodiment of the present invention.

FIG. 108 is a depiction of transaction example in accordance with an embodiment of the present invention.

FIG. 109 is a depiction of transaction example in accordance with an embodiment of the present invention.

FIG. 110 is a depiction of transaction example in accordance with an embodiment of the present invention.

FIG. 111 is a depiction of transaction example in accordance with an embodiment of the present invention.

FIG. 112 is a depiction of transaction example in accordance with an embodiment of the present invention.

FIG. 113 is a depiction of transaction example in accordance with an embodiment of the present invention.

FIGS. 114A and 114B are depictions of preference sensitivity in accordance with an embodiment of the present invention.

FIG. 115 is a depiction of preference sensitivity in accordance with an embodiment of the present invention.

FIG. 116 is a depiction of preference sensitivity in accordance with an embodiment of the present invention.

FIG. 117 is a depiction of preference sensitivity in accordance with an embodiment of the present invention.

FIG. 118 is a depiction of the avoidable zone in accordance with an embodiment of the present invention.

FIG. 119 is a depiction of ratchet bidding strategy in accordance with an embodiment of the present invention.

FIG. 120 is a depiction of a two phase negotiating process in accordance with an embodiment of the present invention.

FIG. 121 is a depiction of a negotiation strategy in accordance with an embodiment of the present invention.

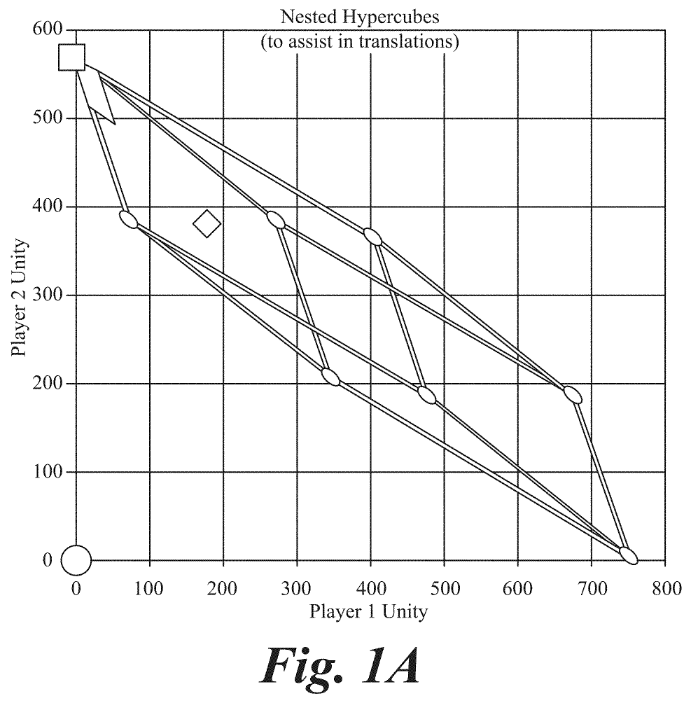

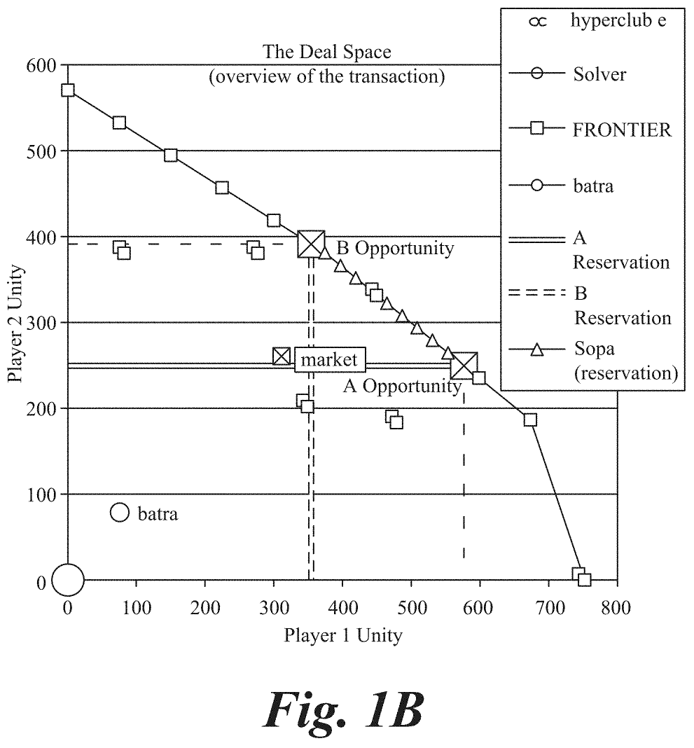

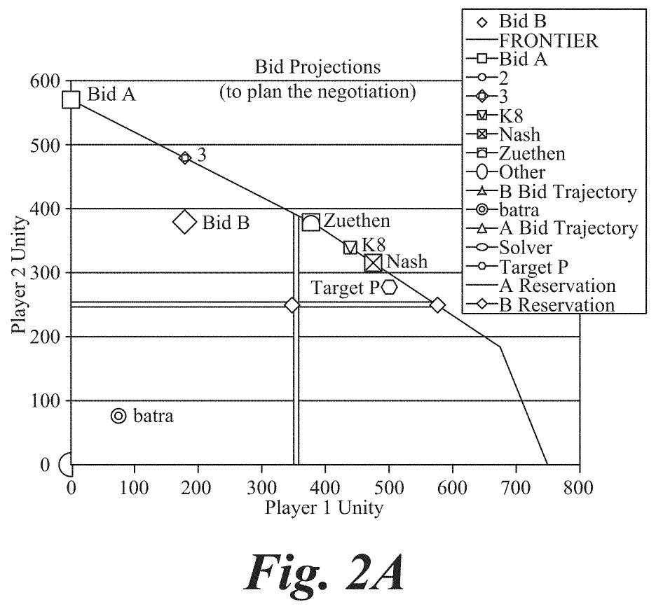

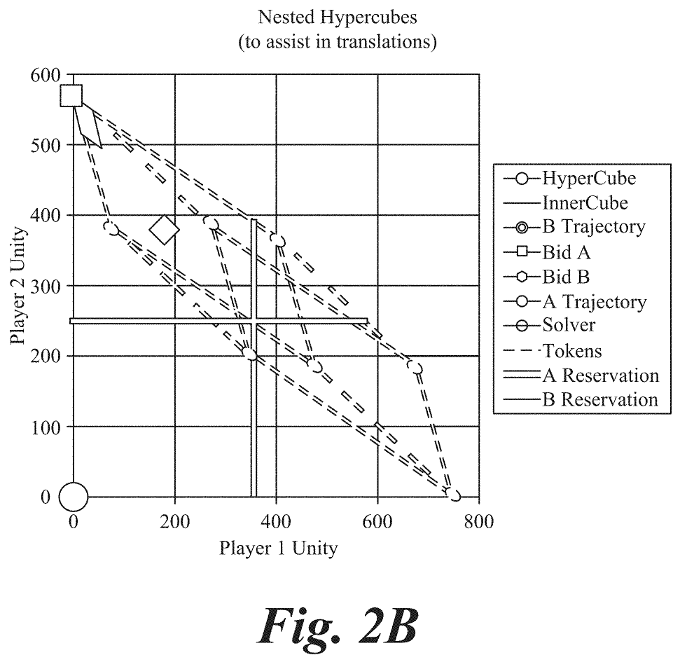

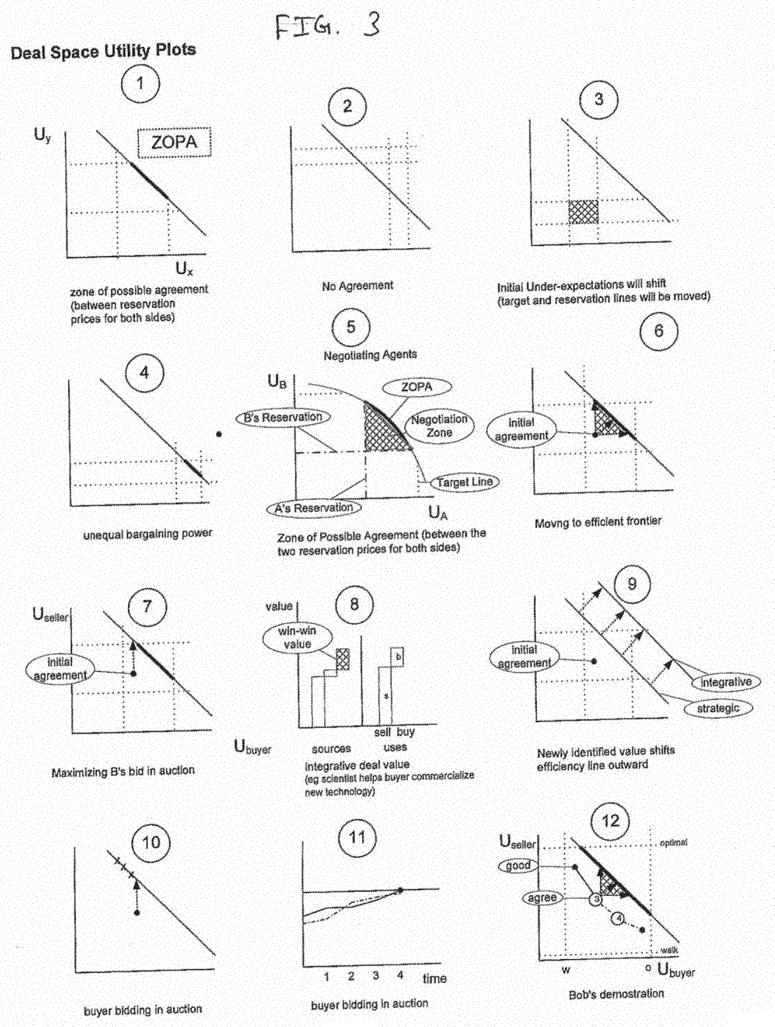

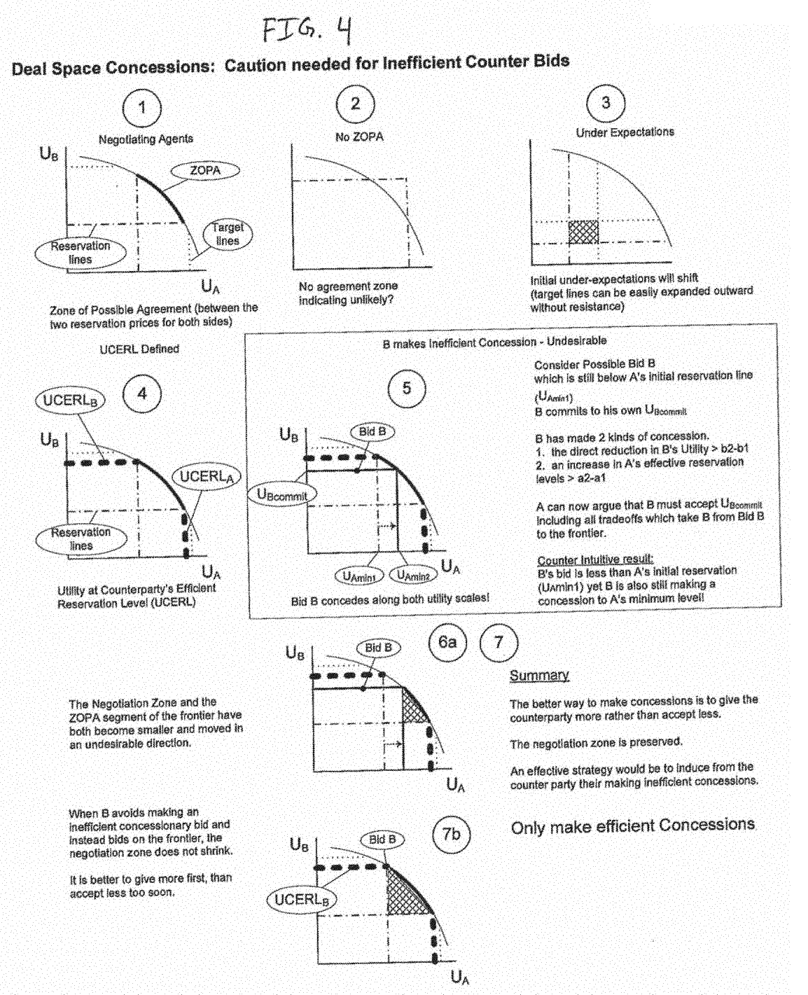

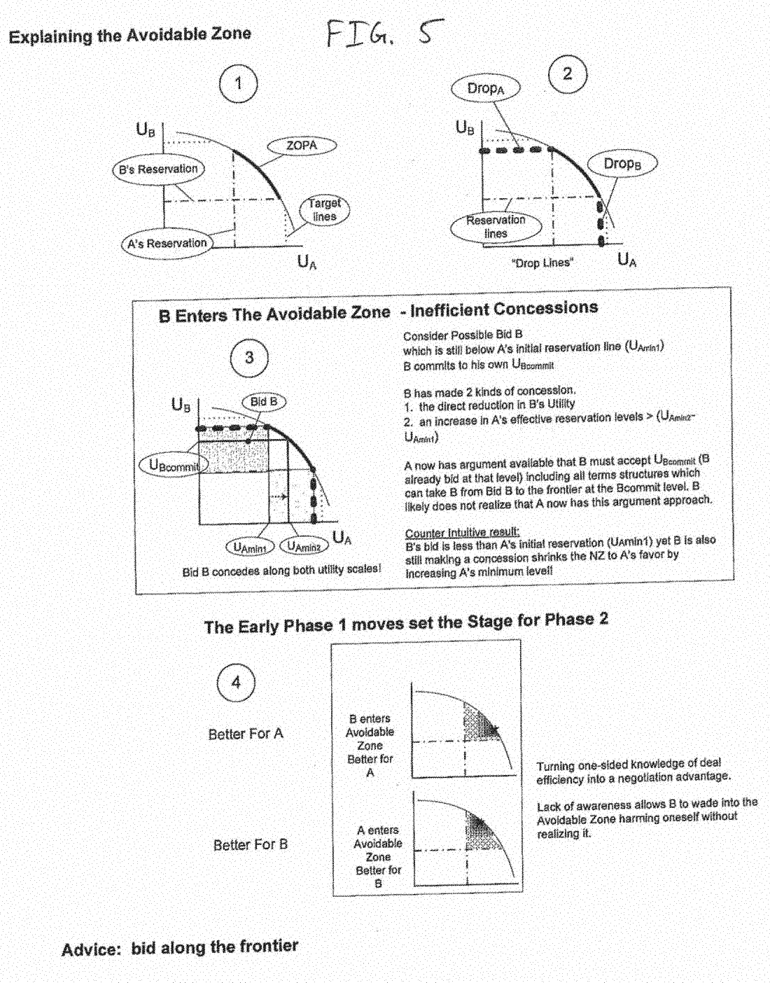

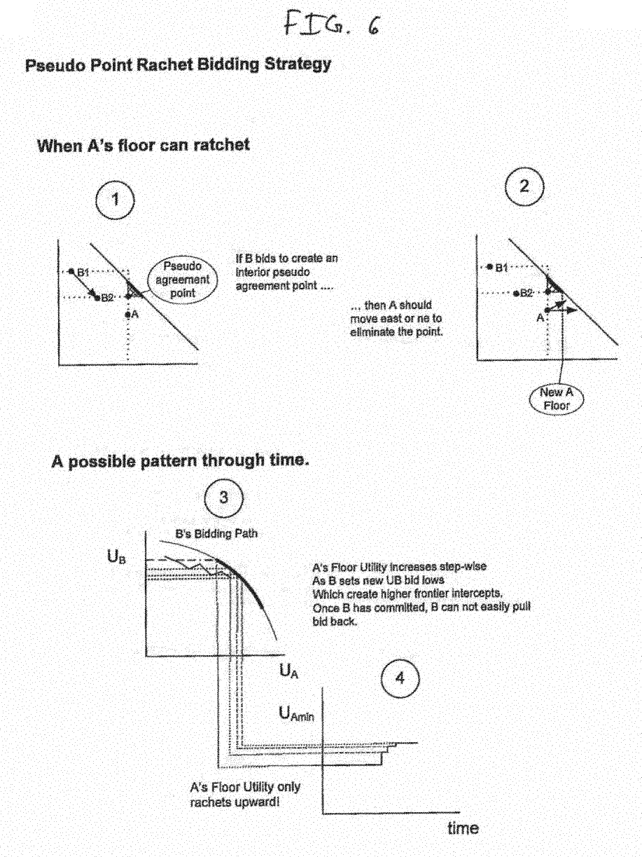

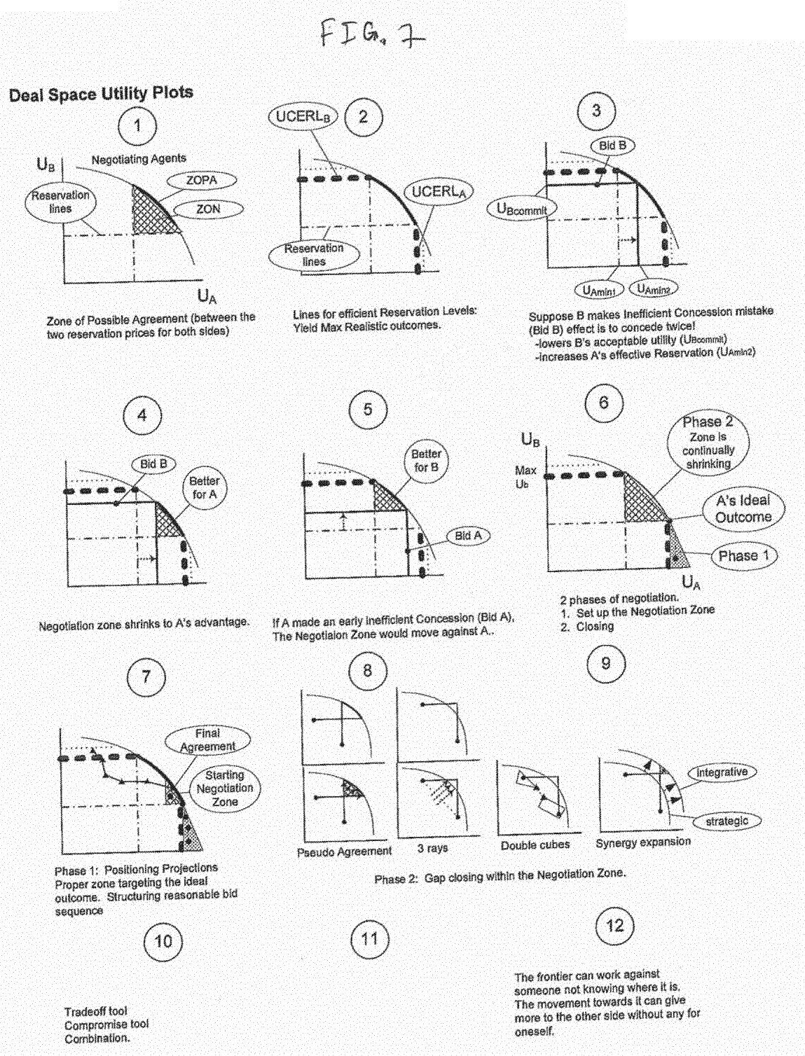

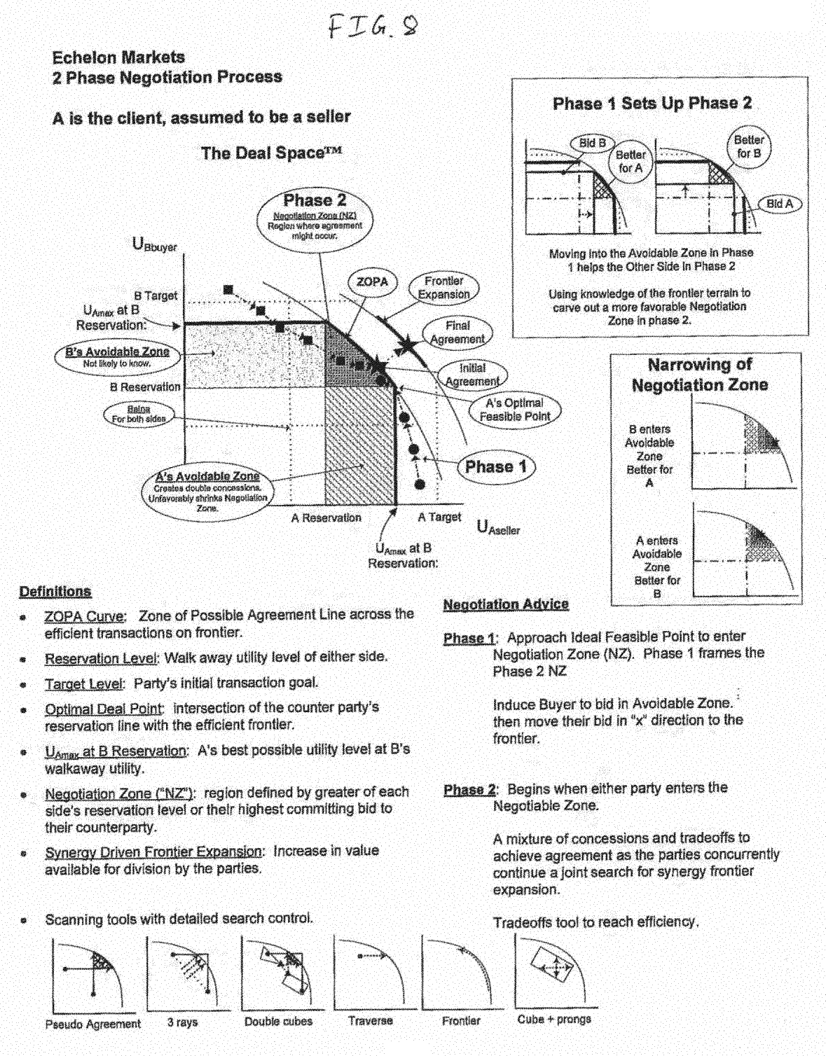

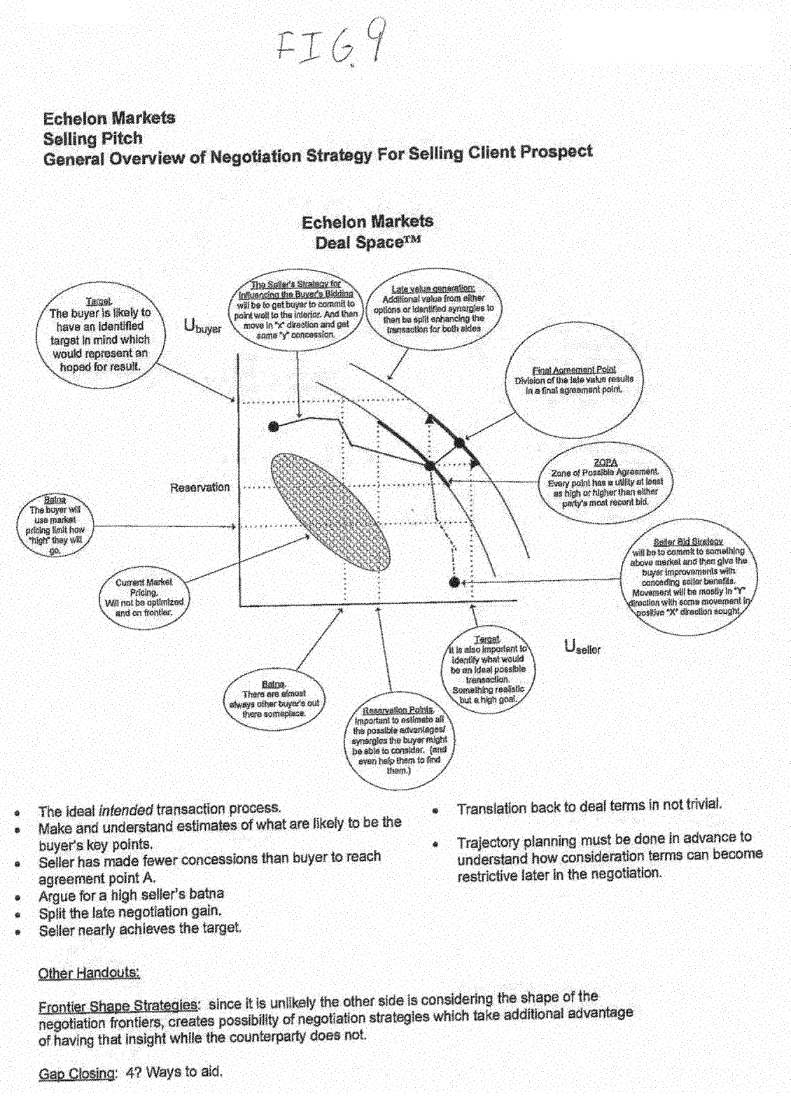

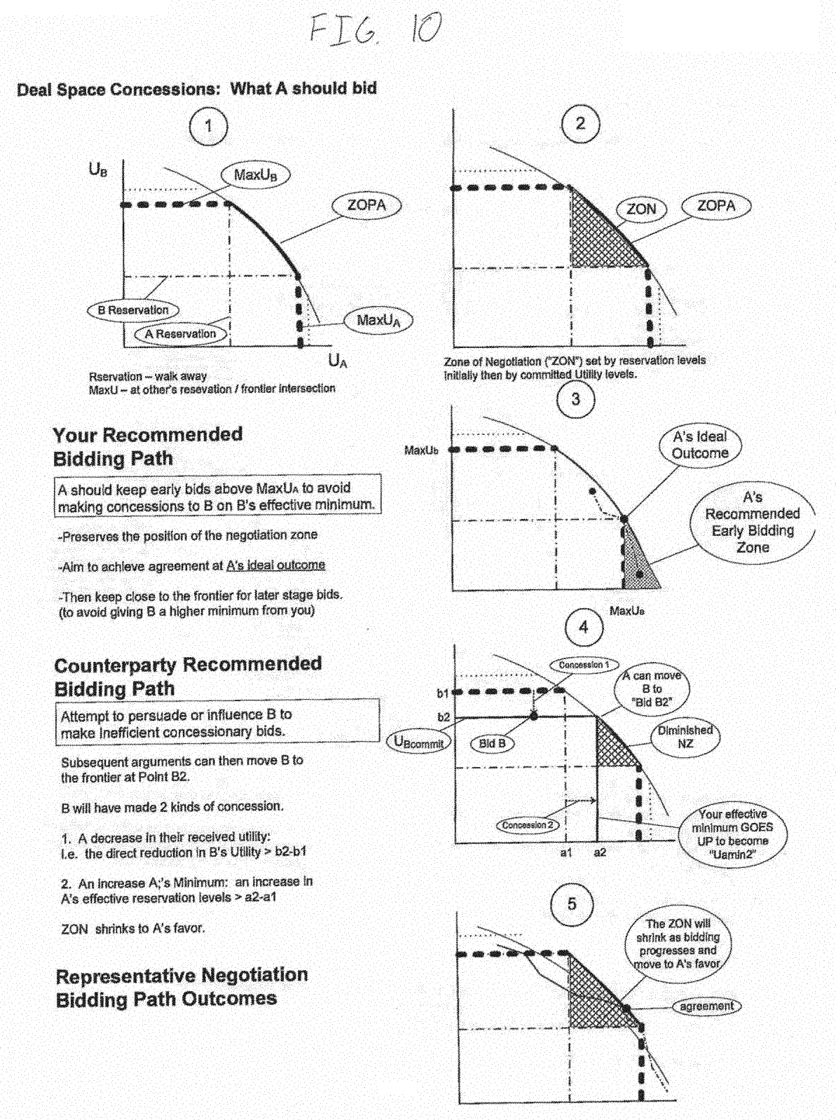

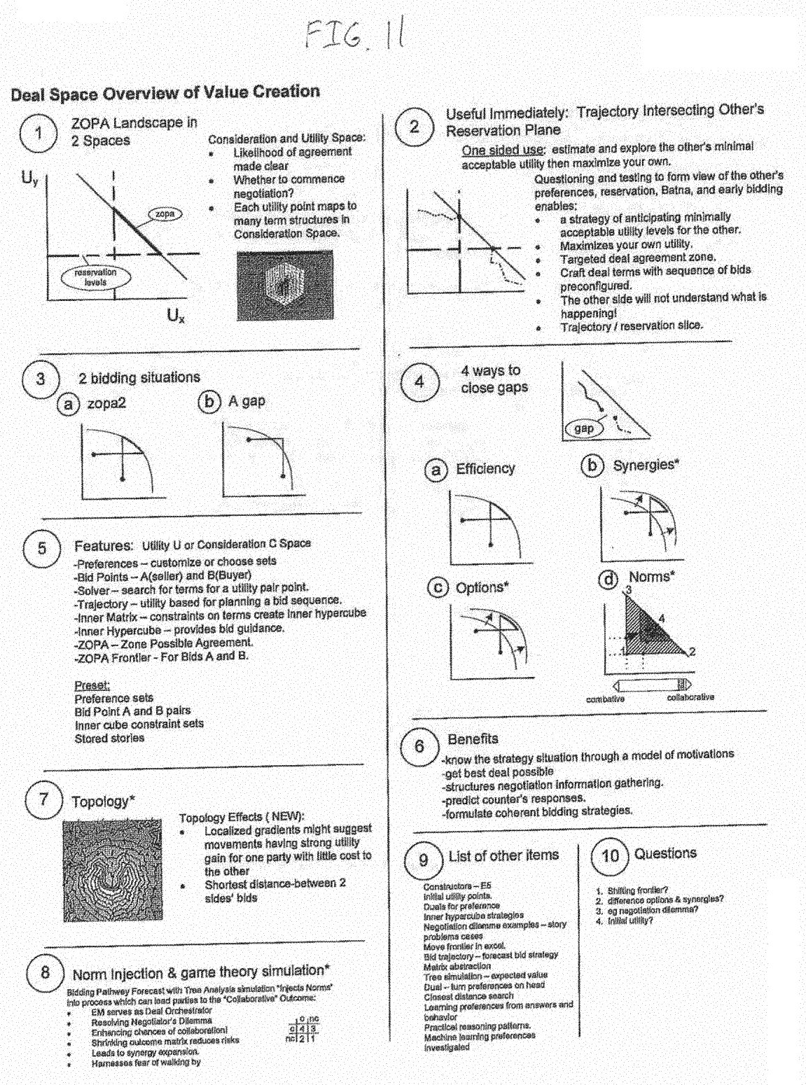

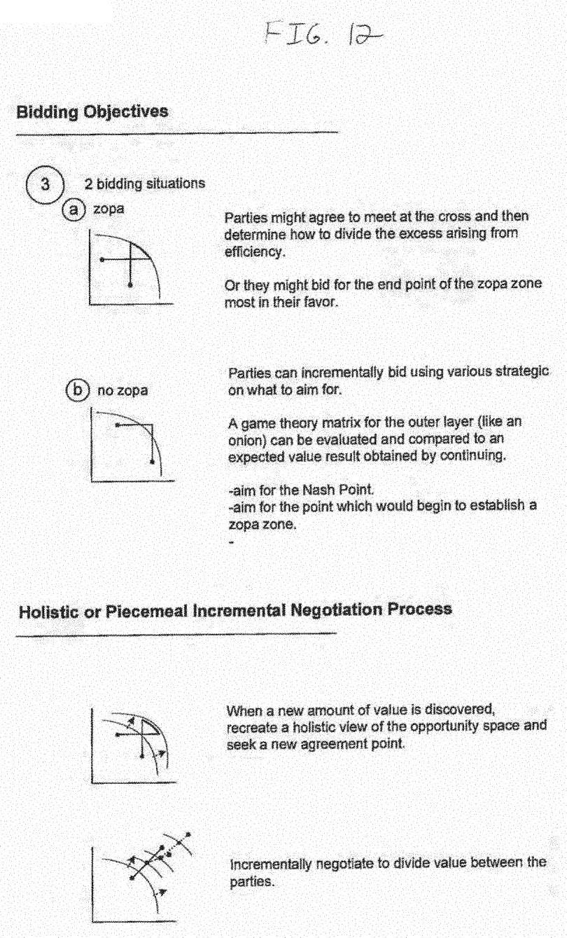

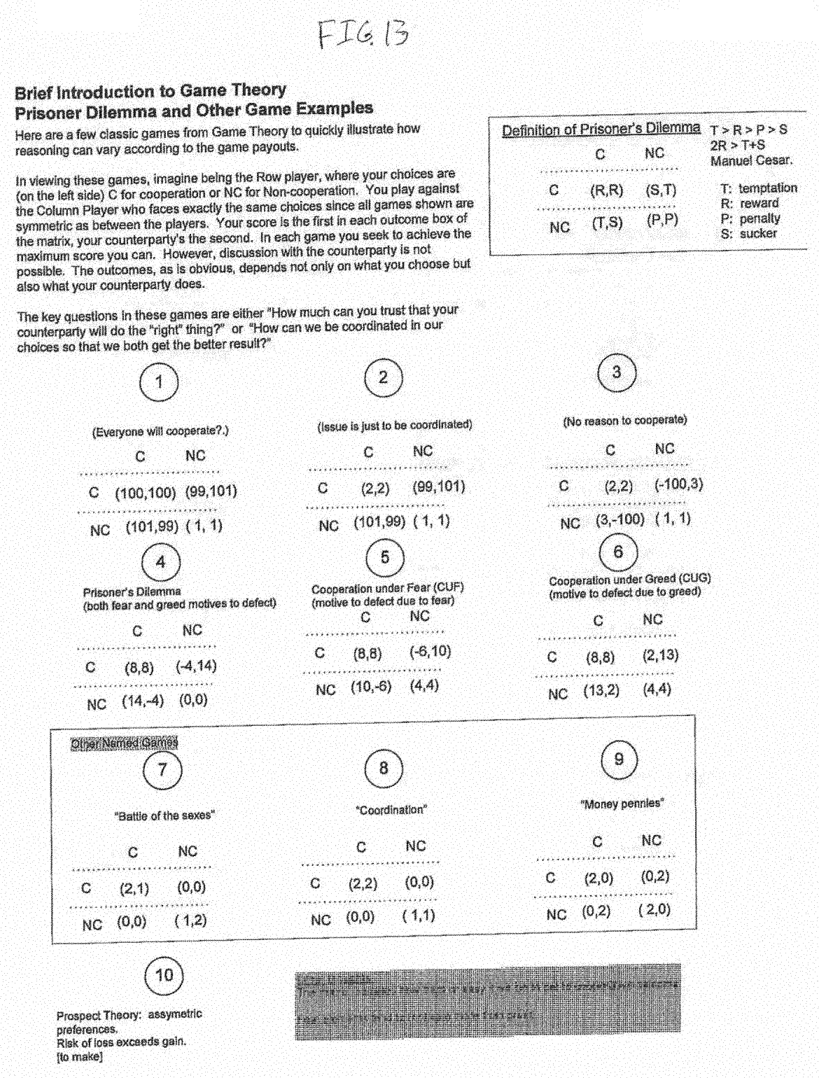

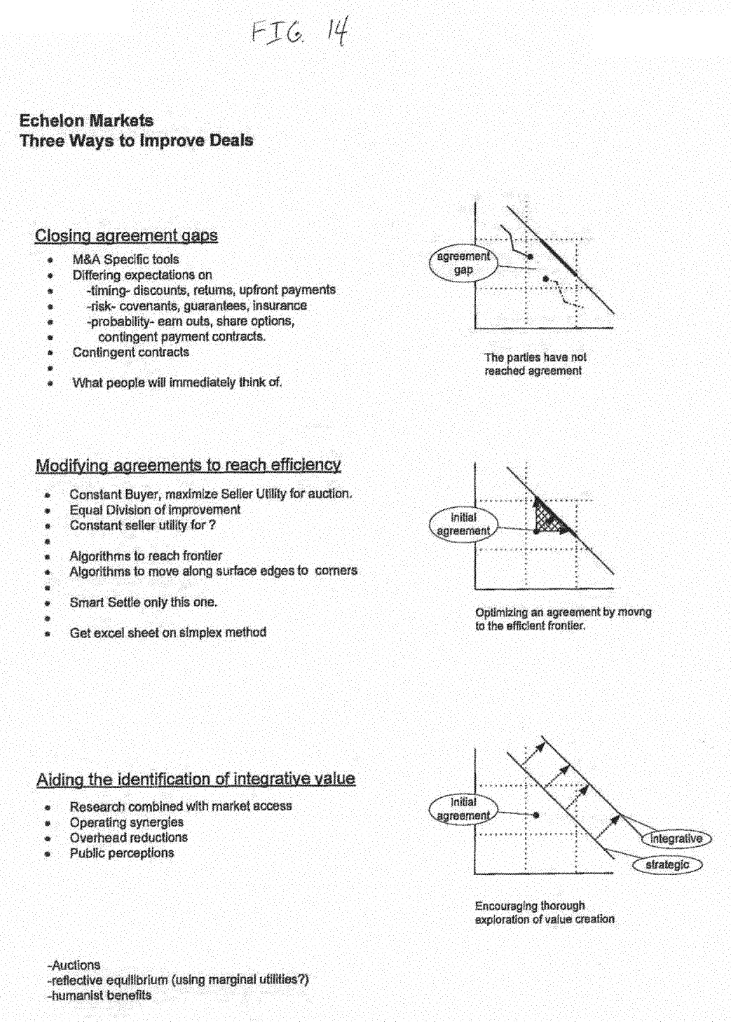

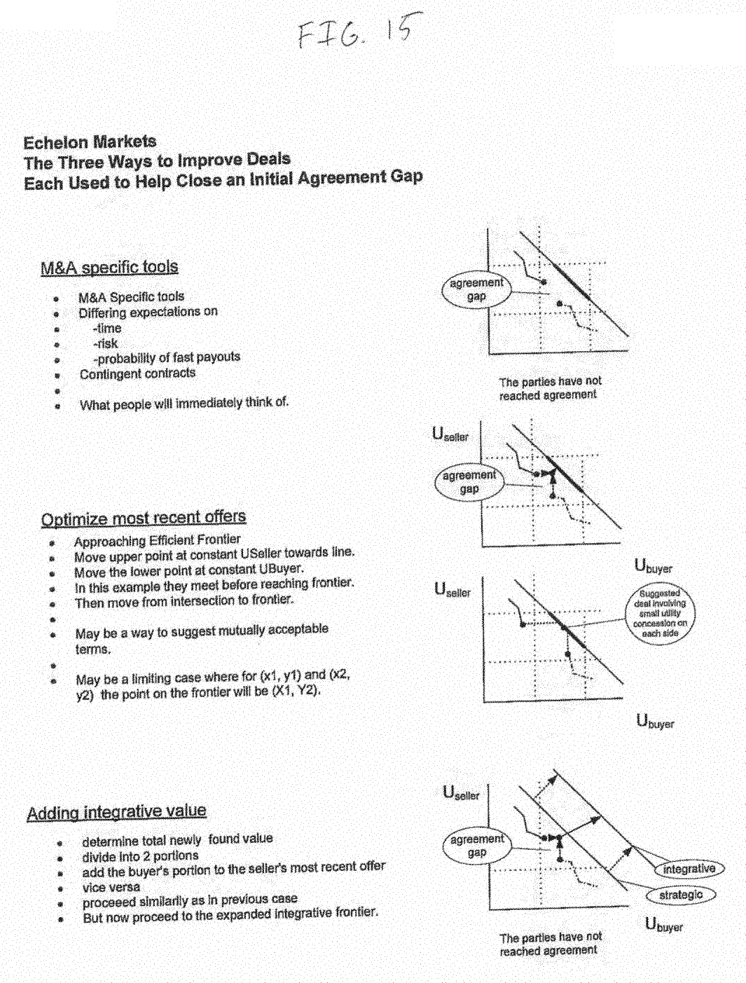

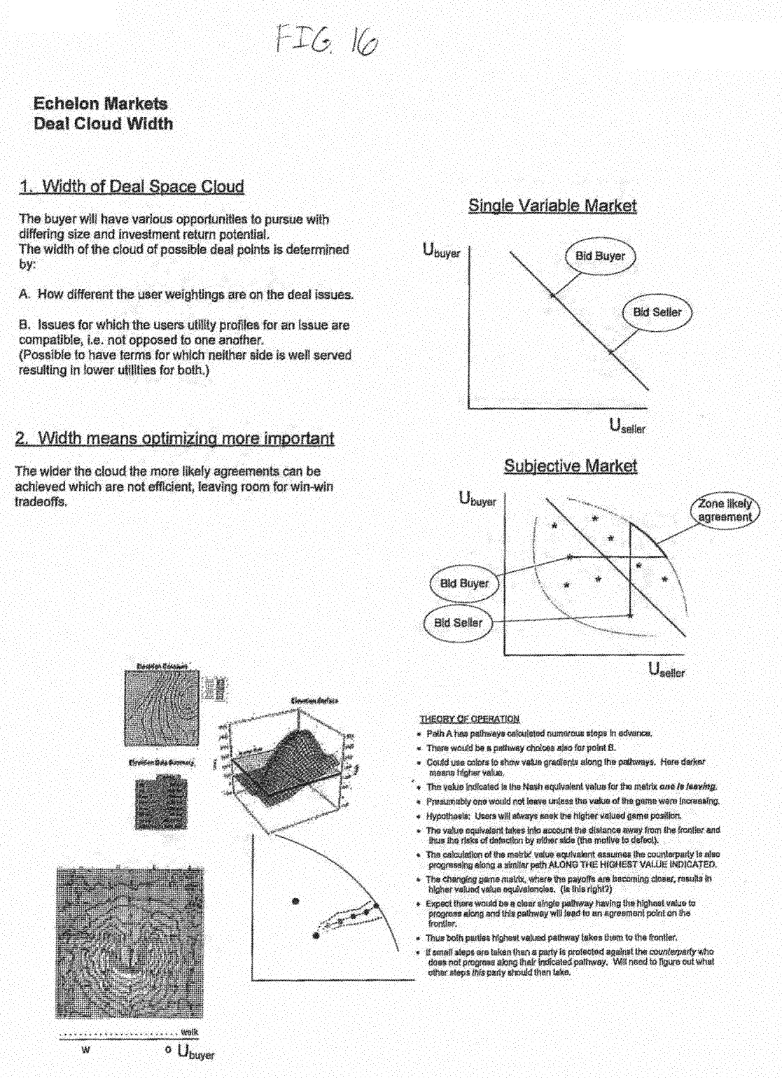

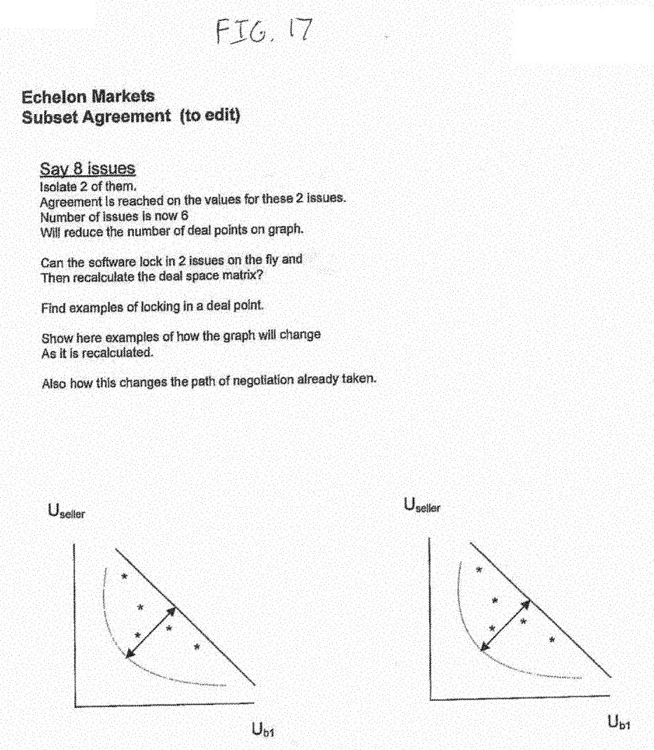

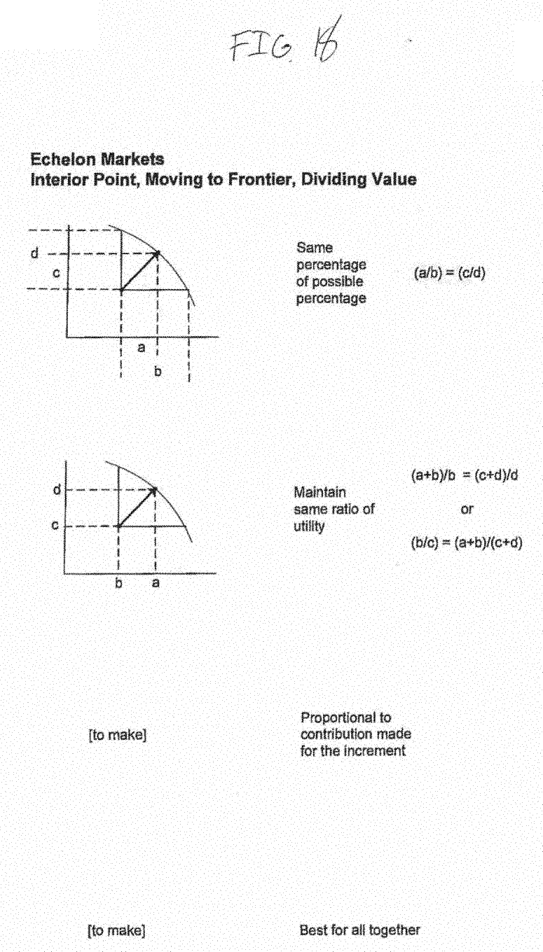

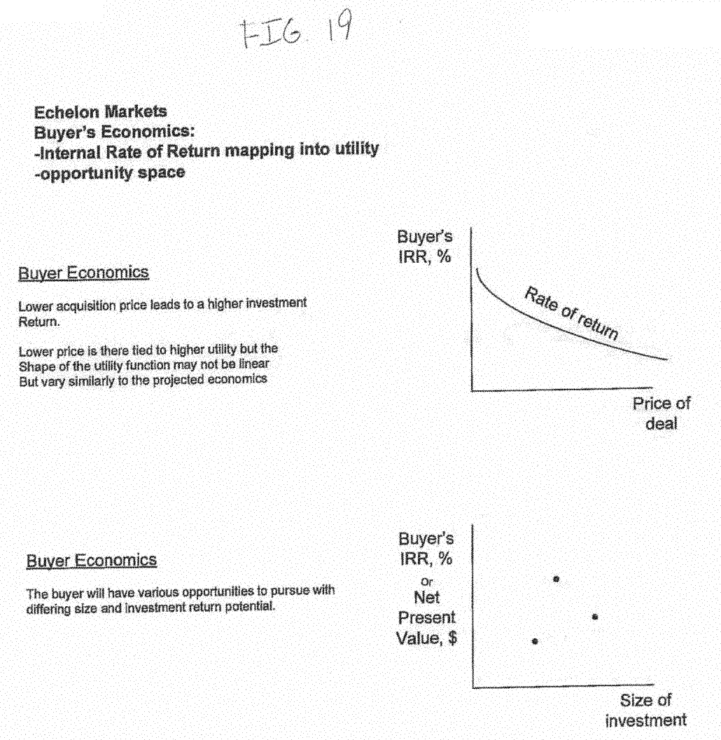

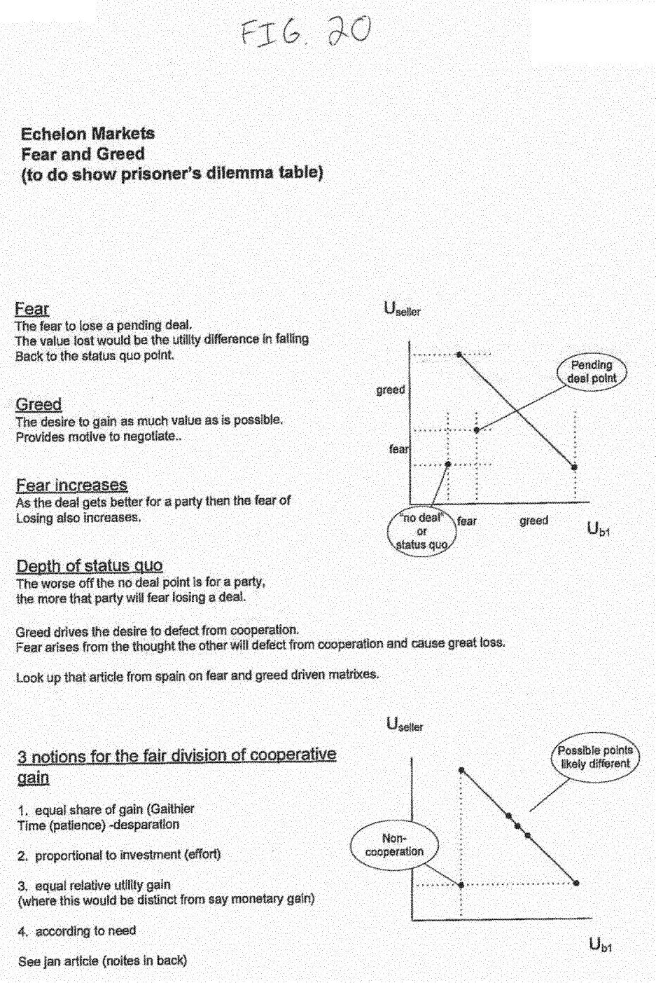

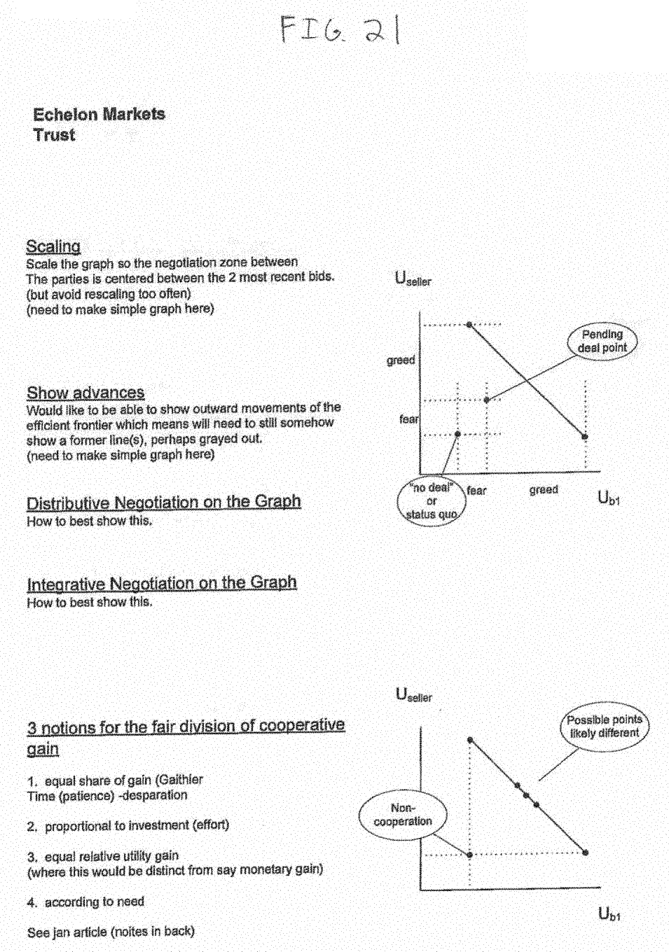

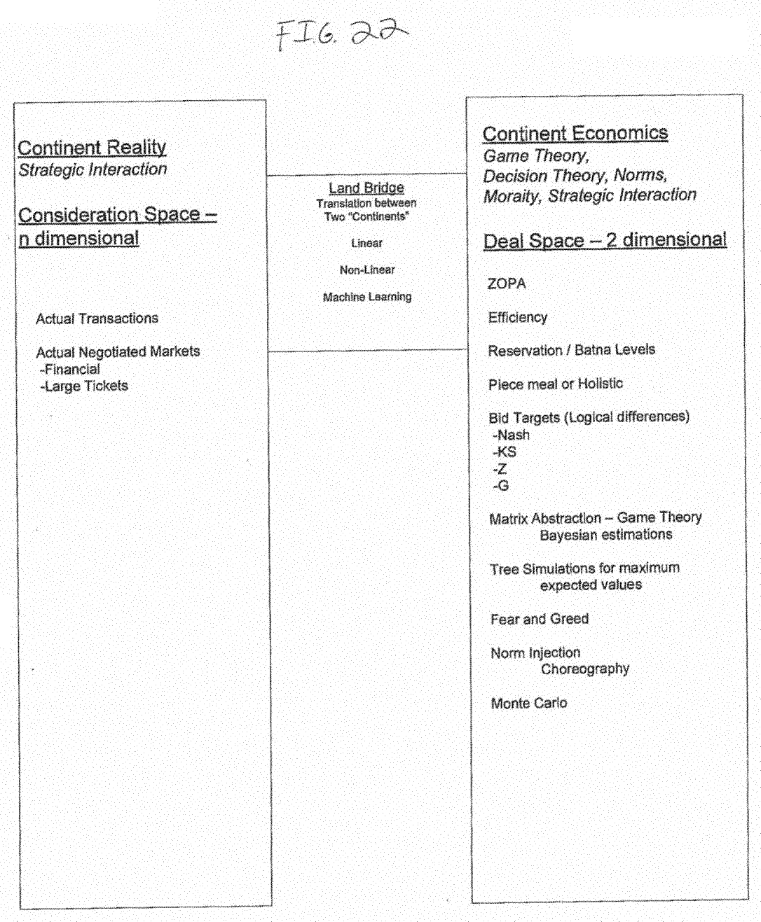

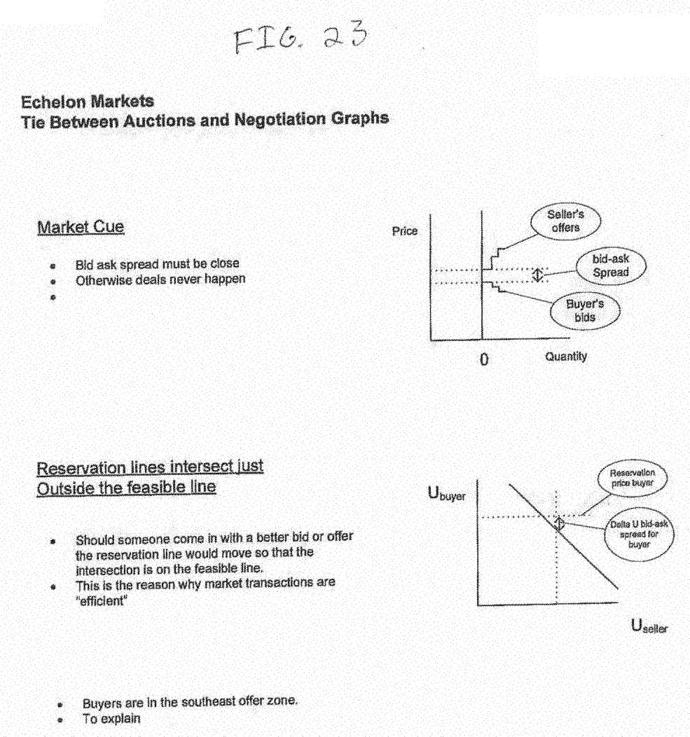

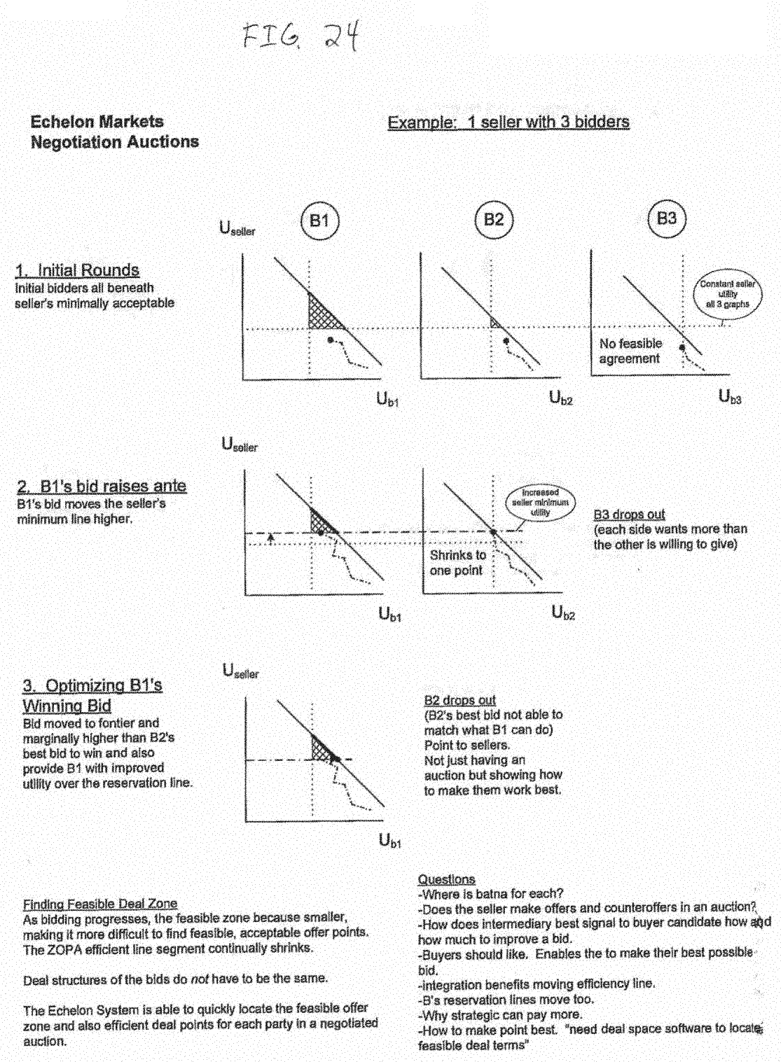

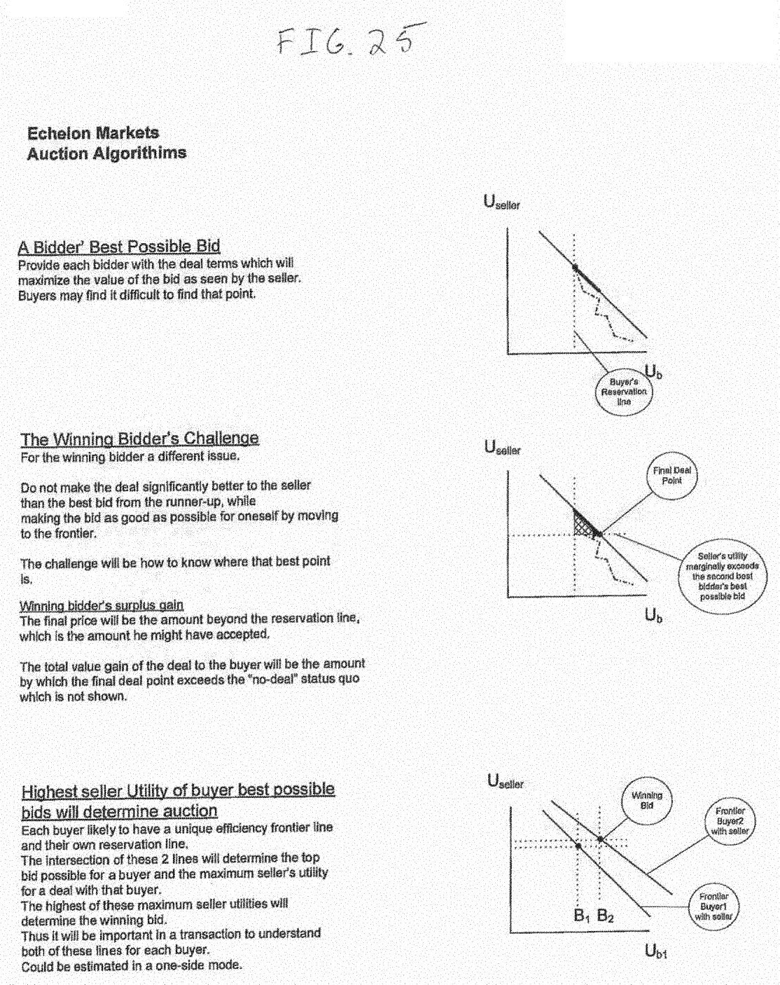

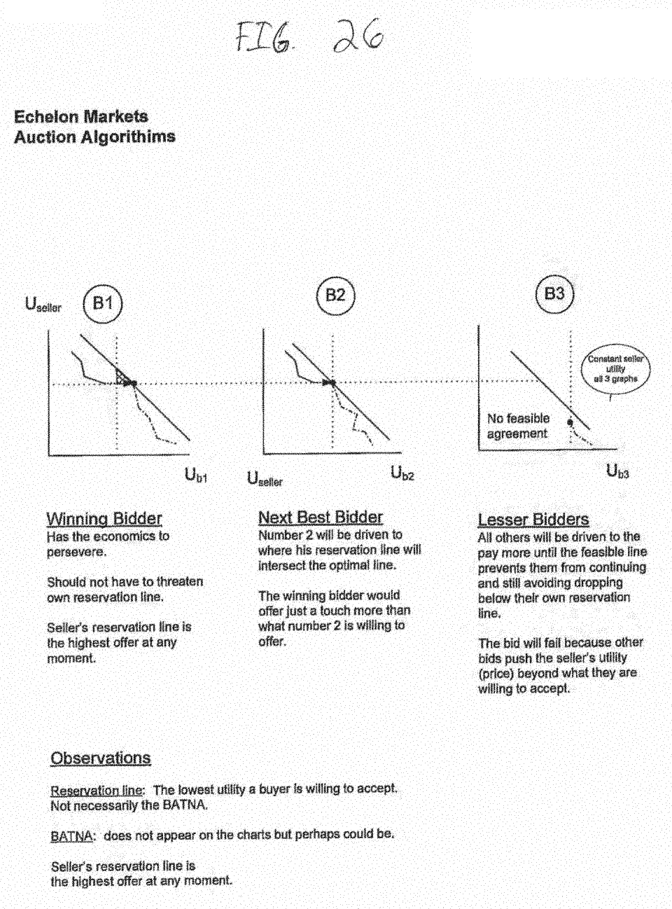

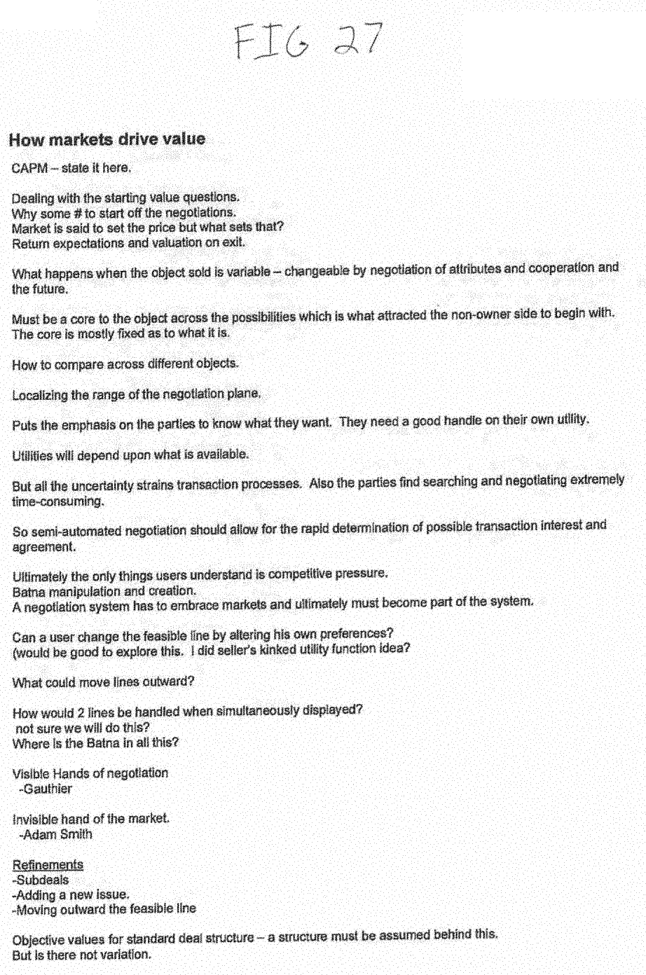

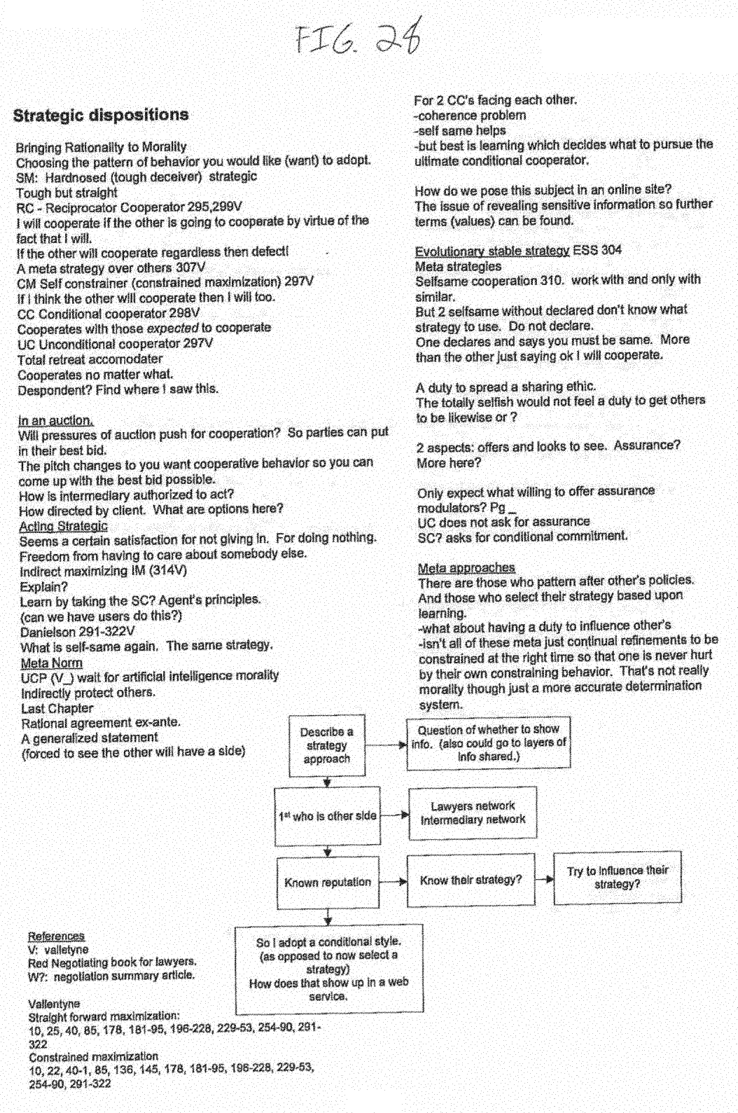

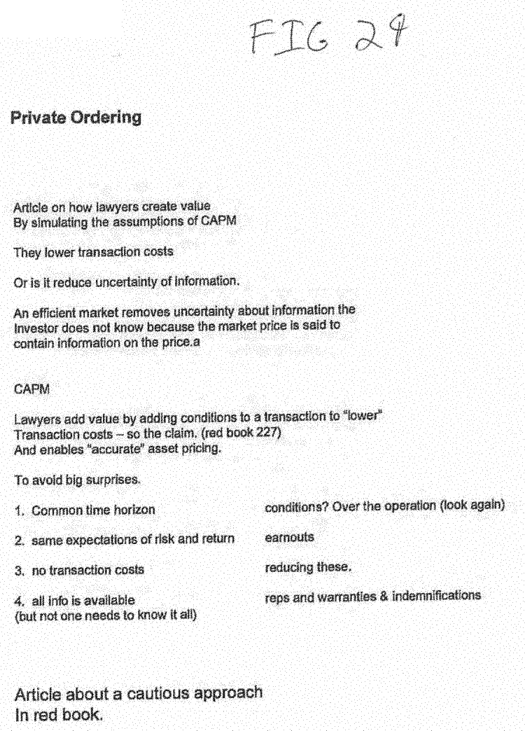

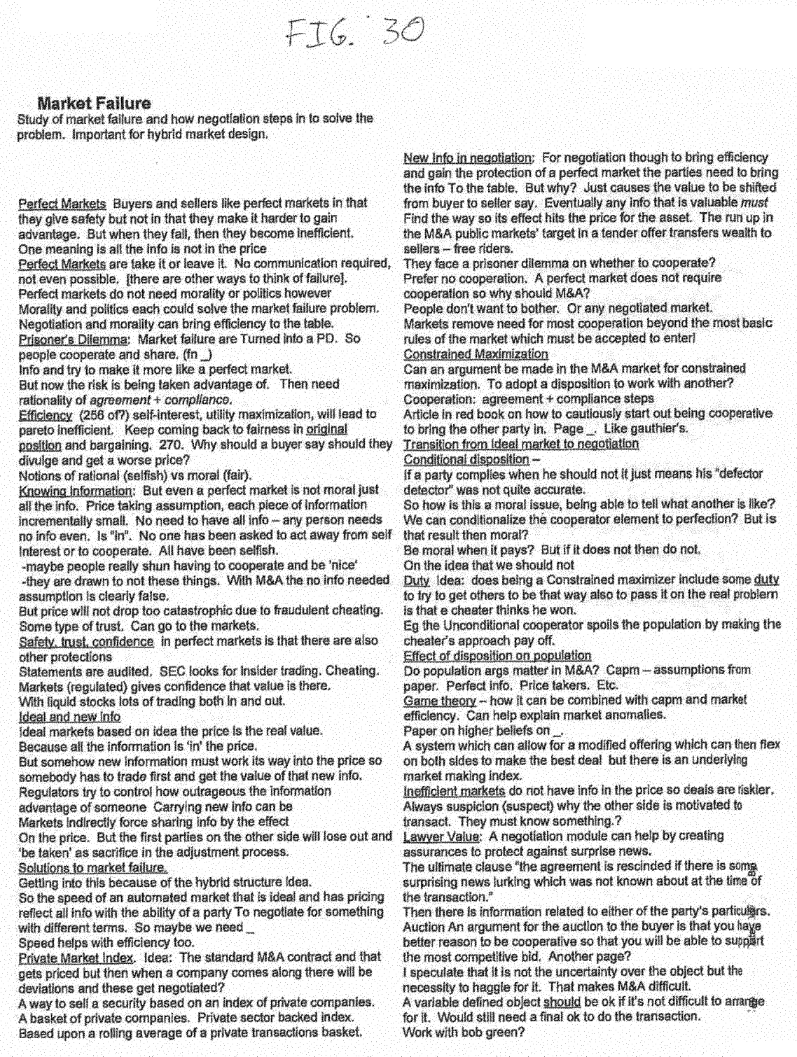

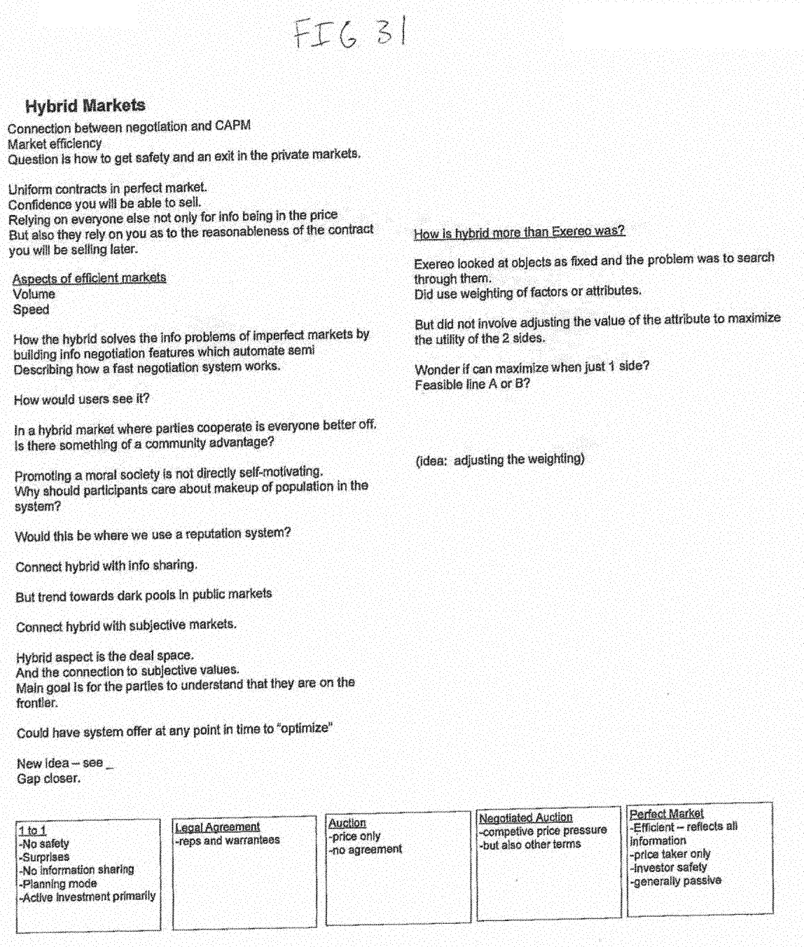

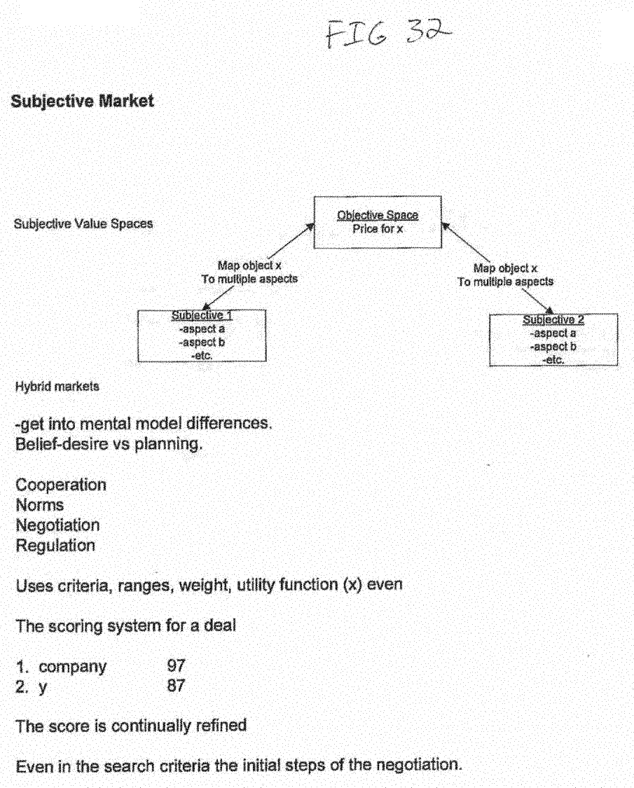

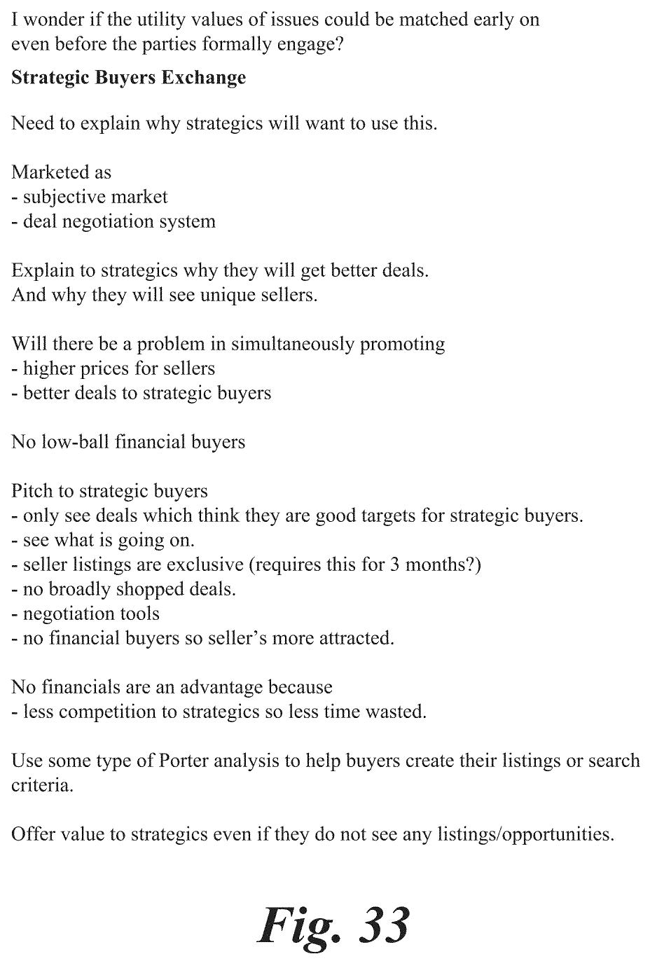

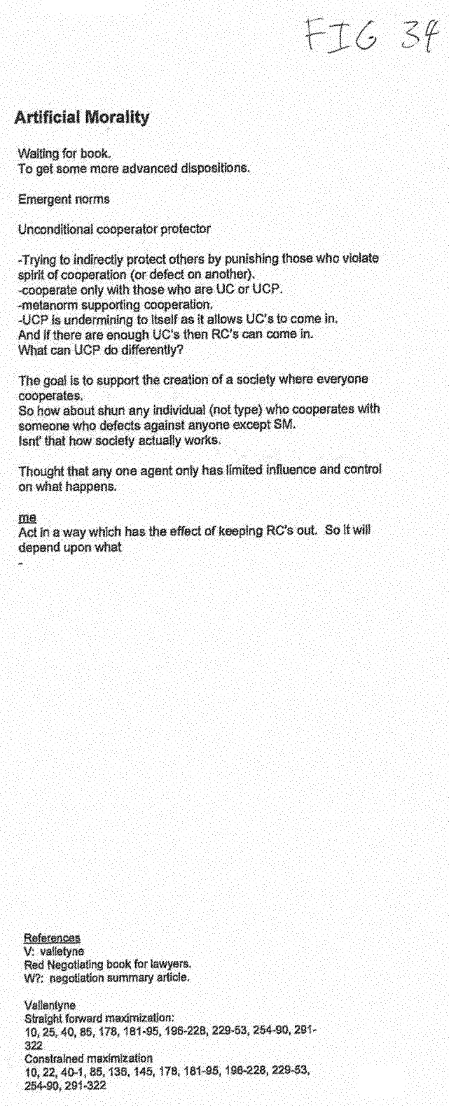

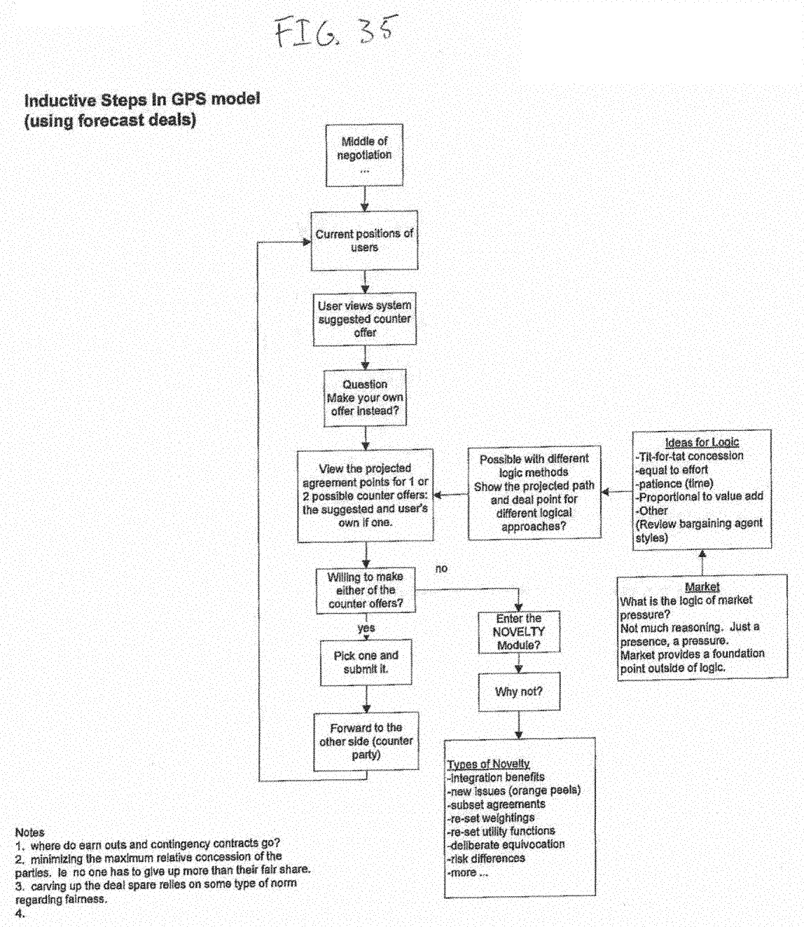

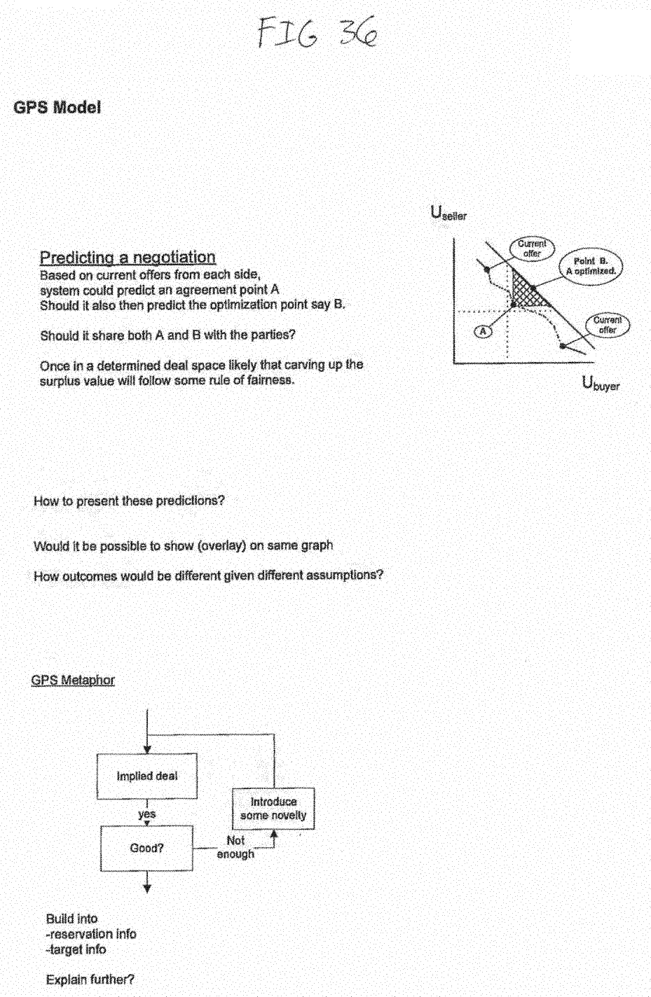

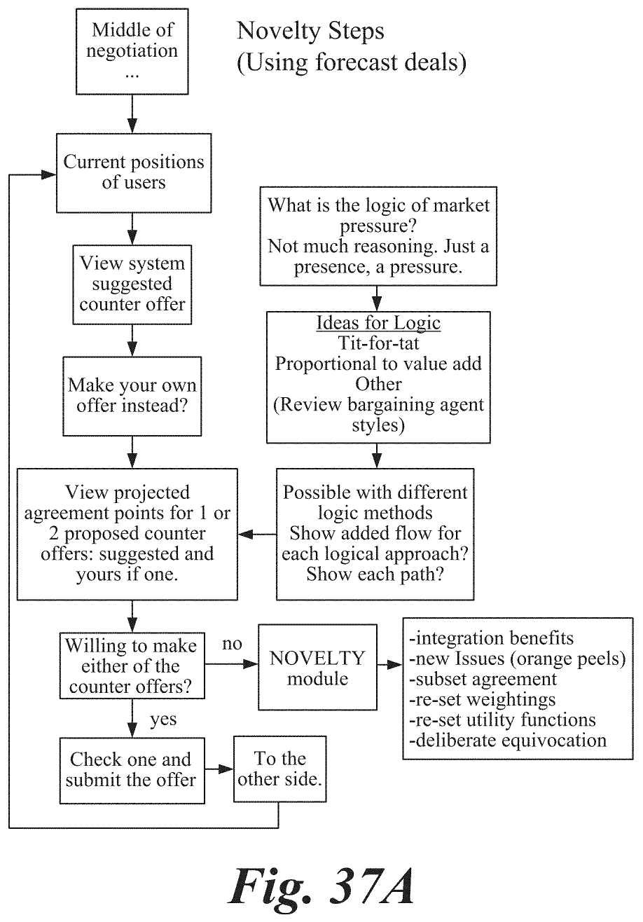

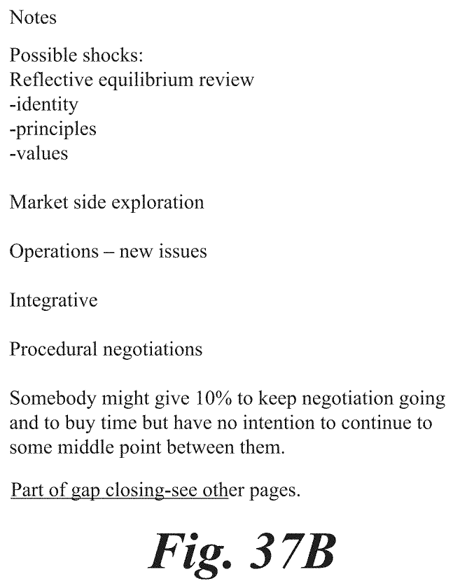

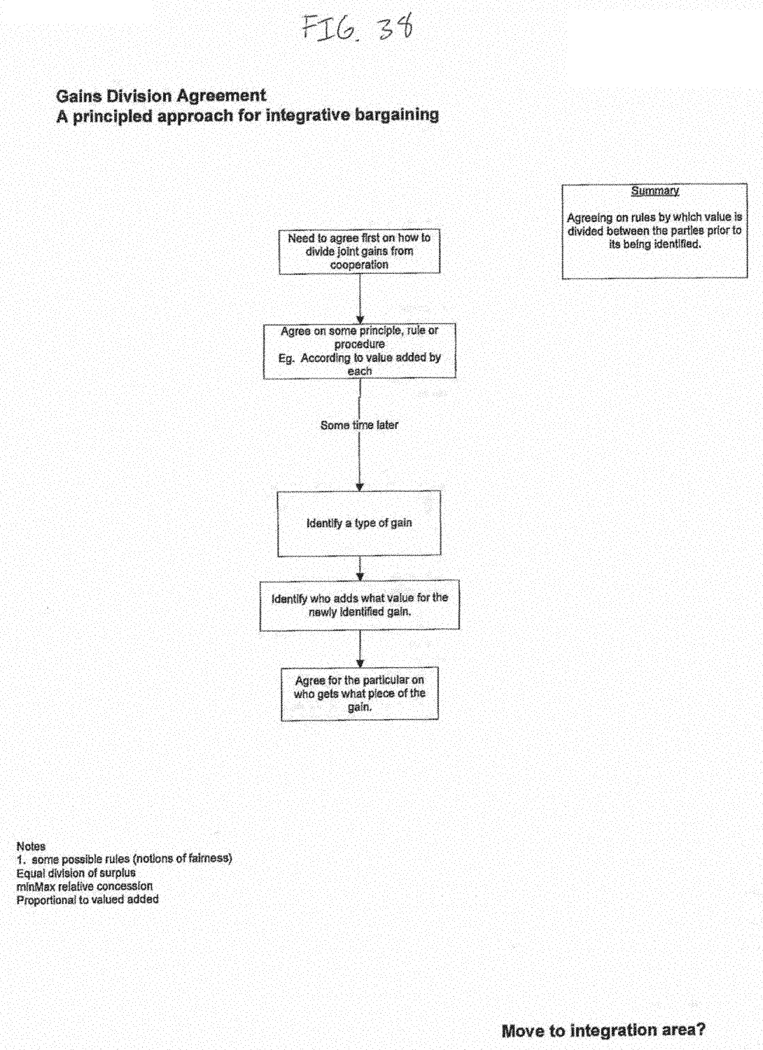

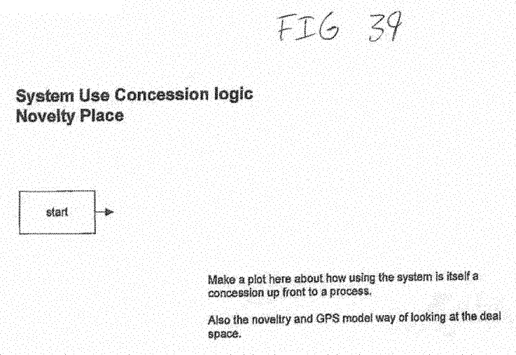

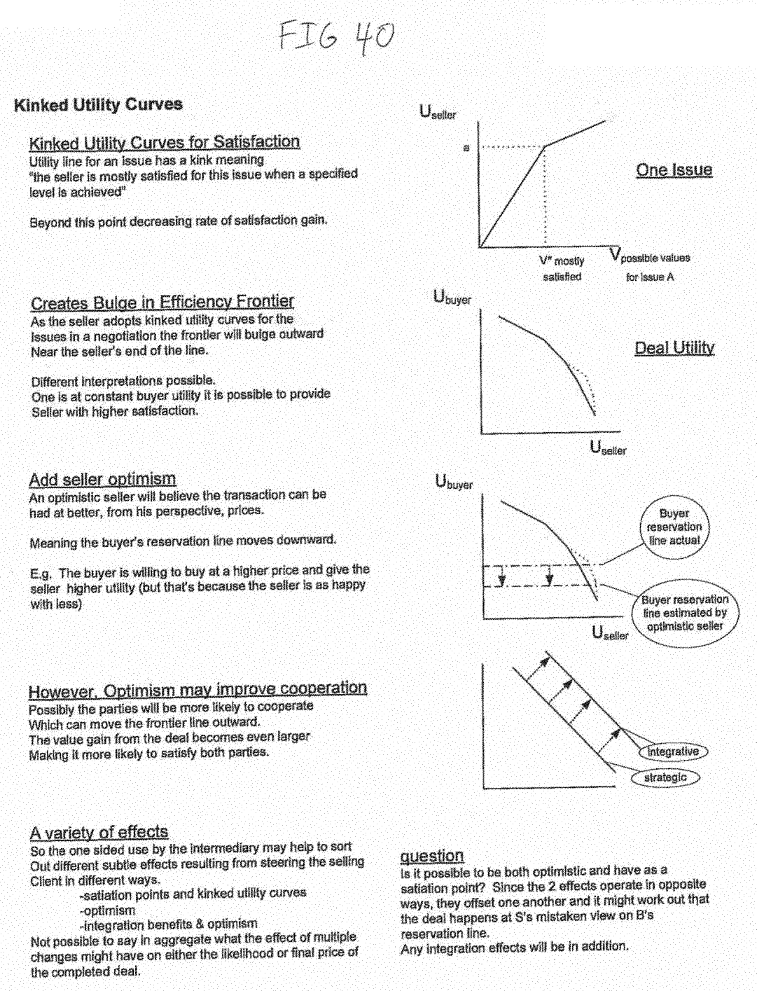

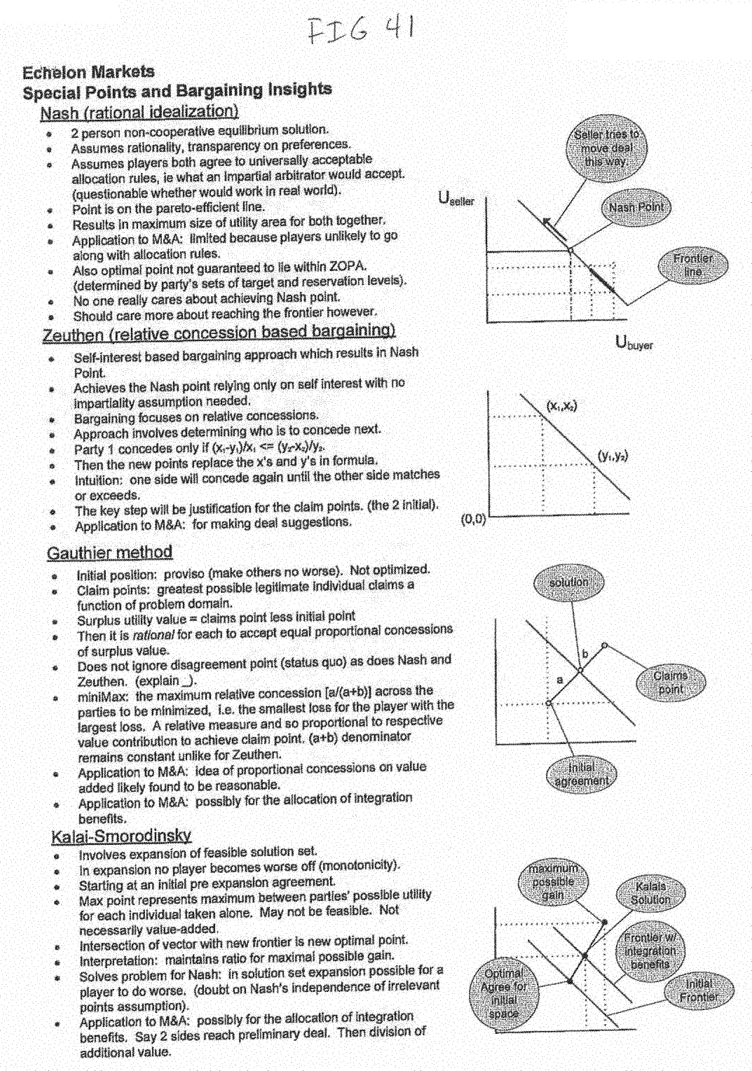

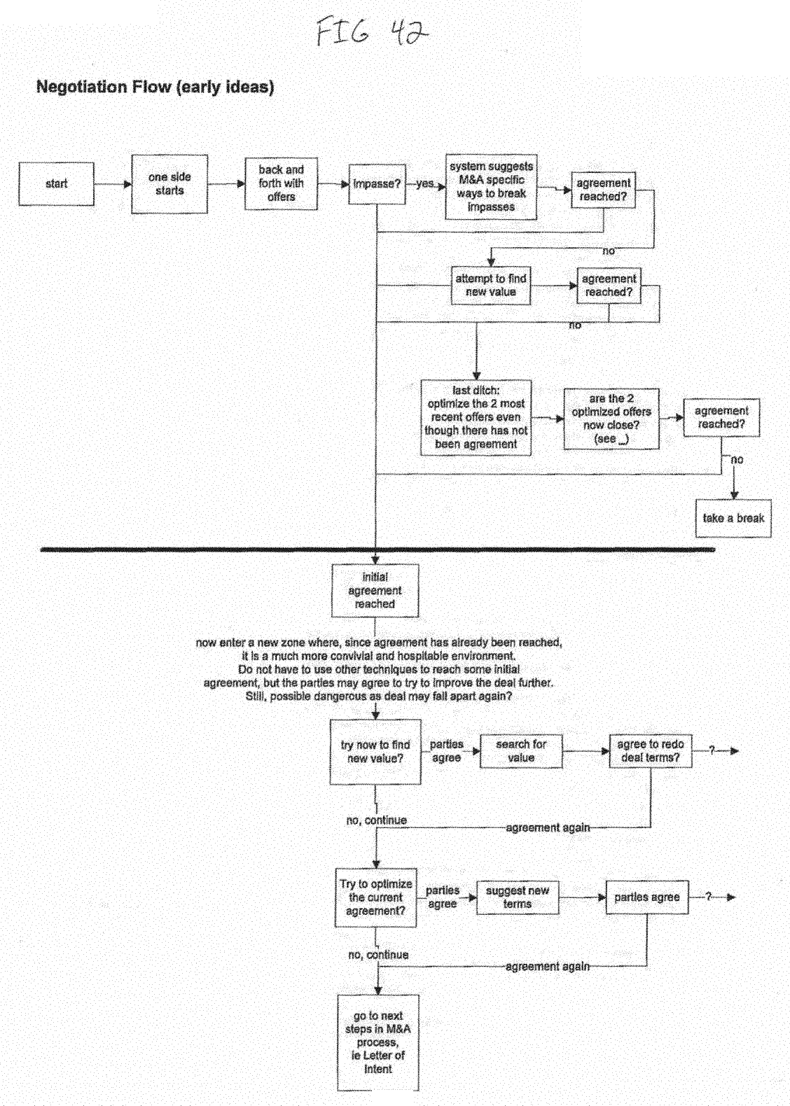

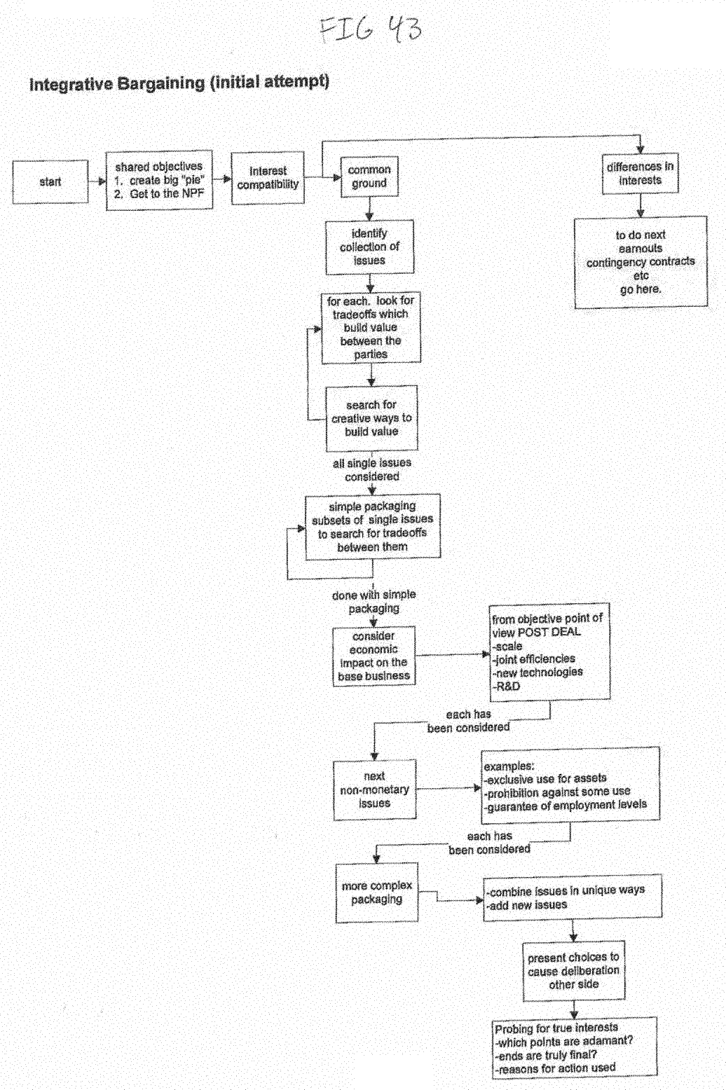

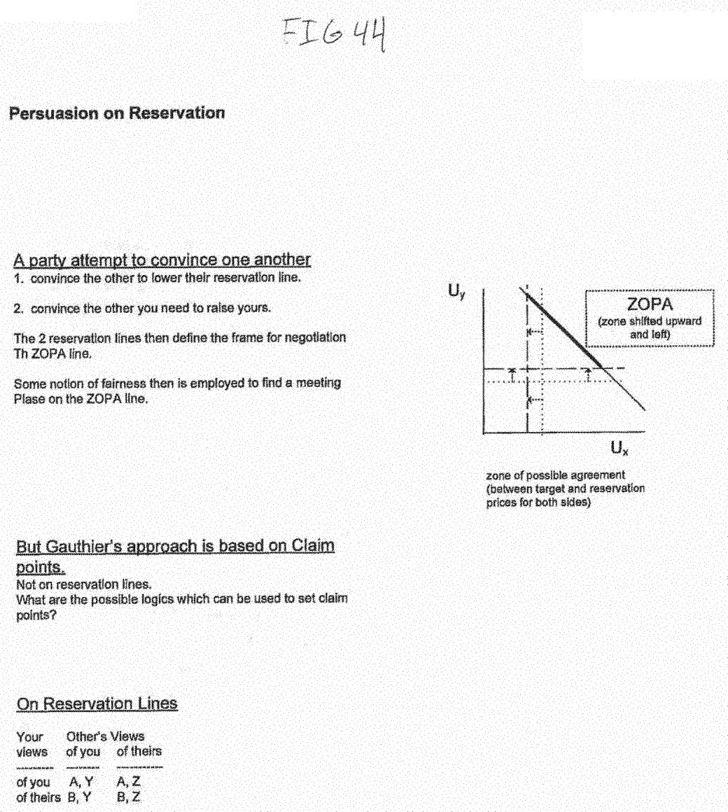

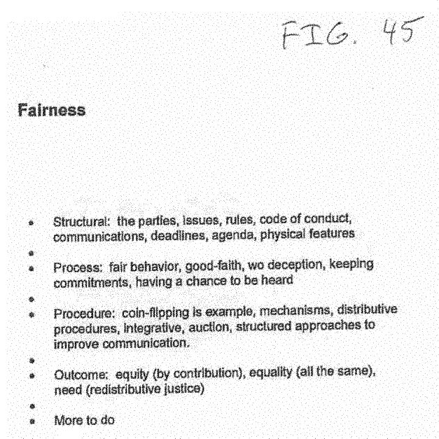

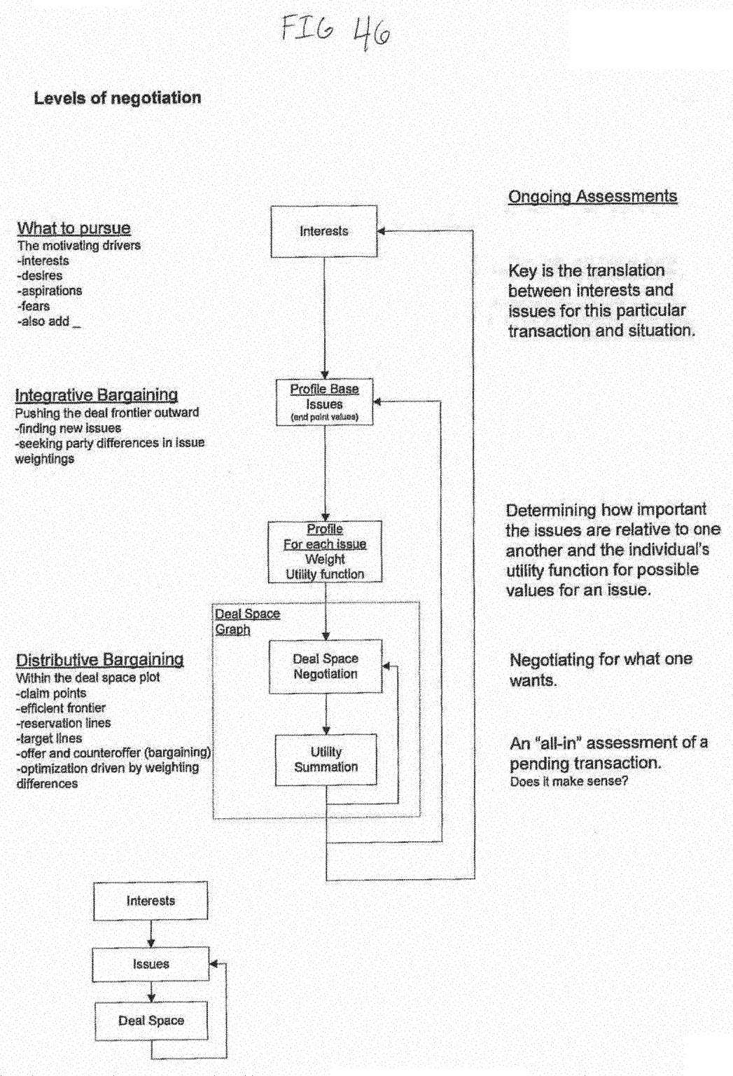

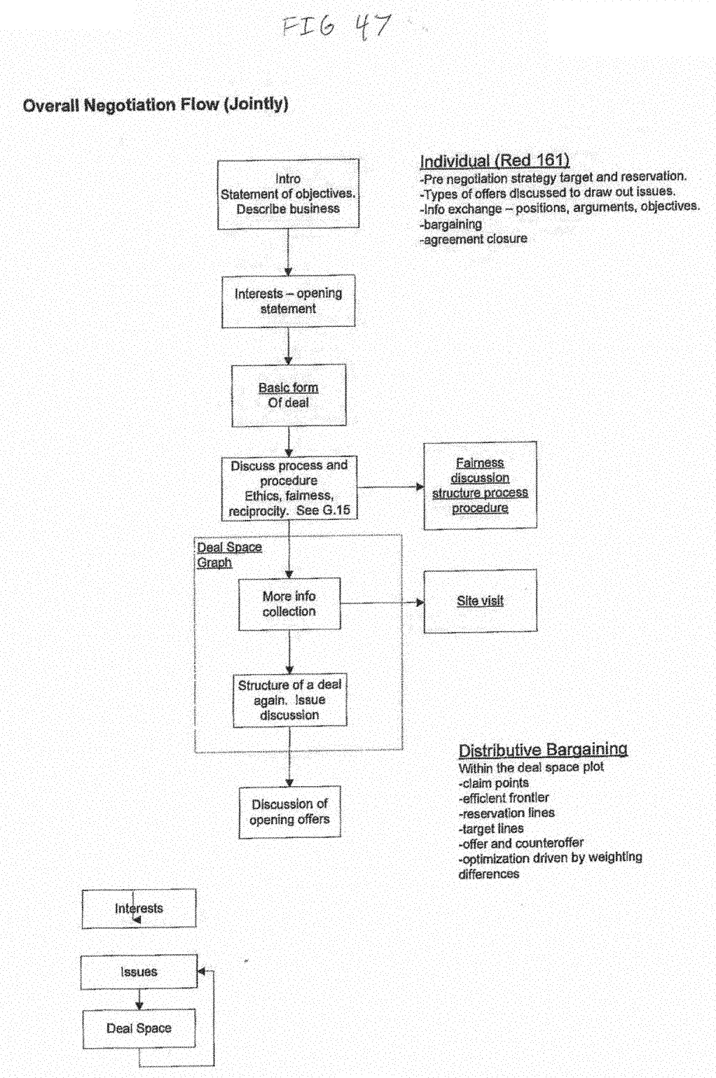

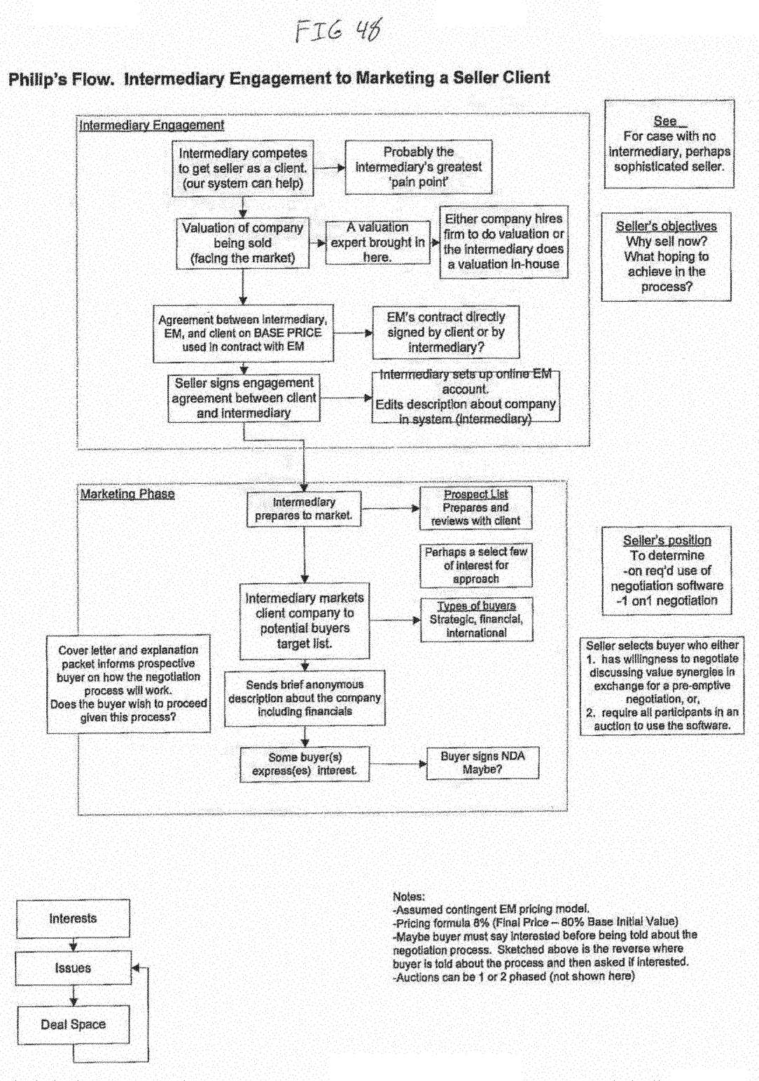

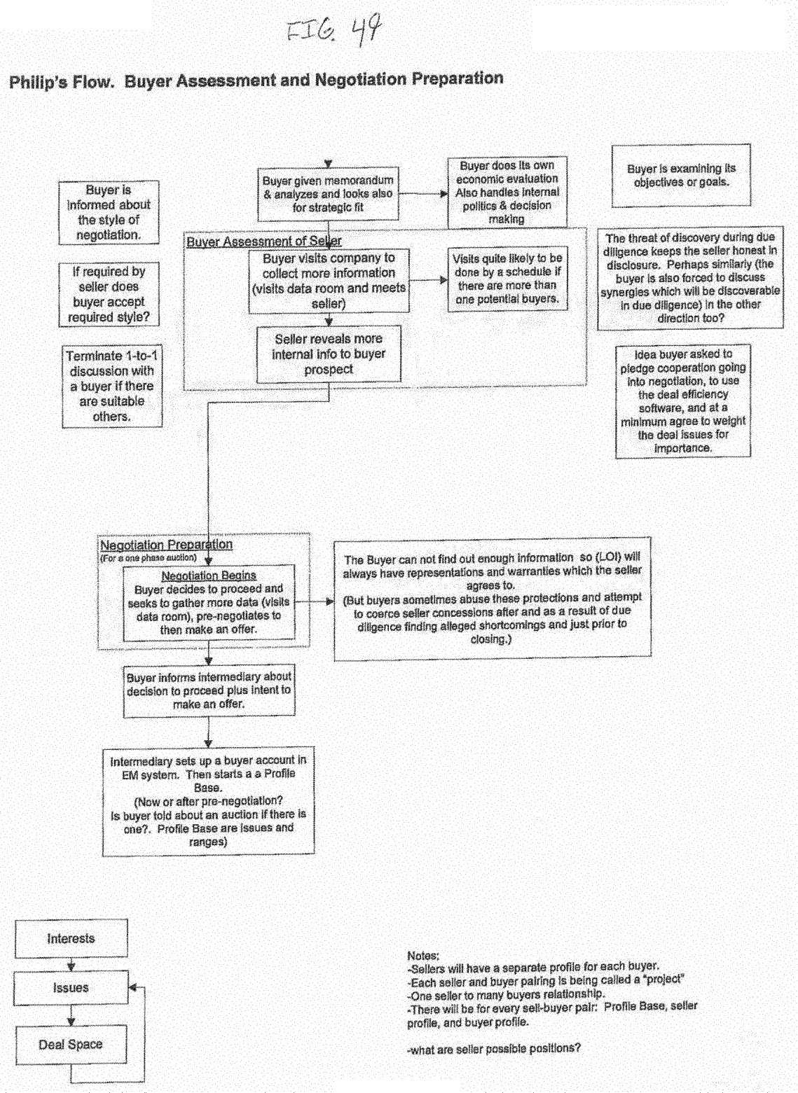

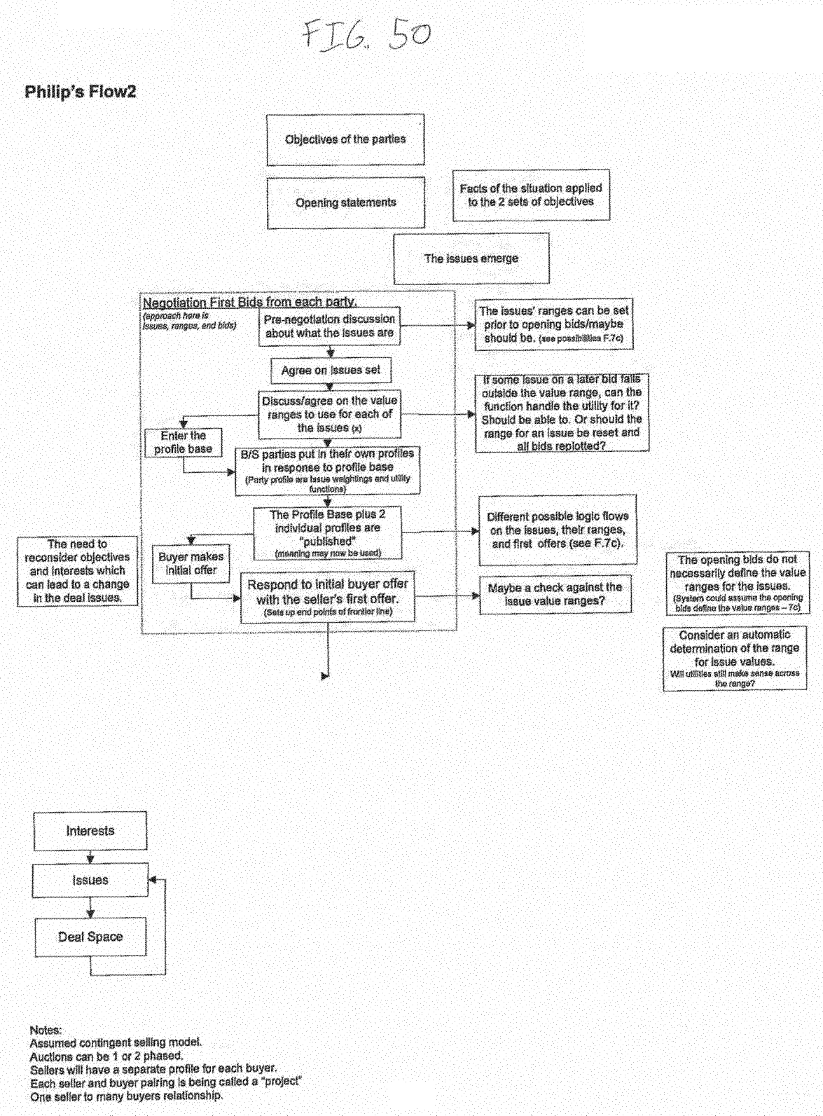

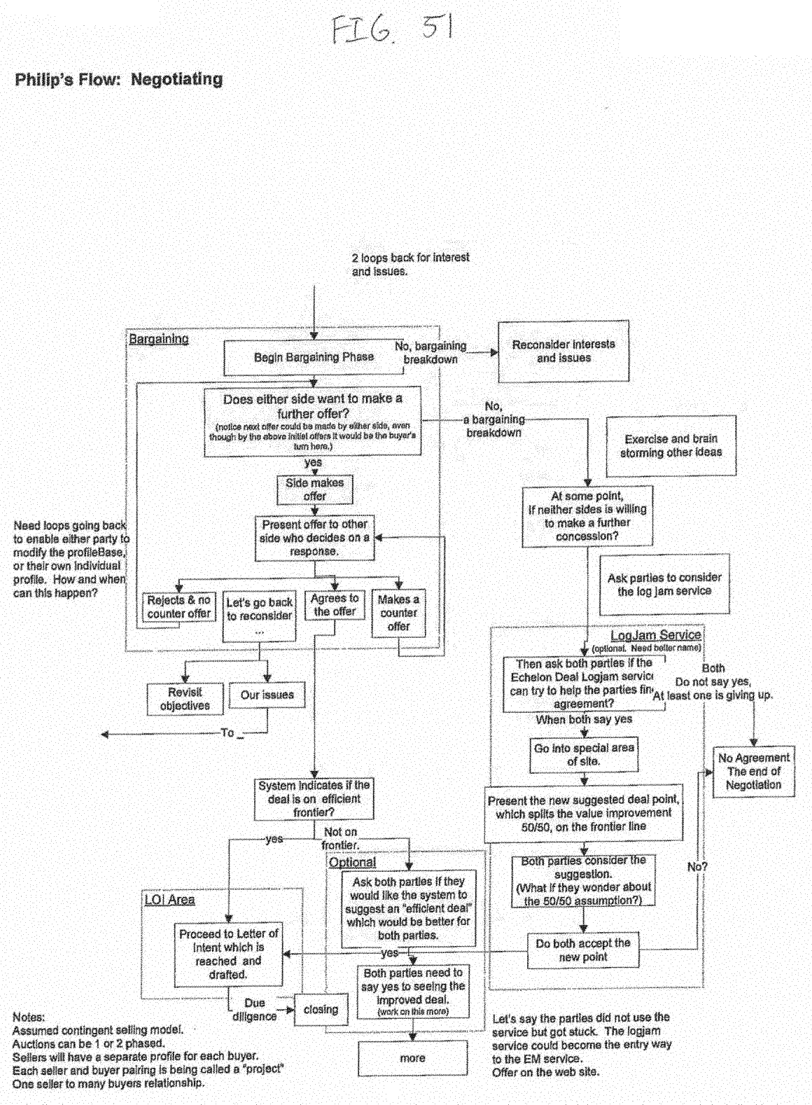

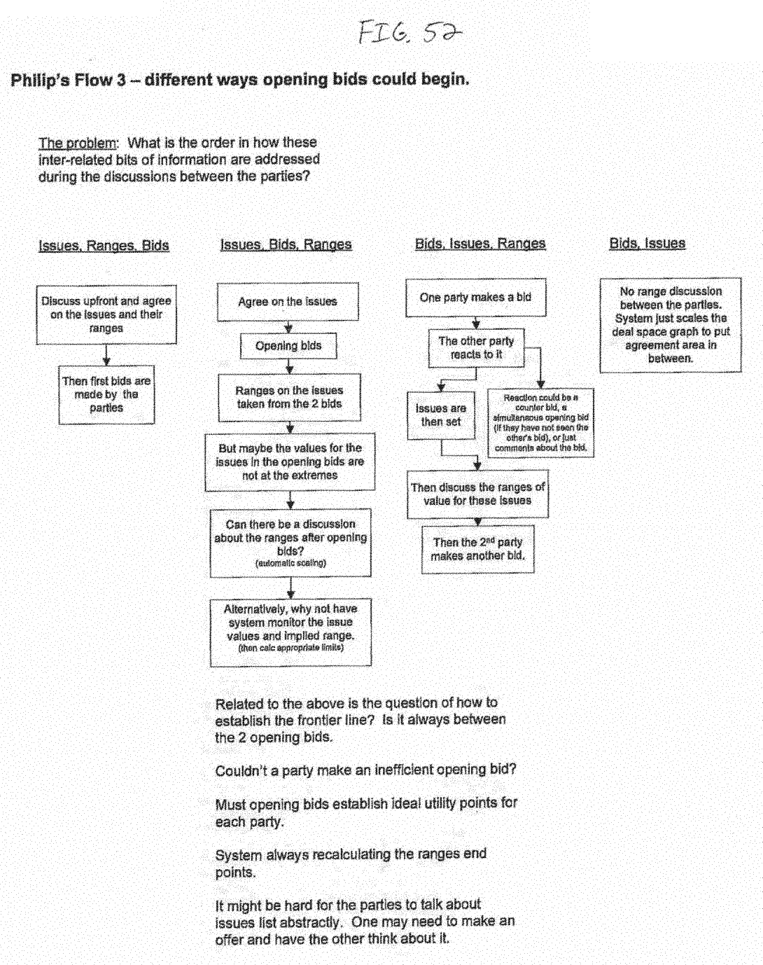

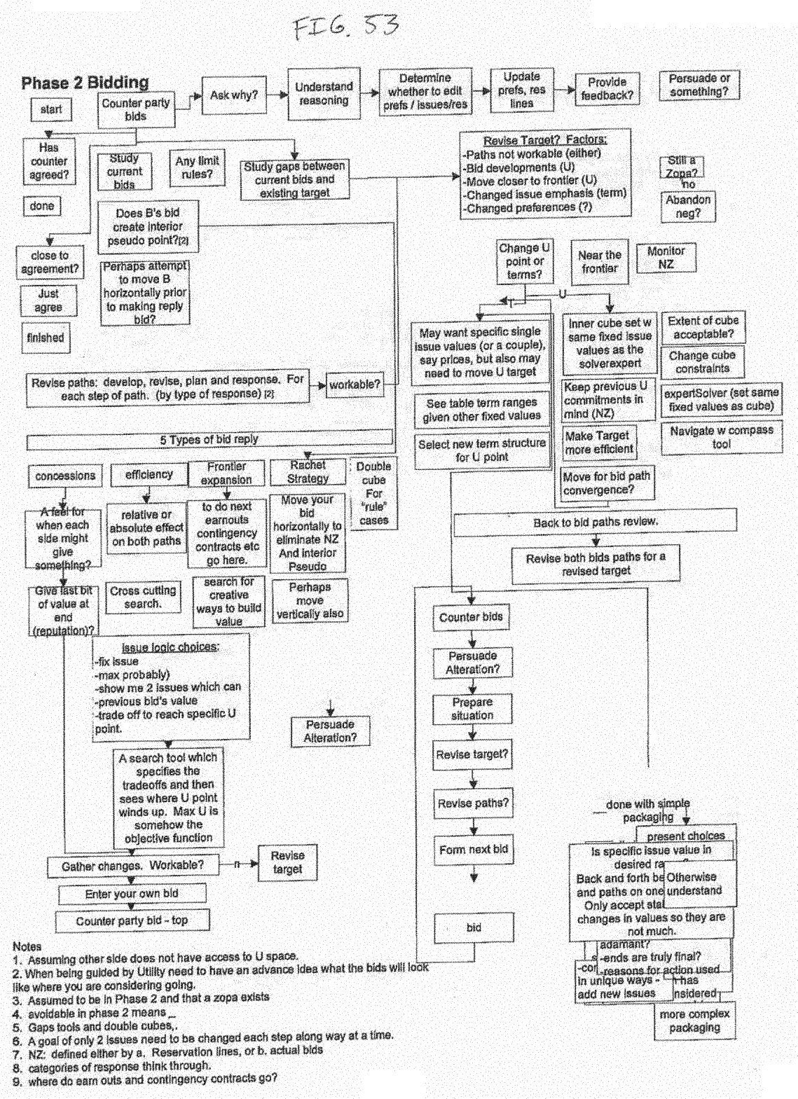

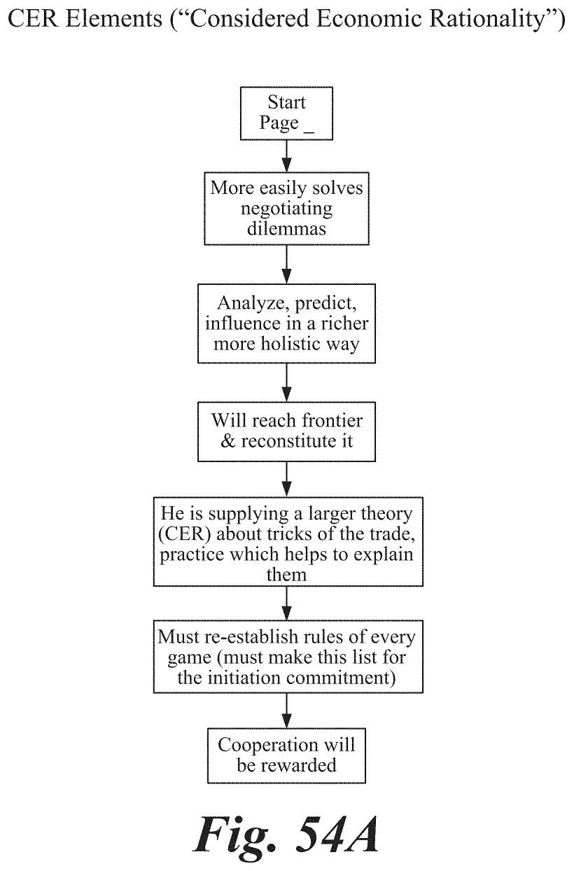

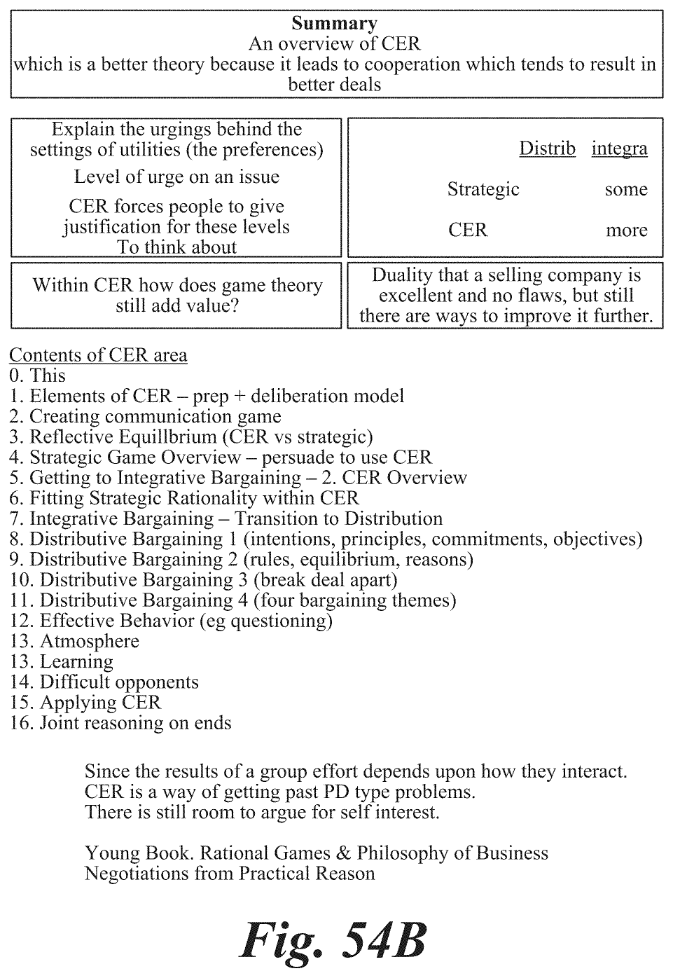

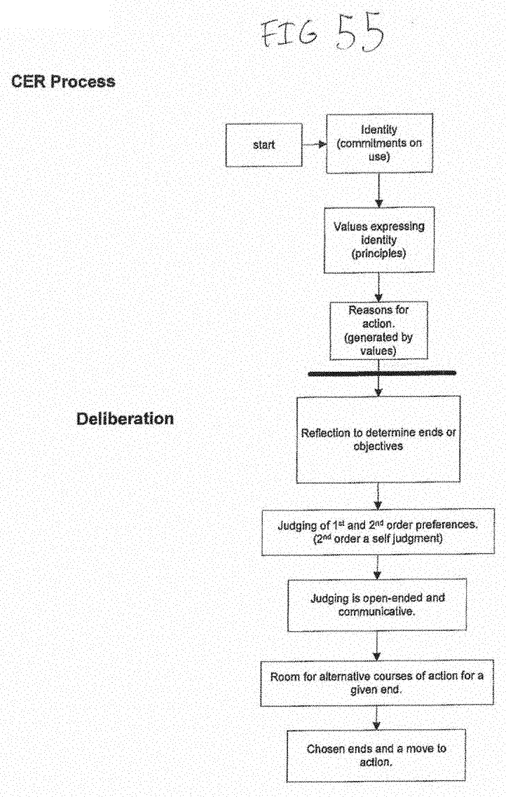

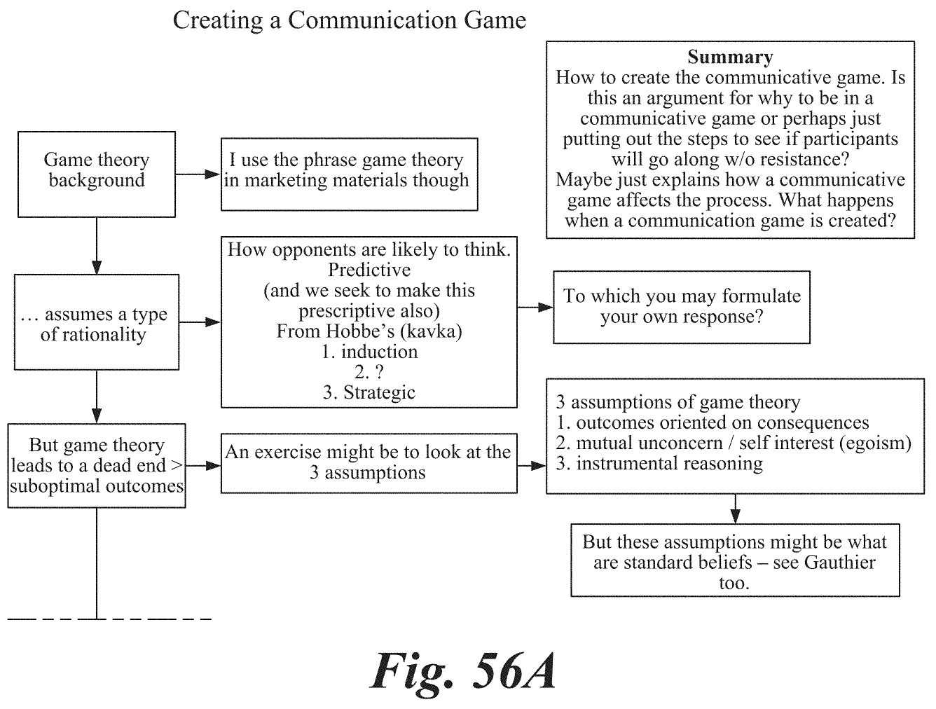

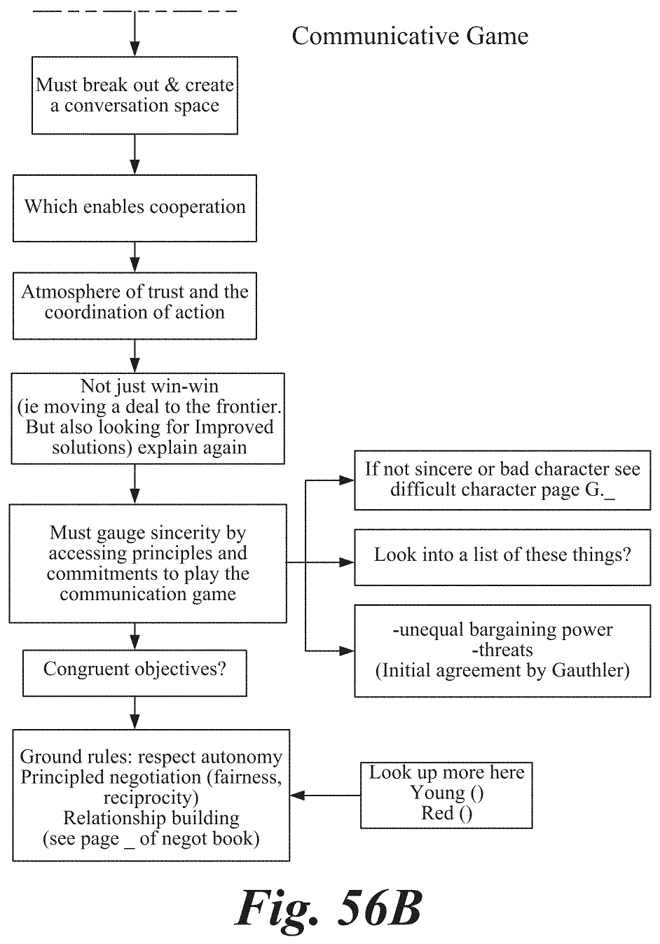

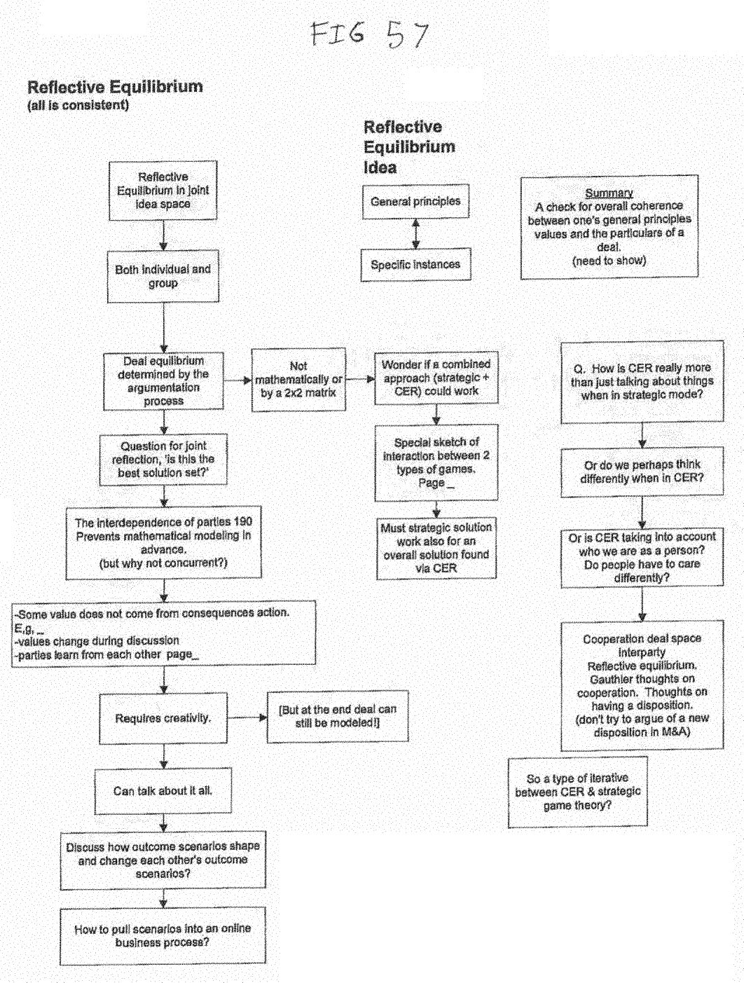

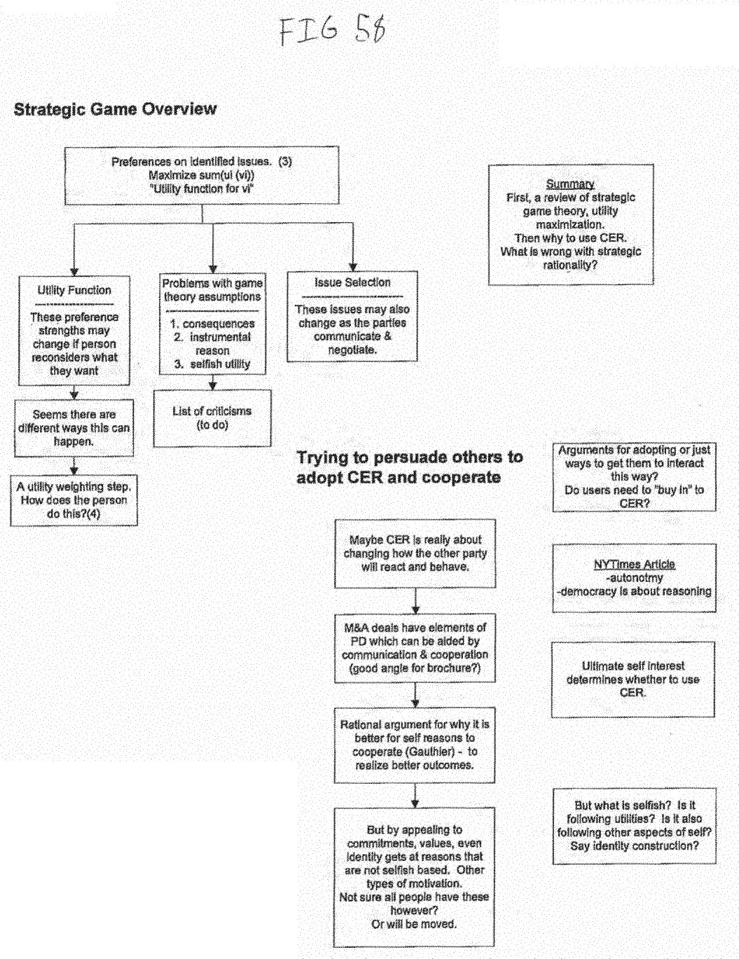

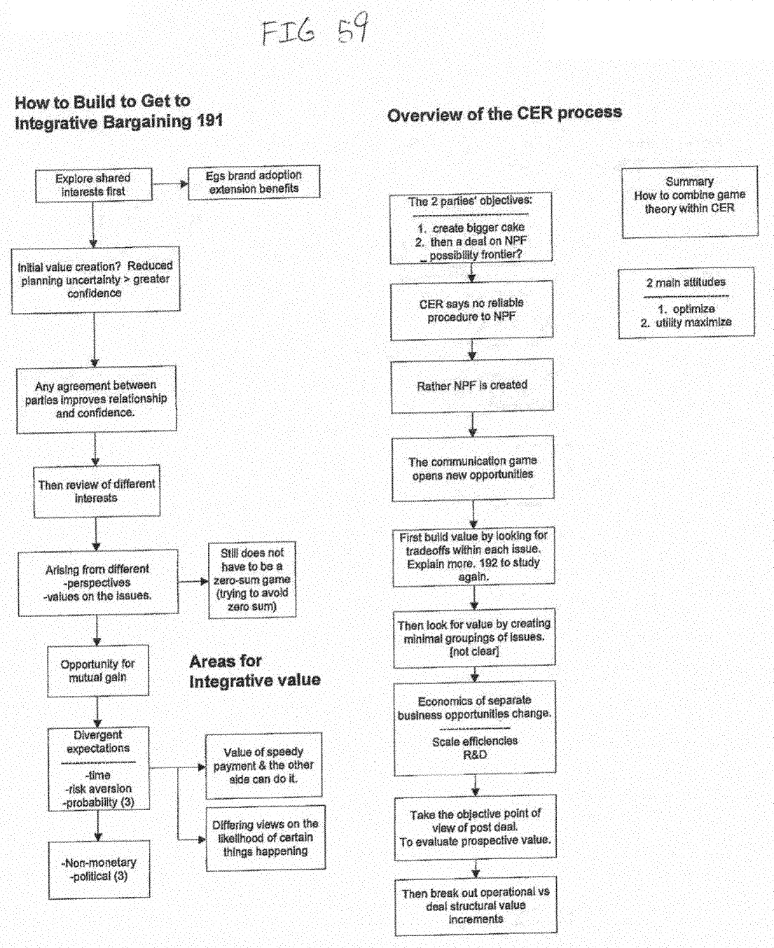

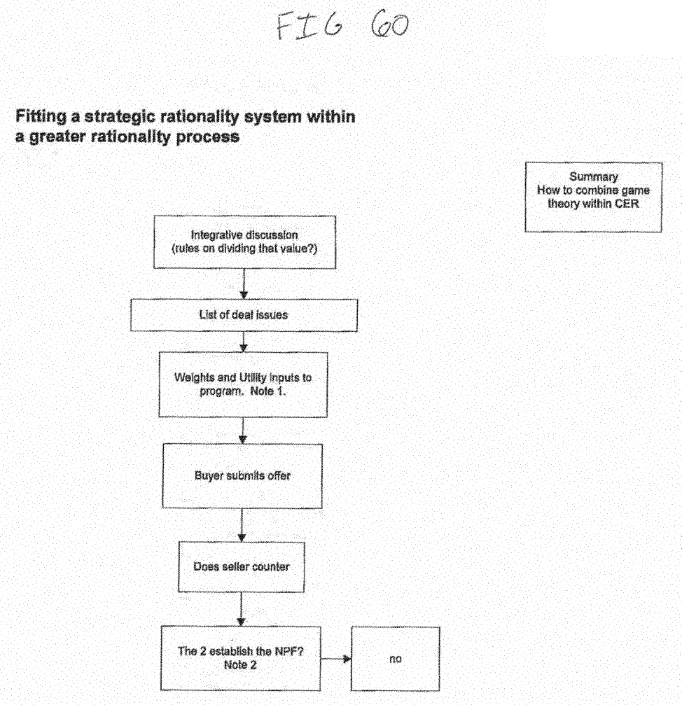

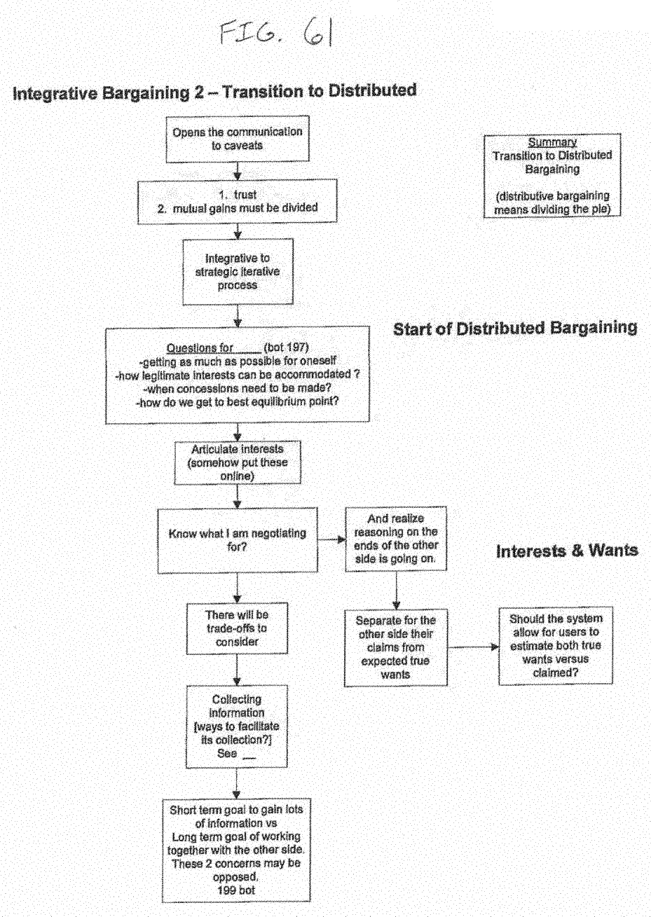

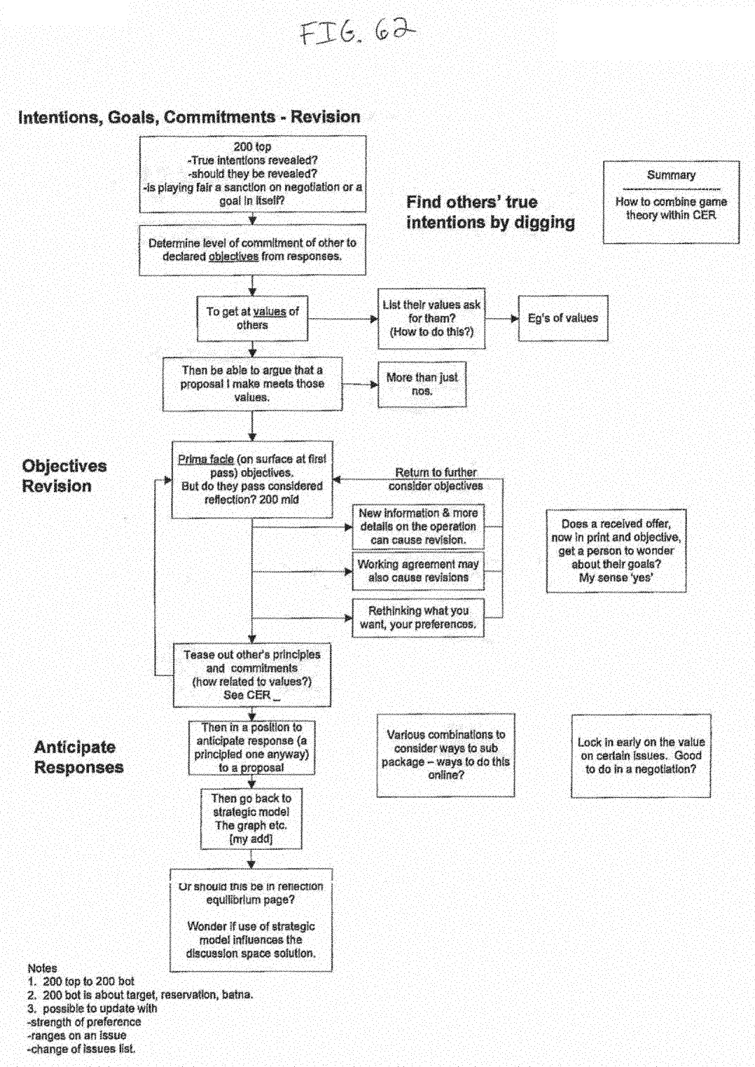

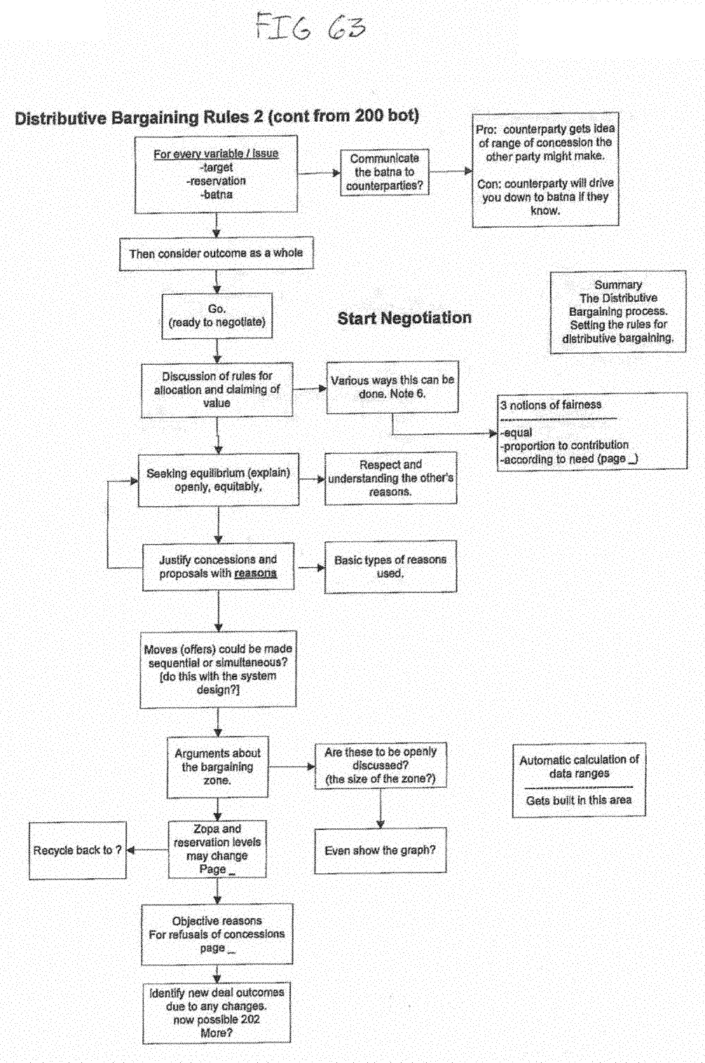

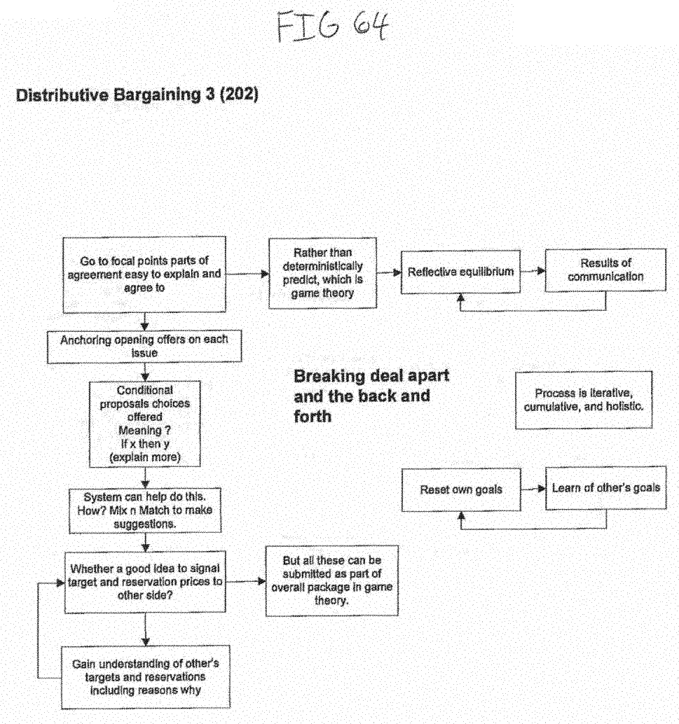

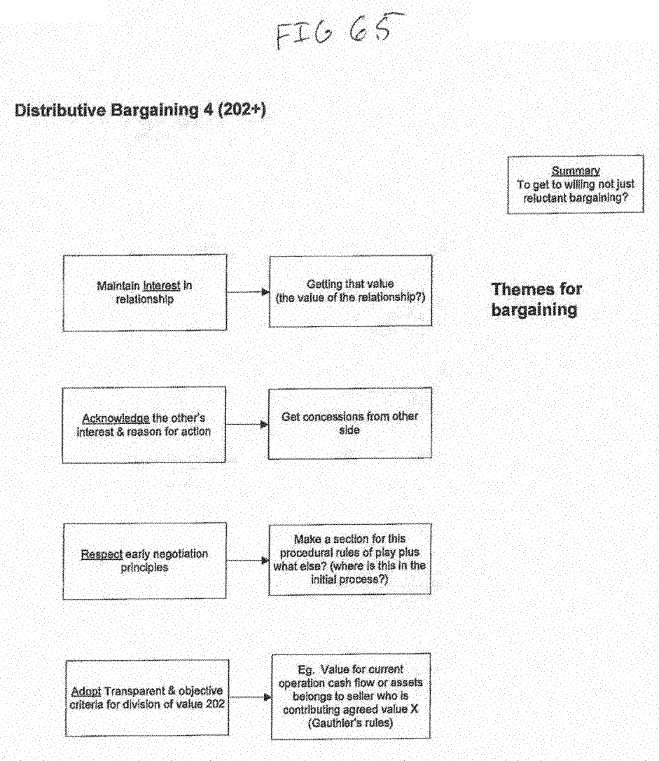

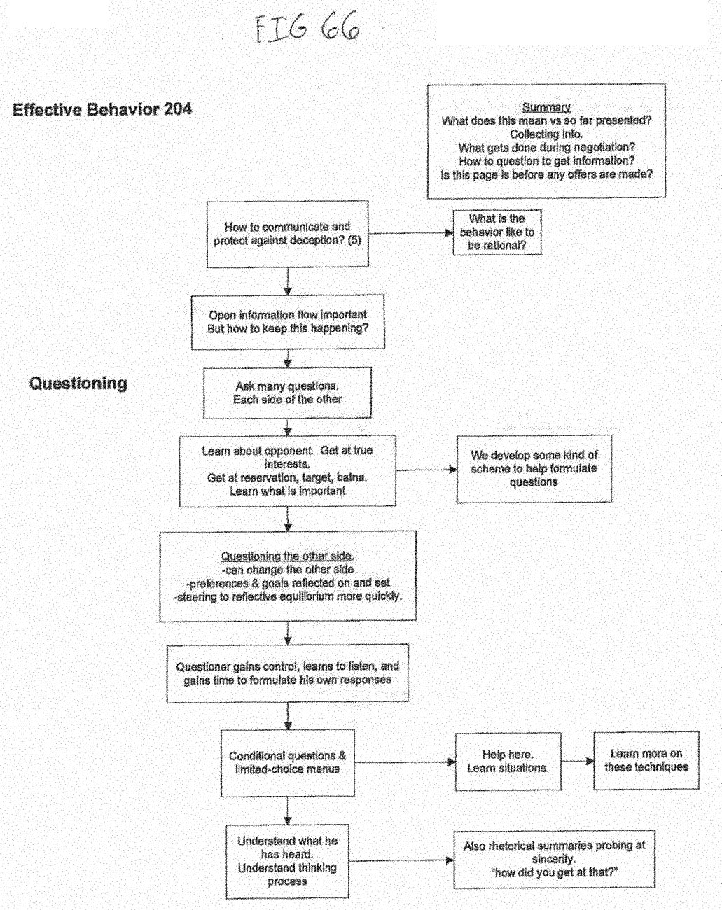

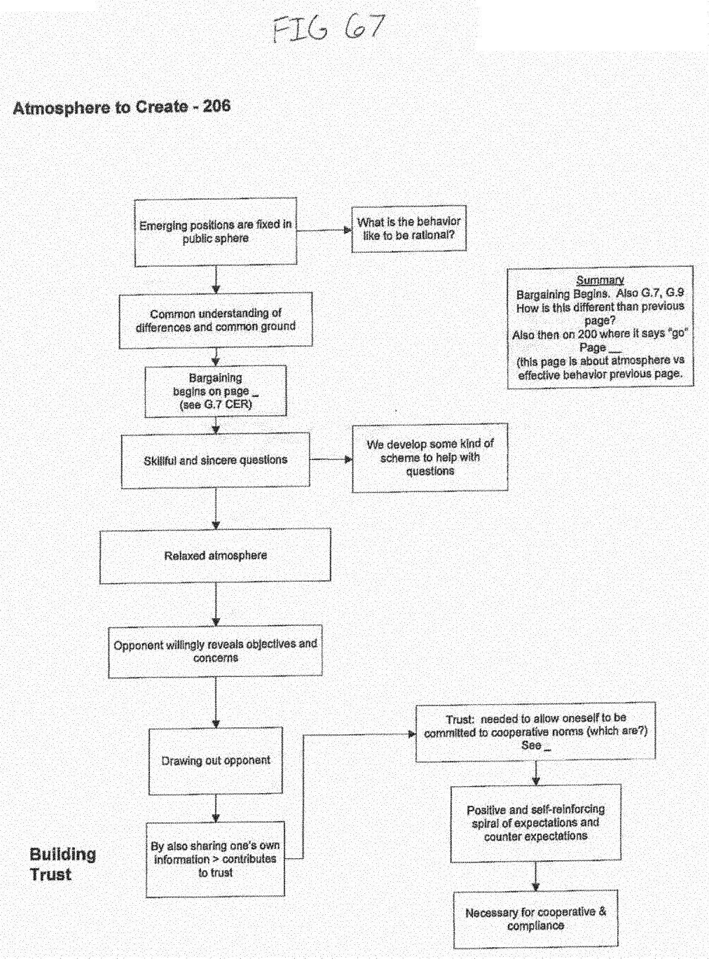

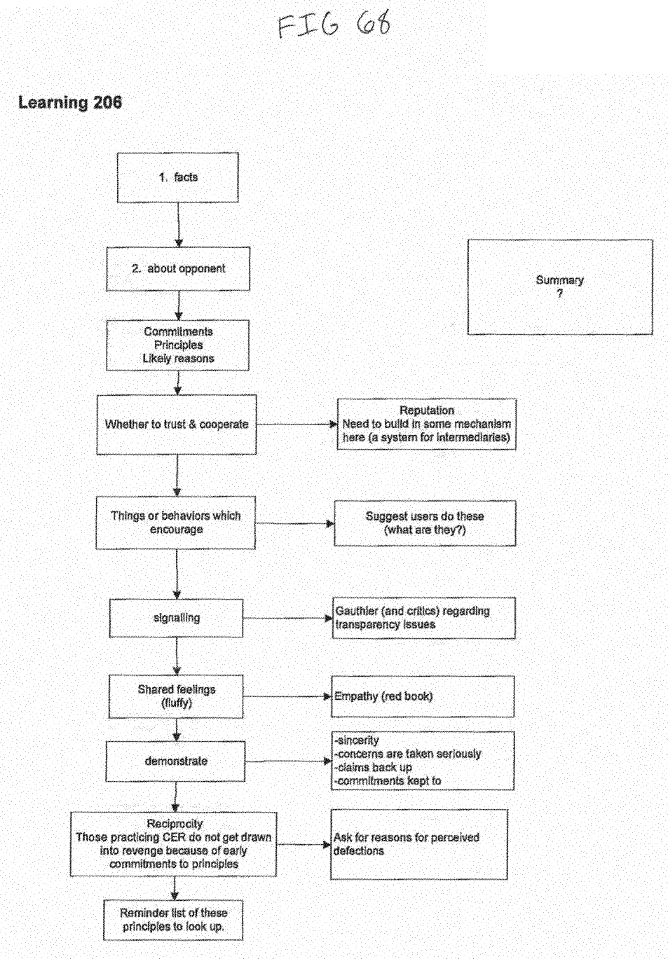

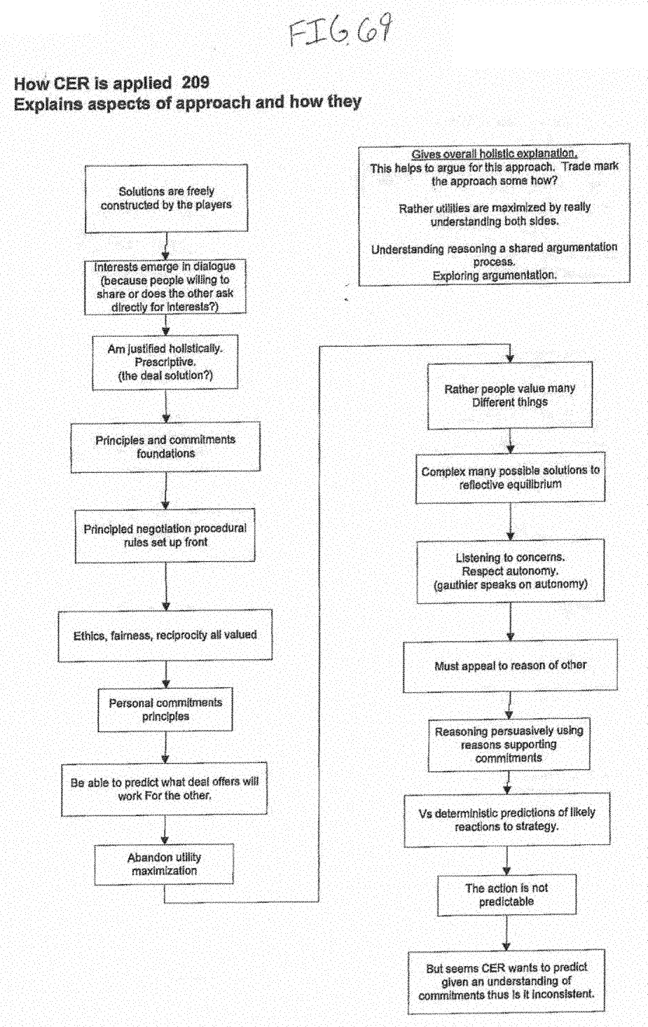

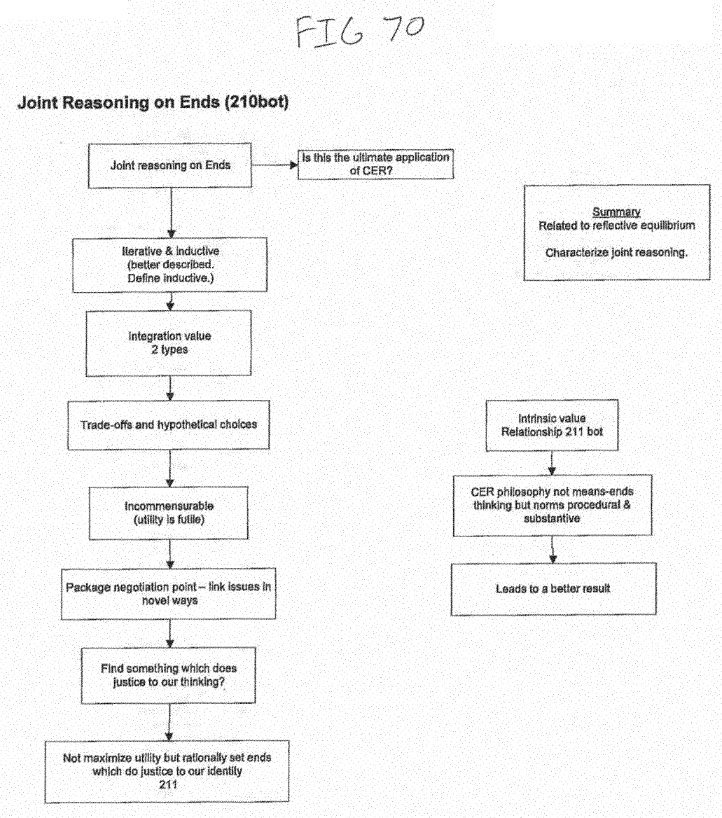

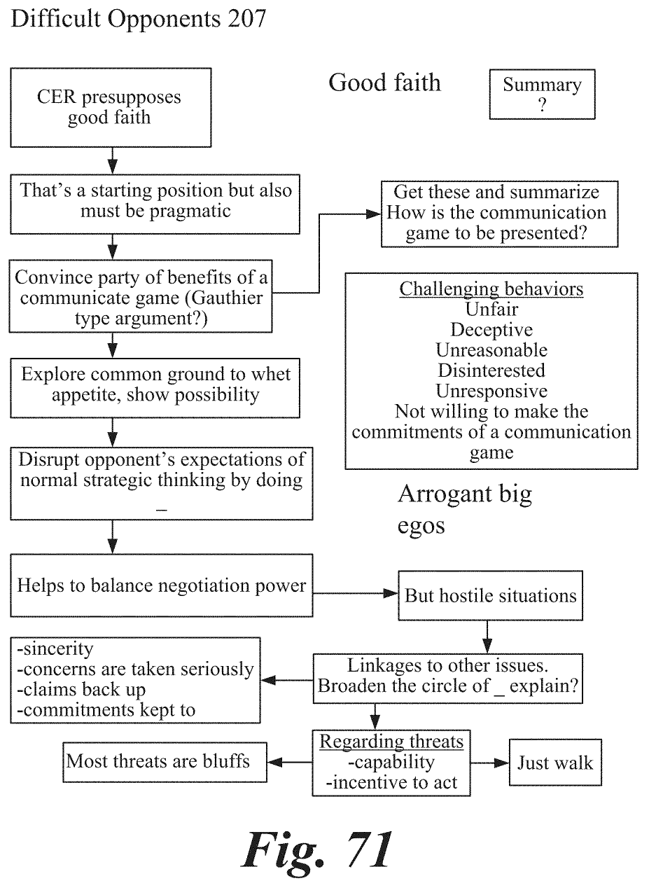

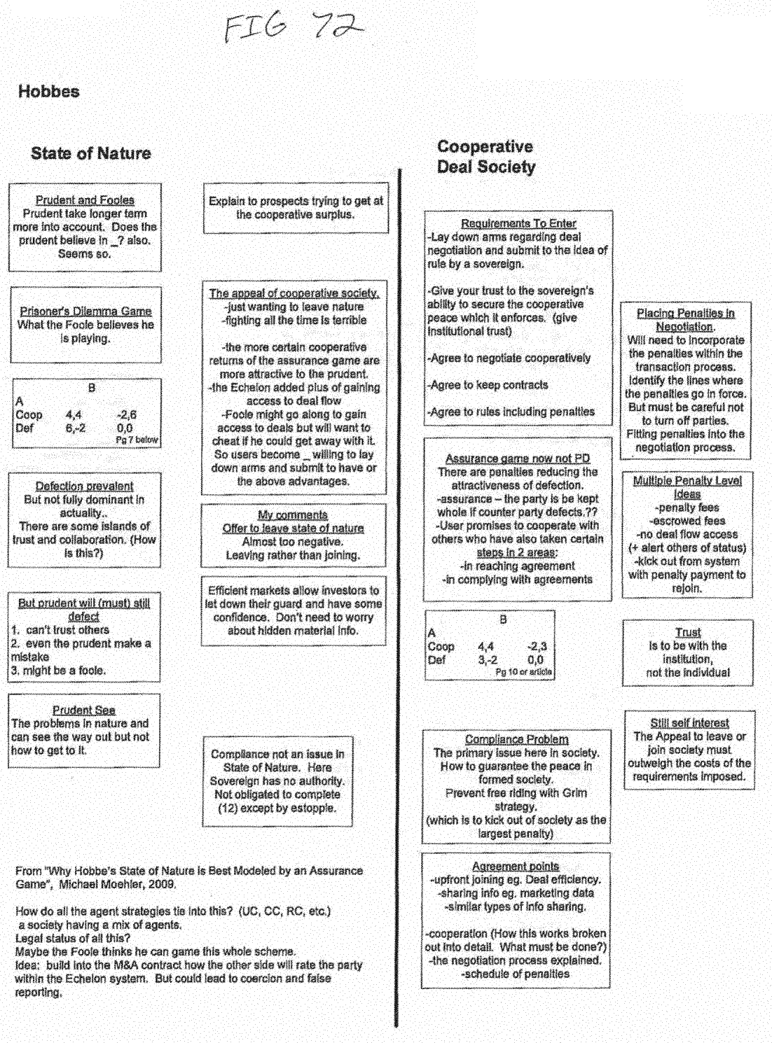

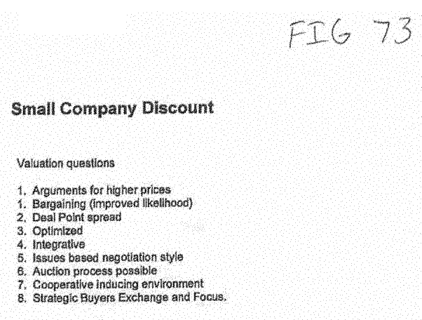

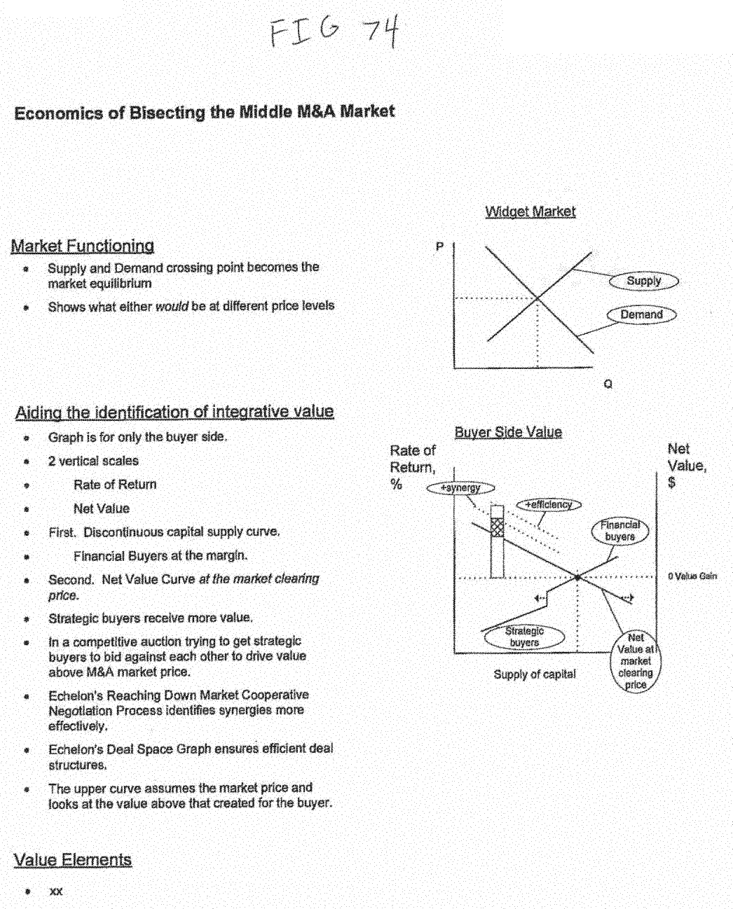

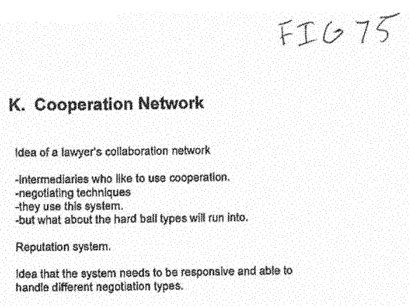

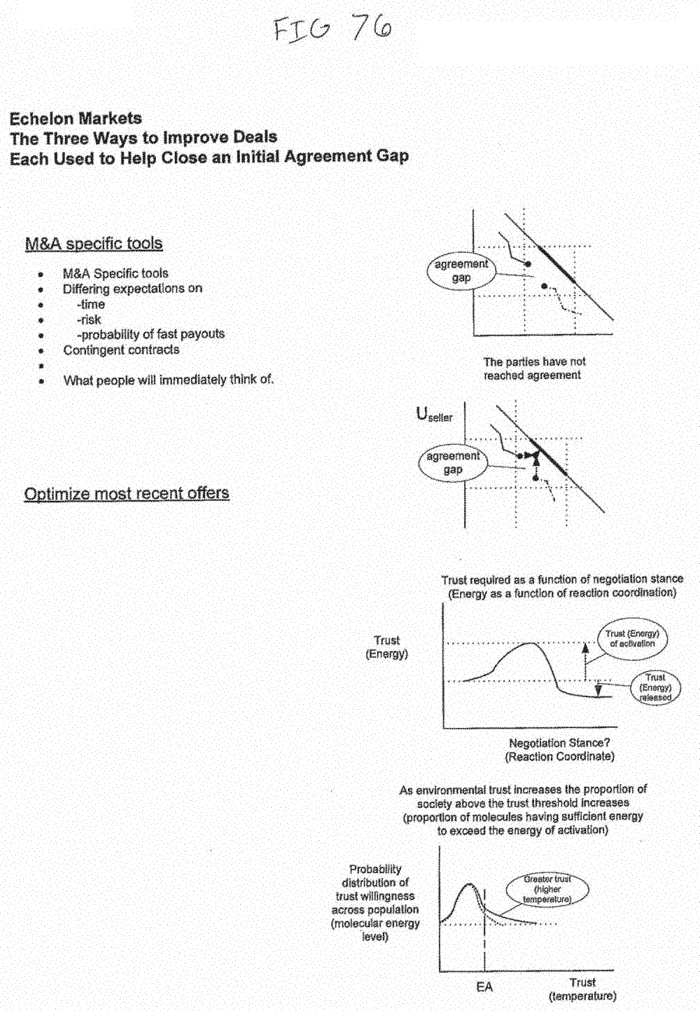

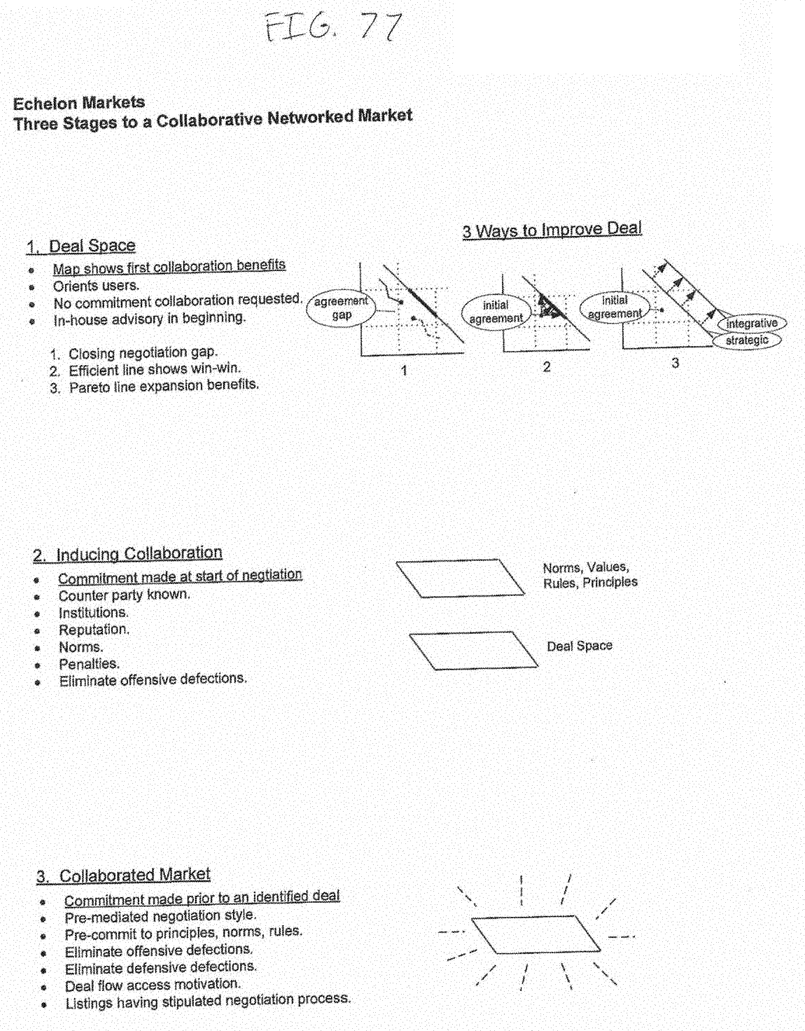

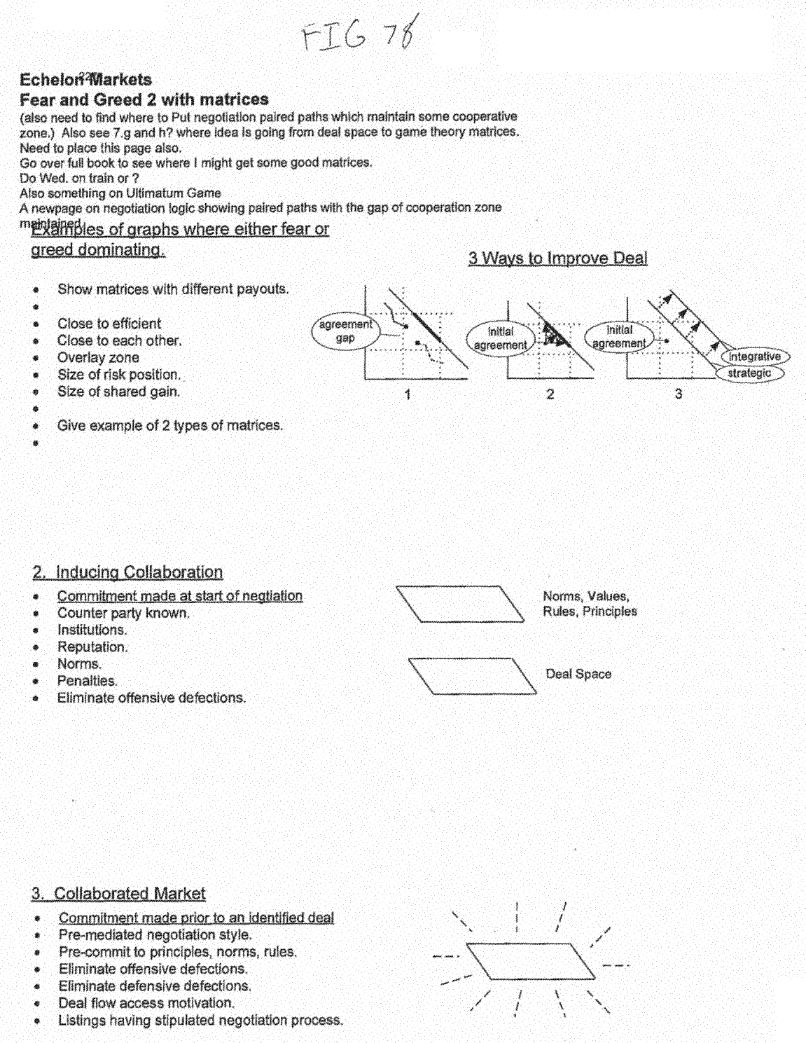

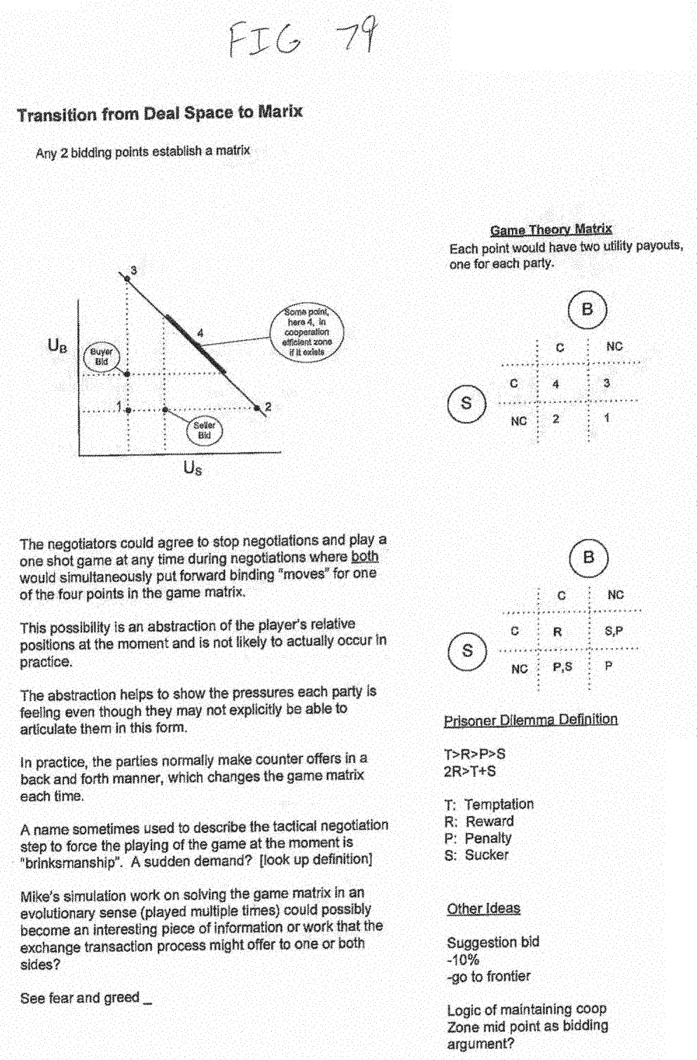

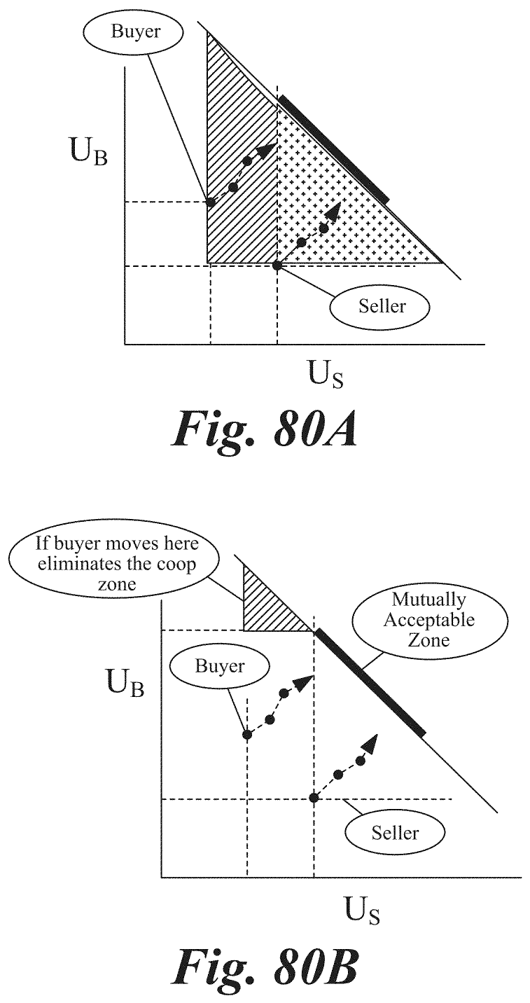

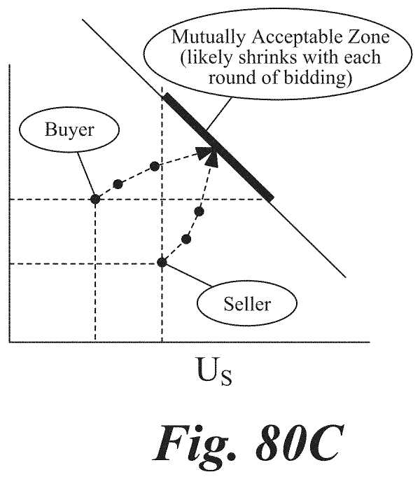

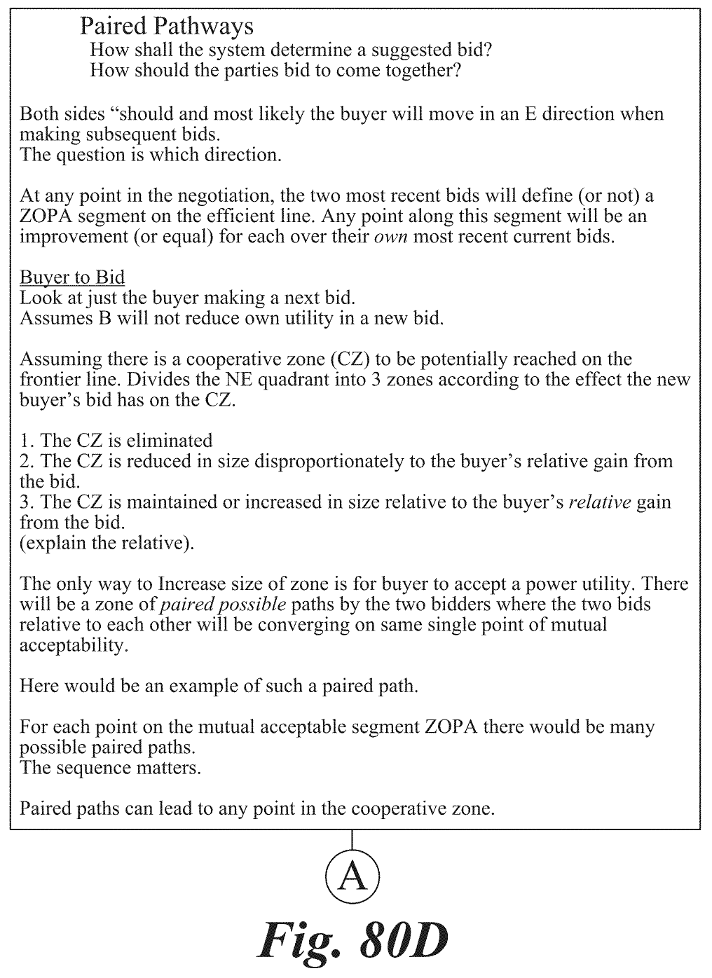

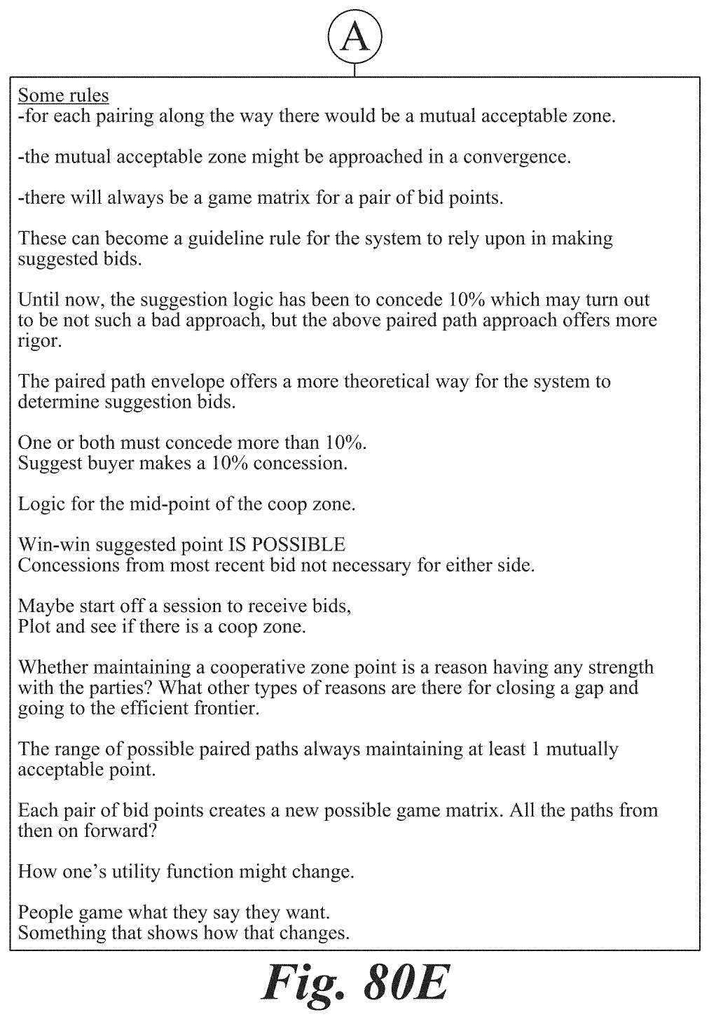

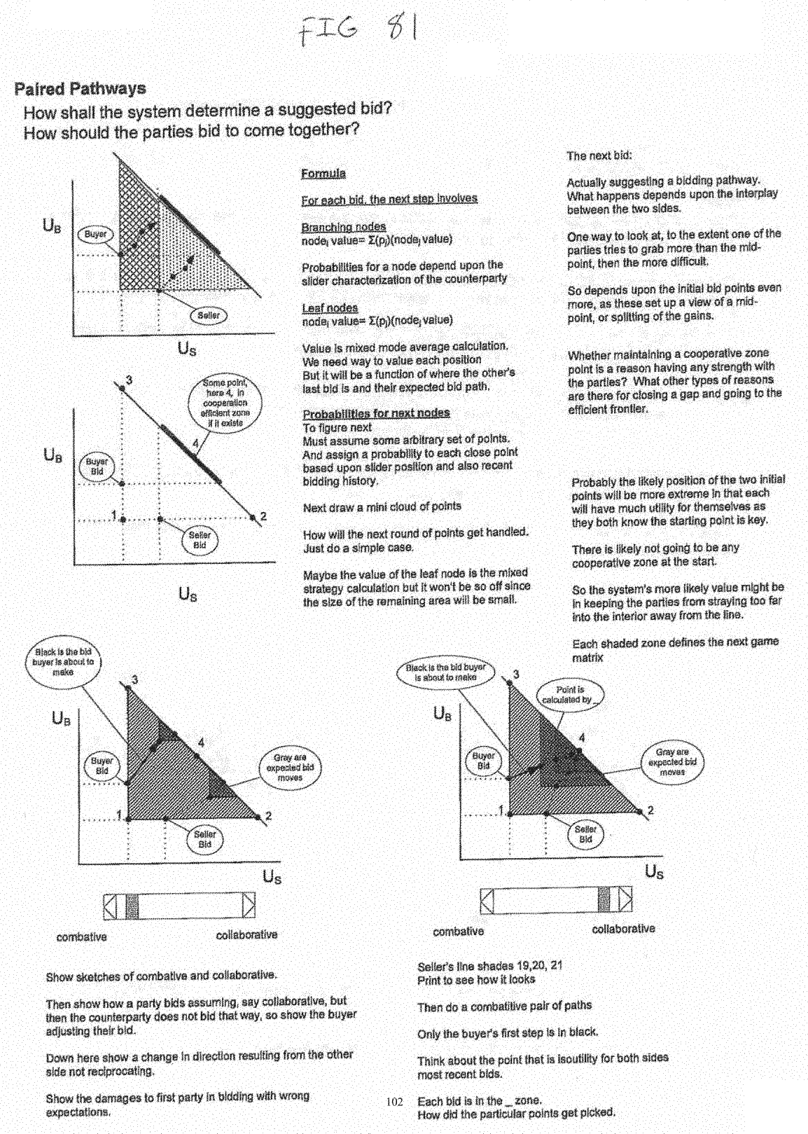

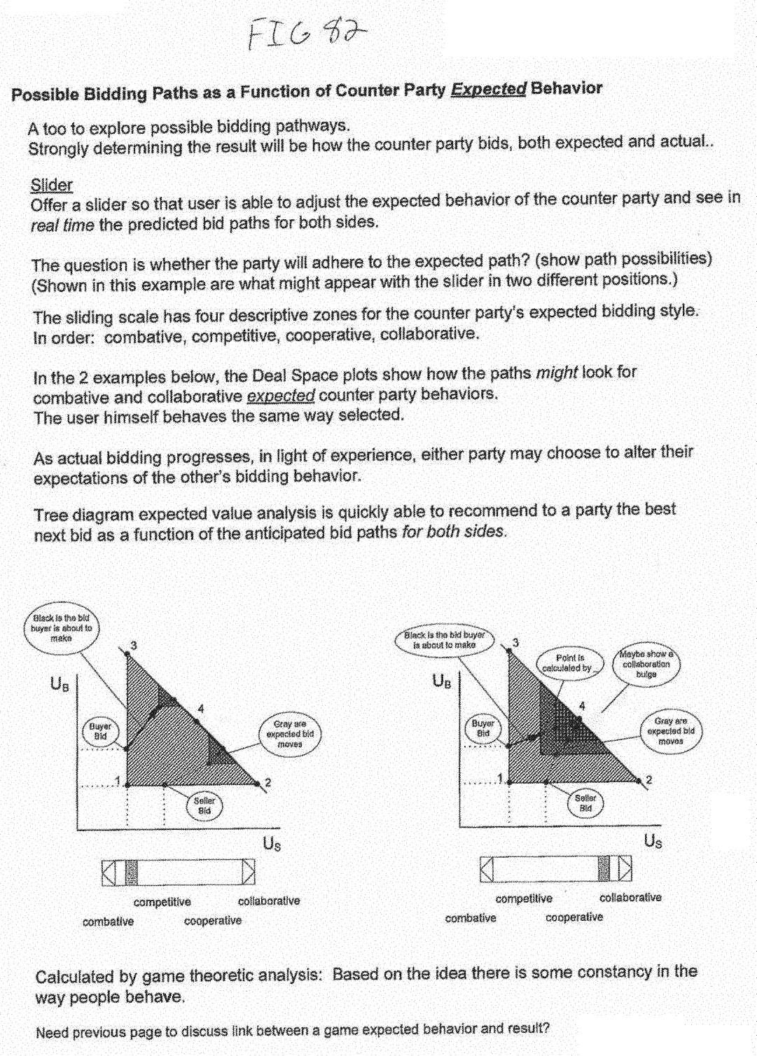

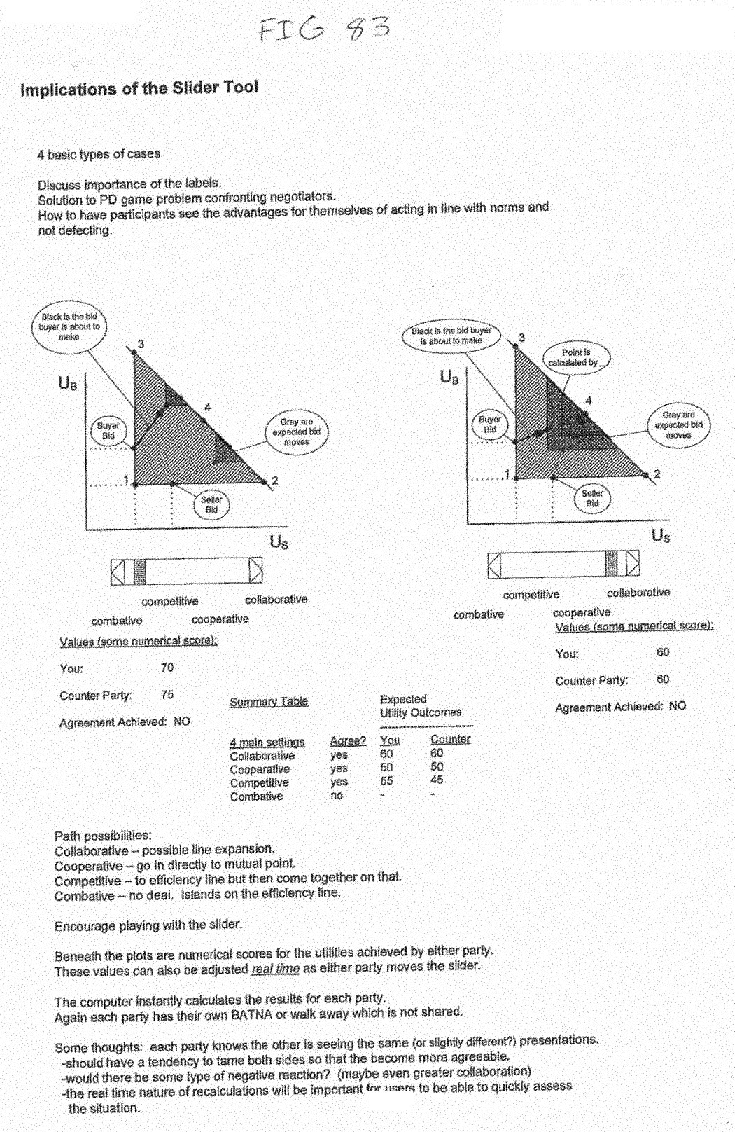

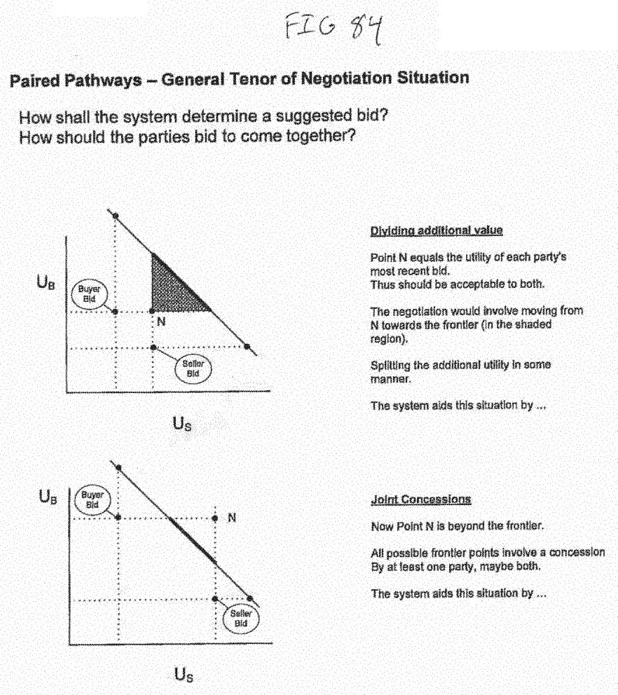

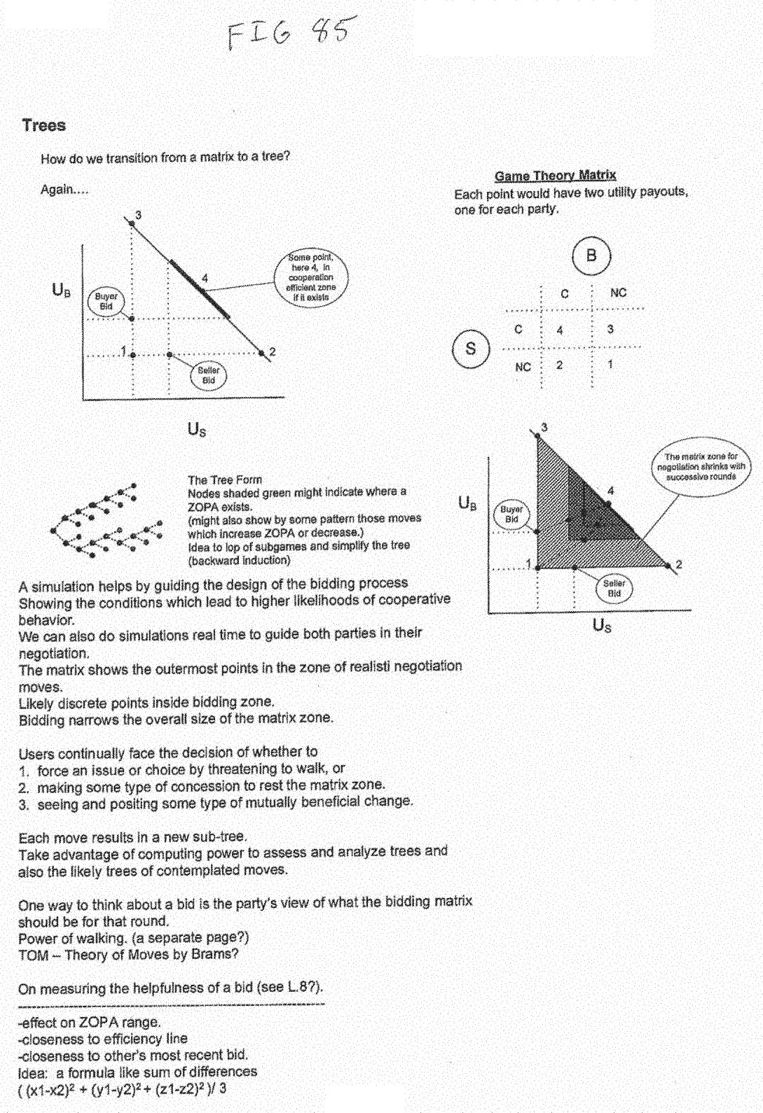

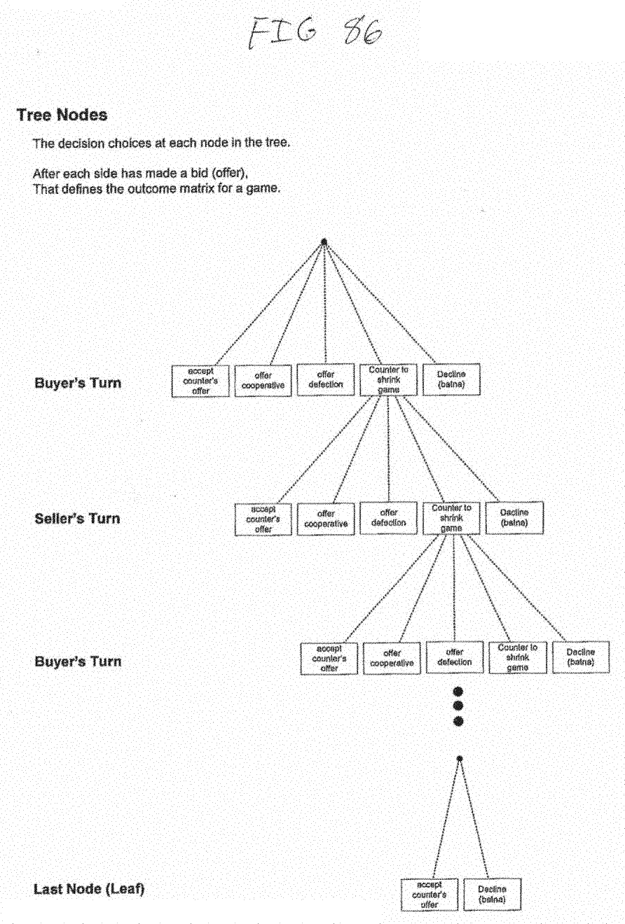

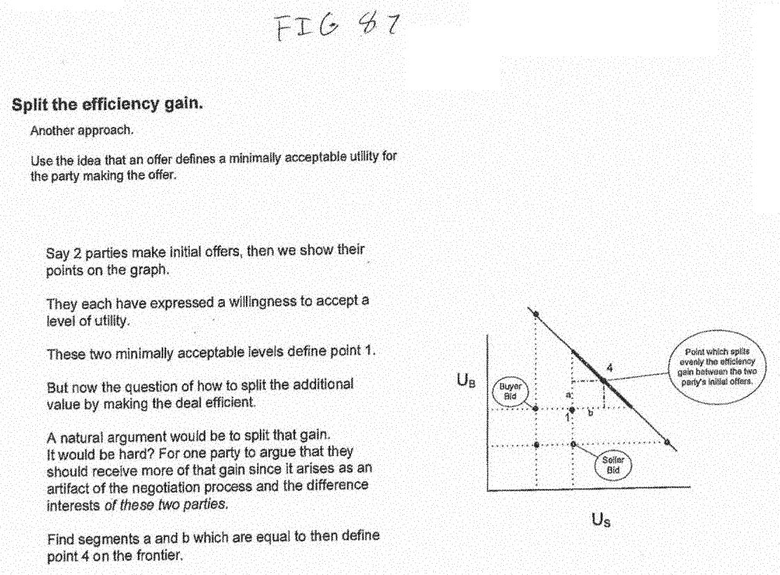

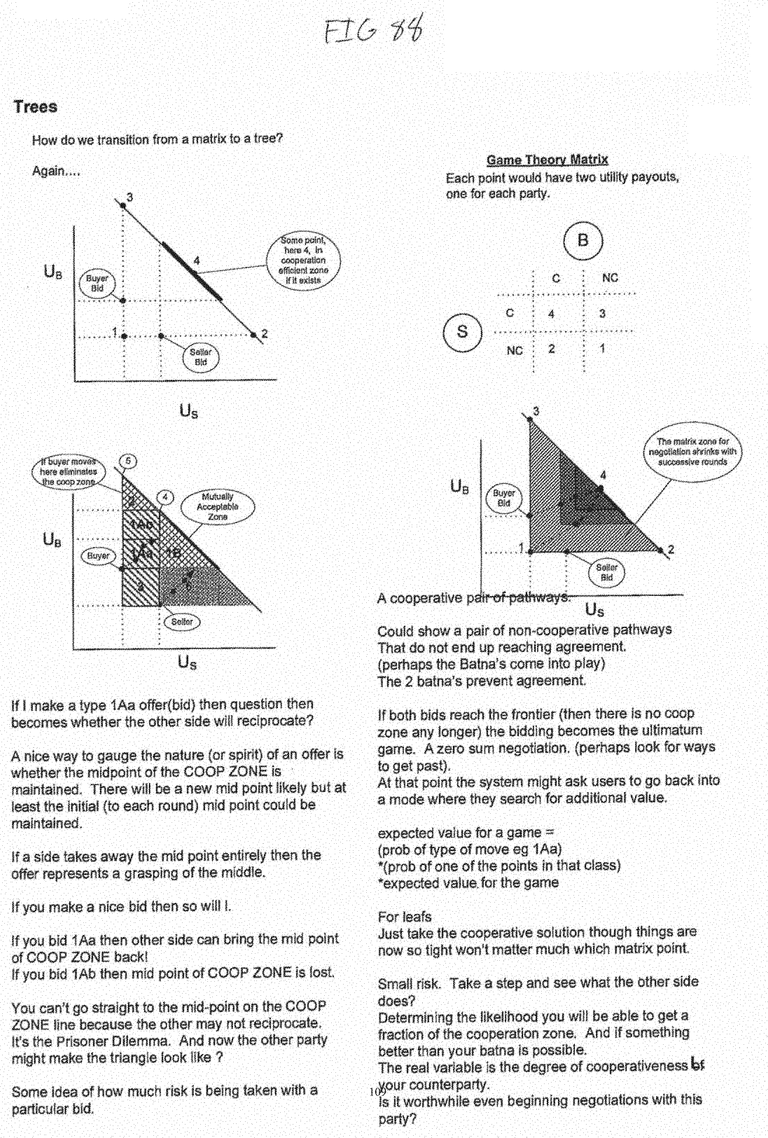

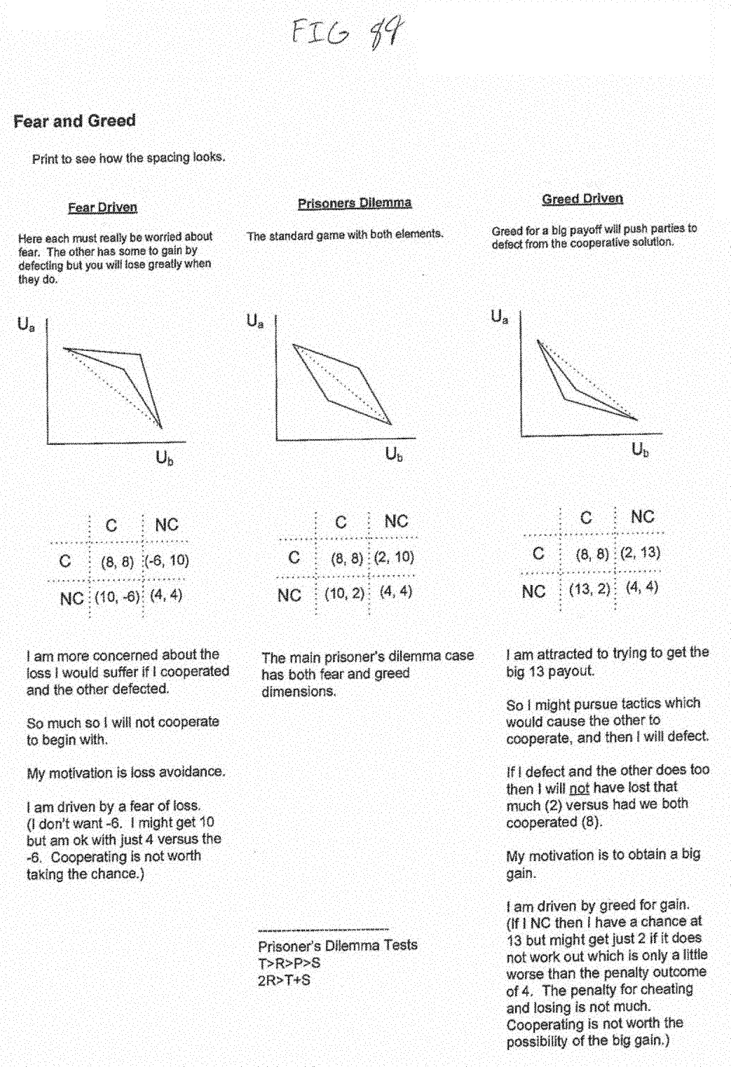

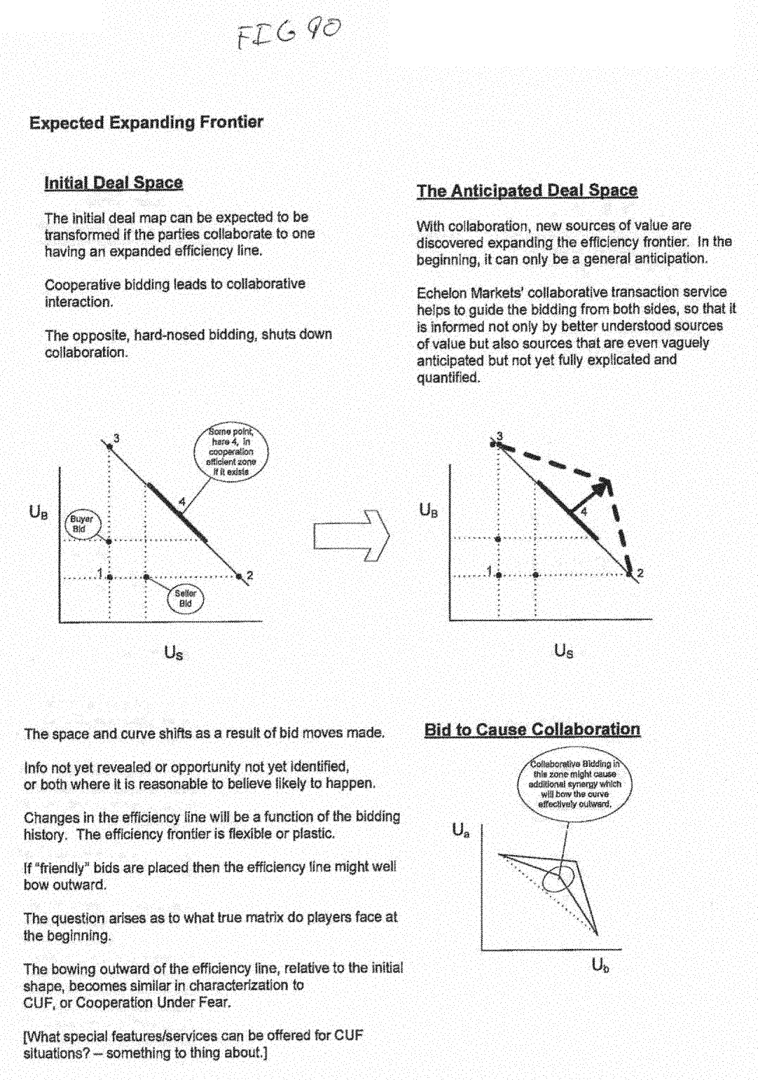

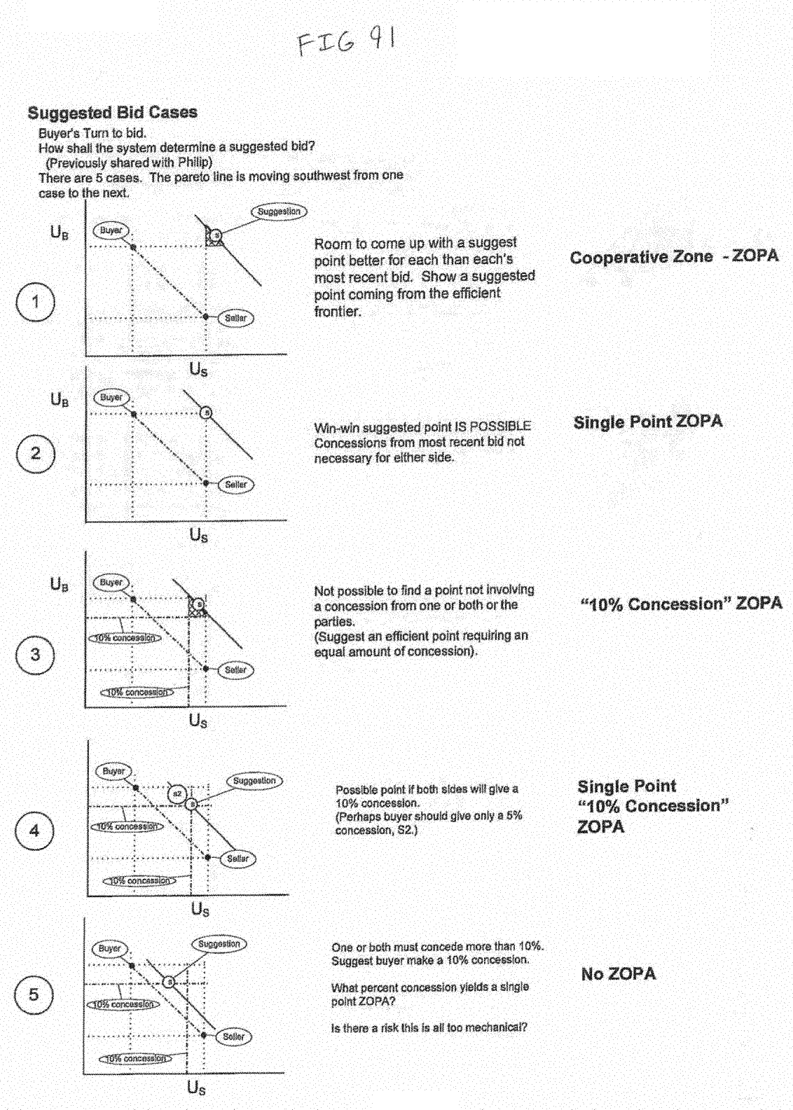

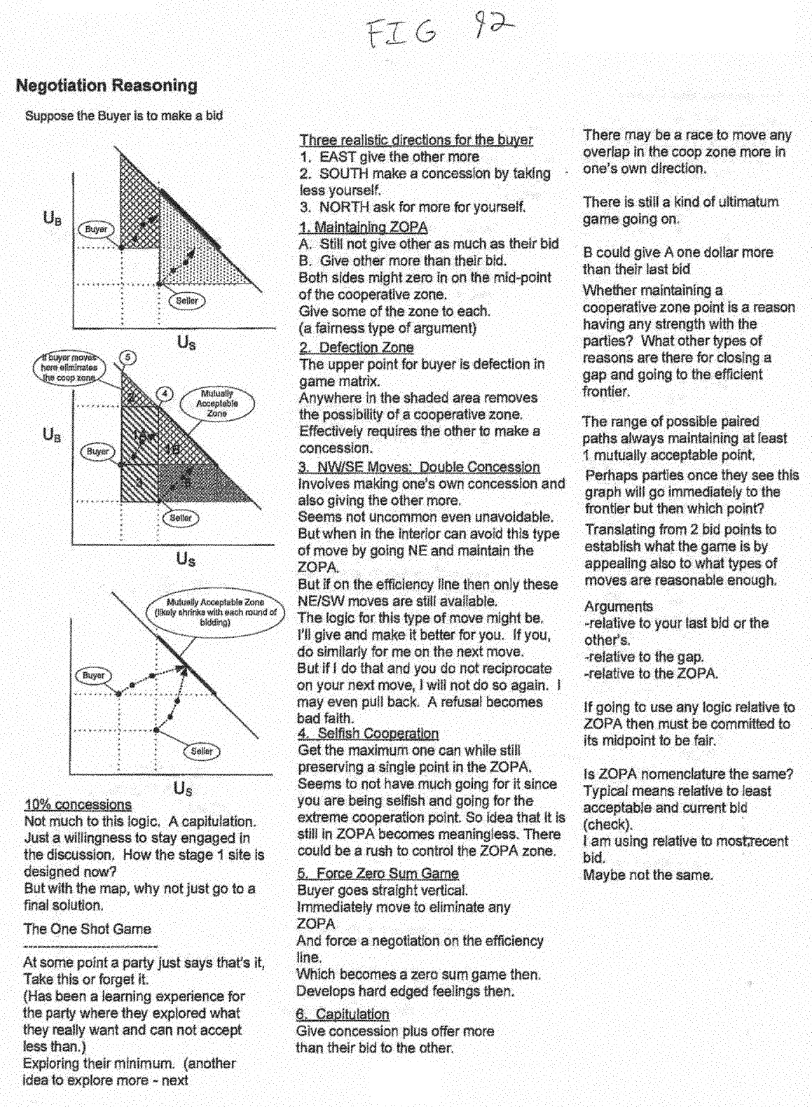

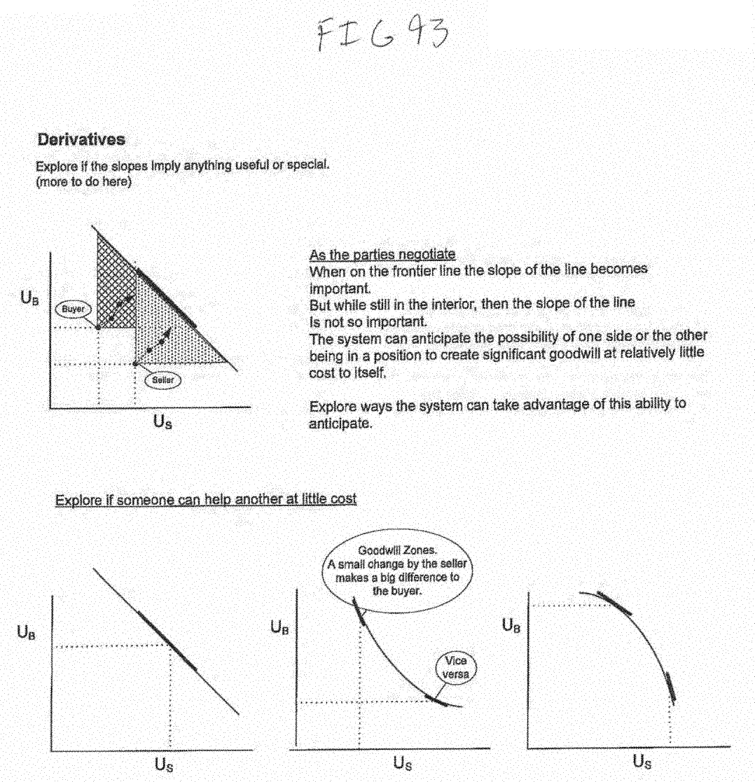

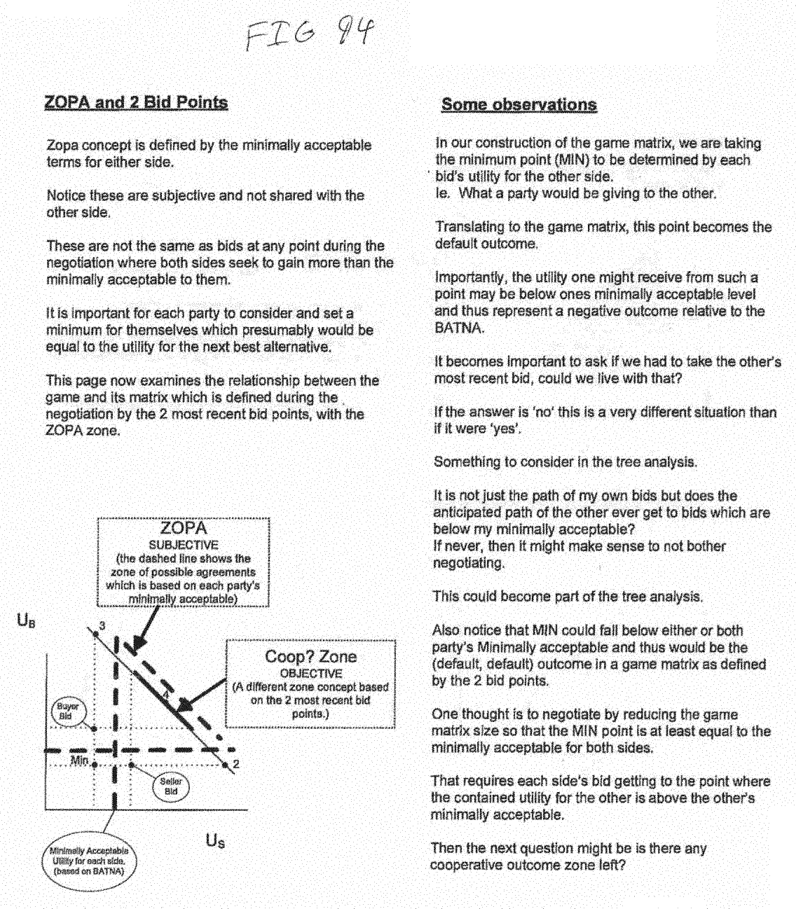

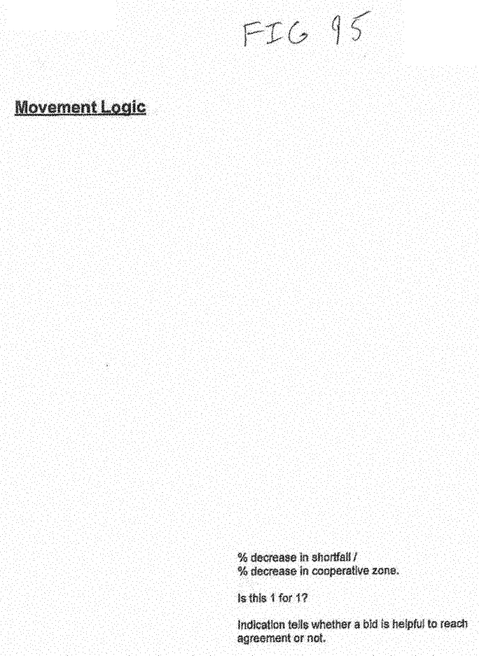

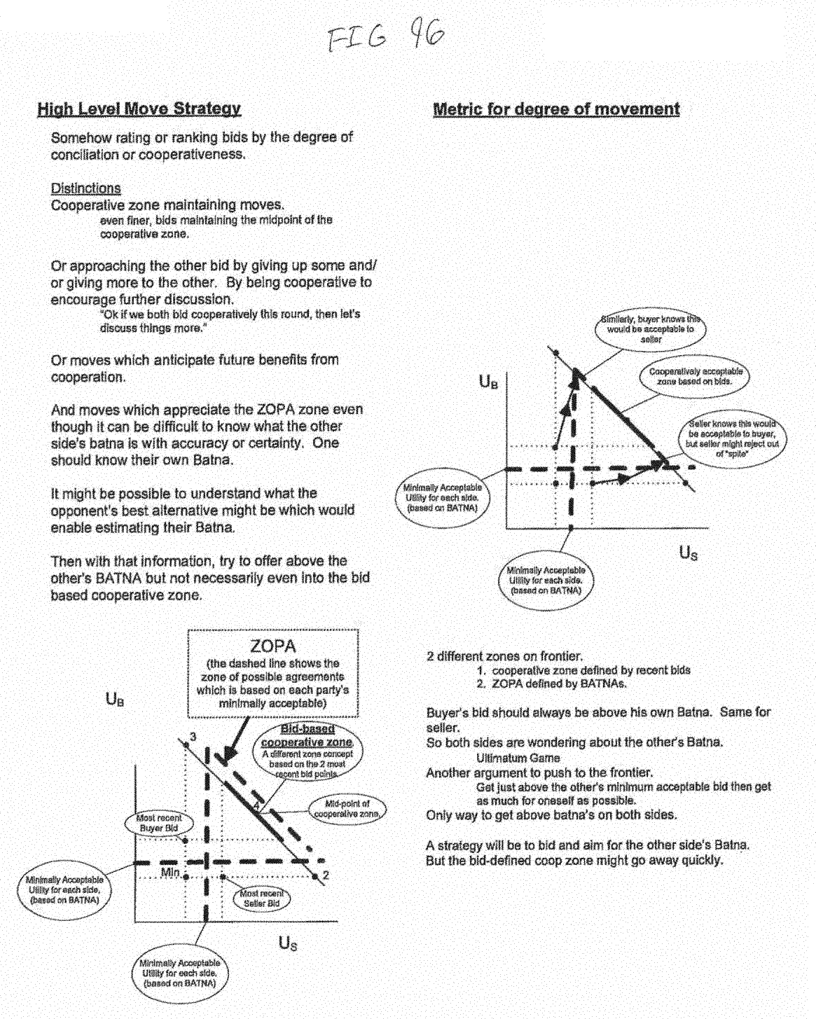

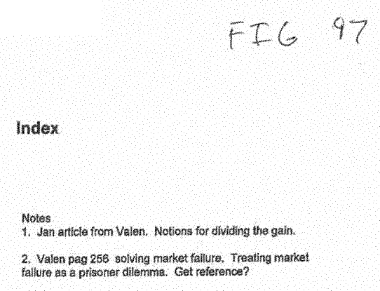

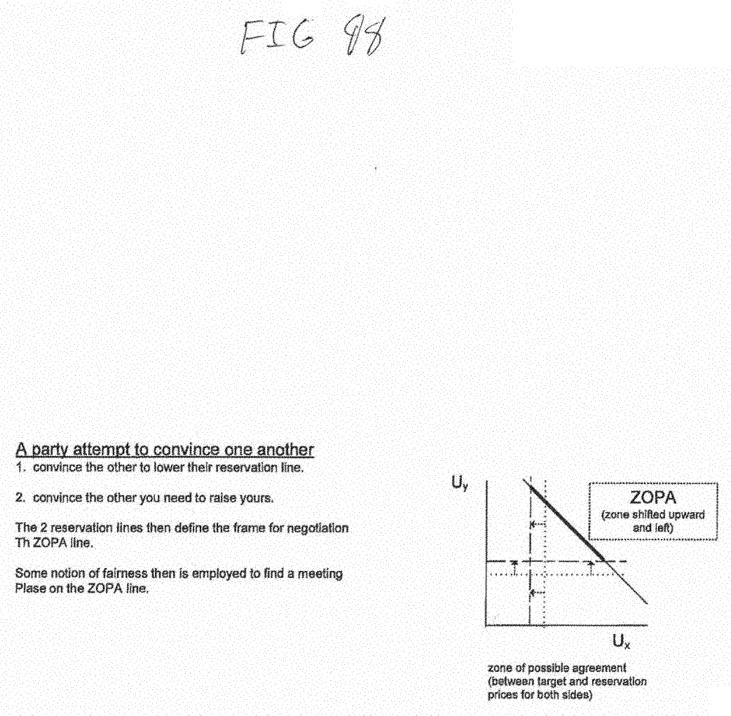

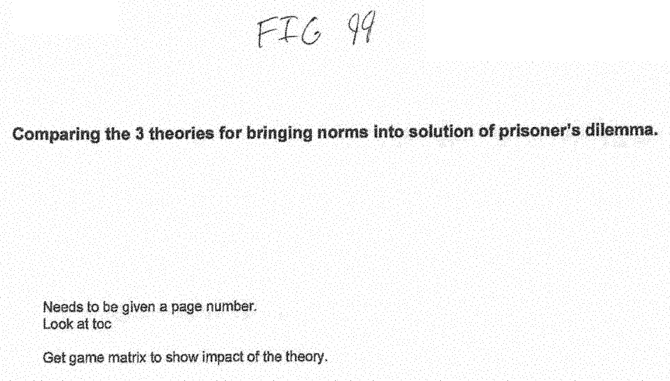

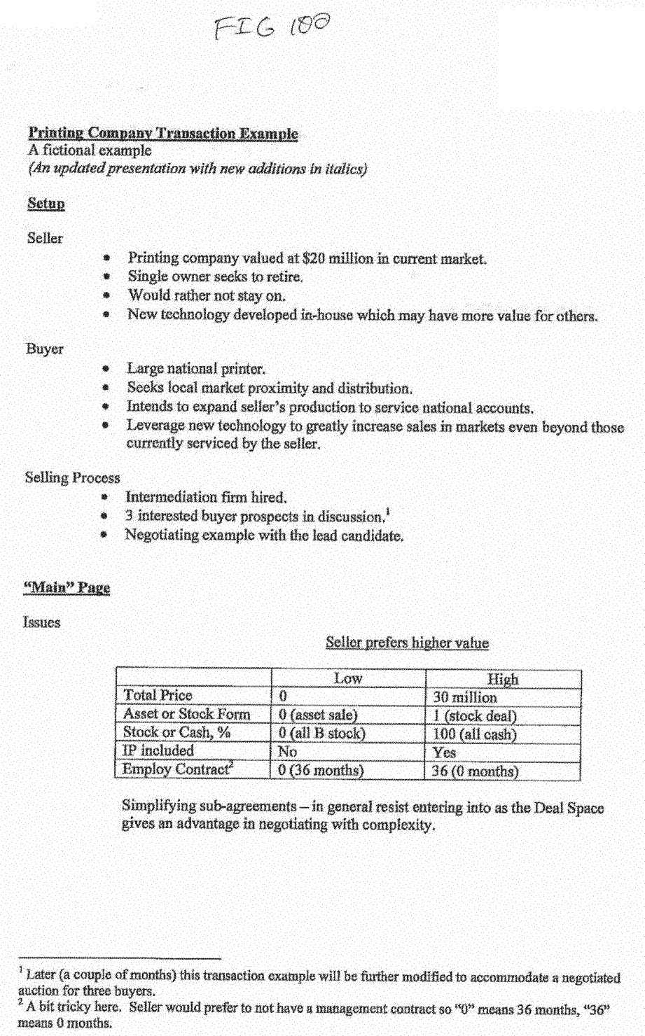

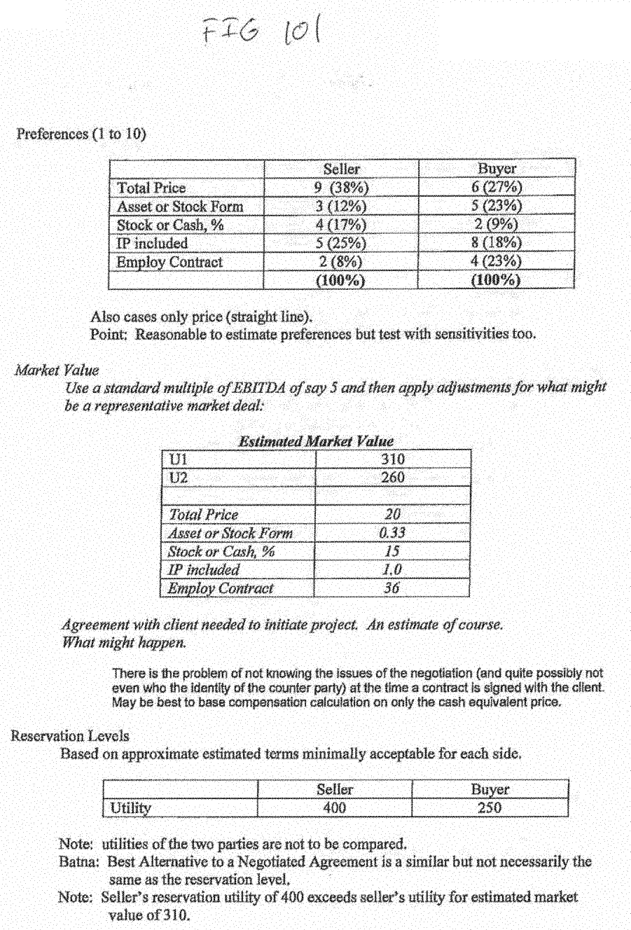

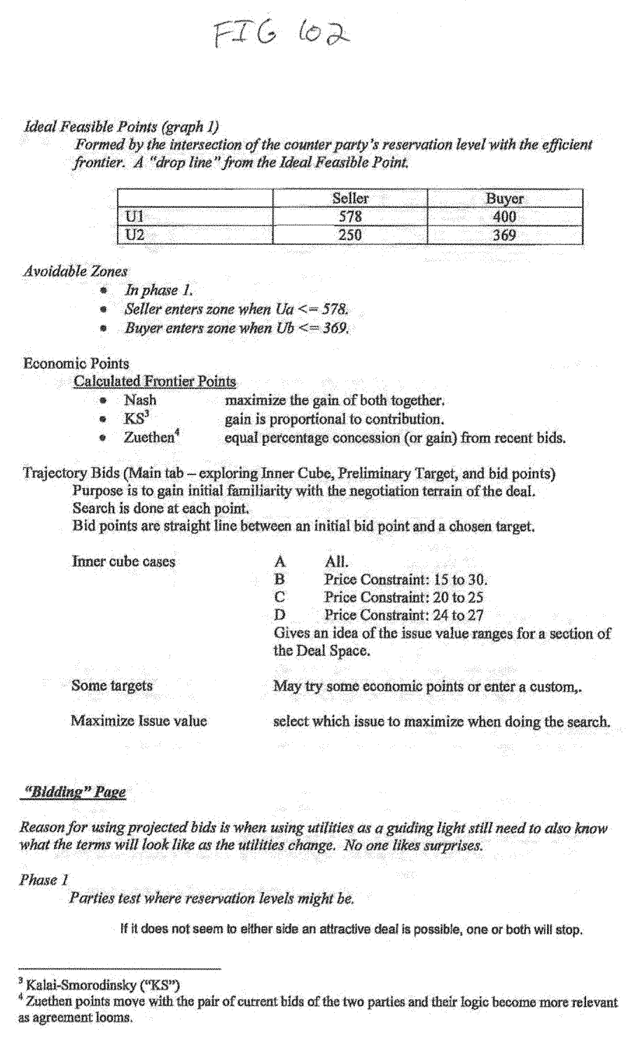

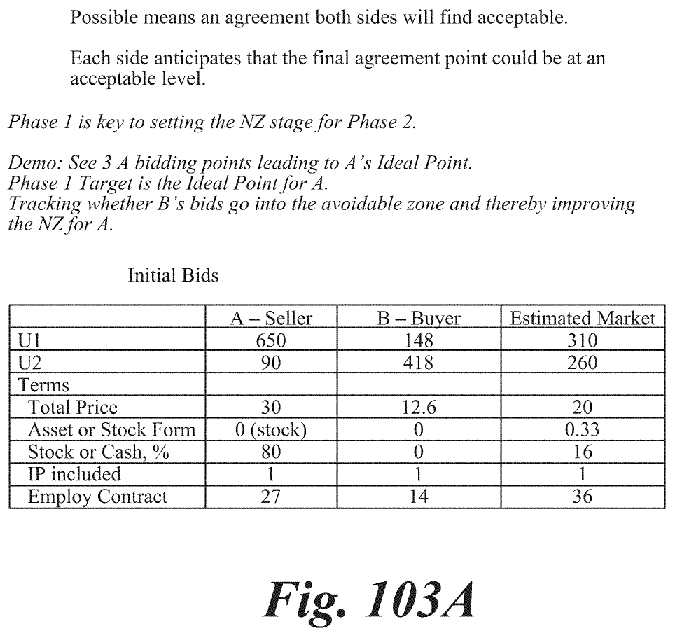

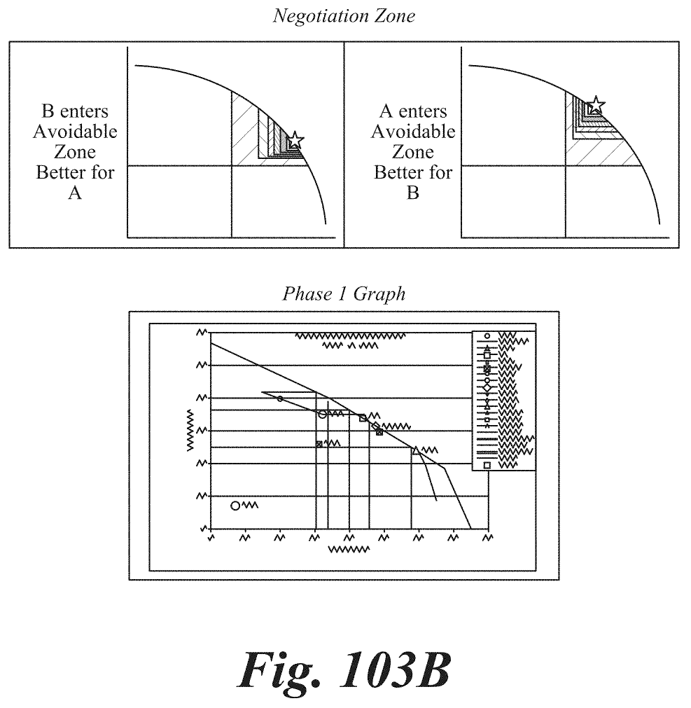

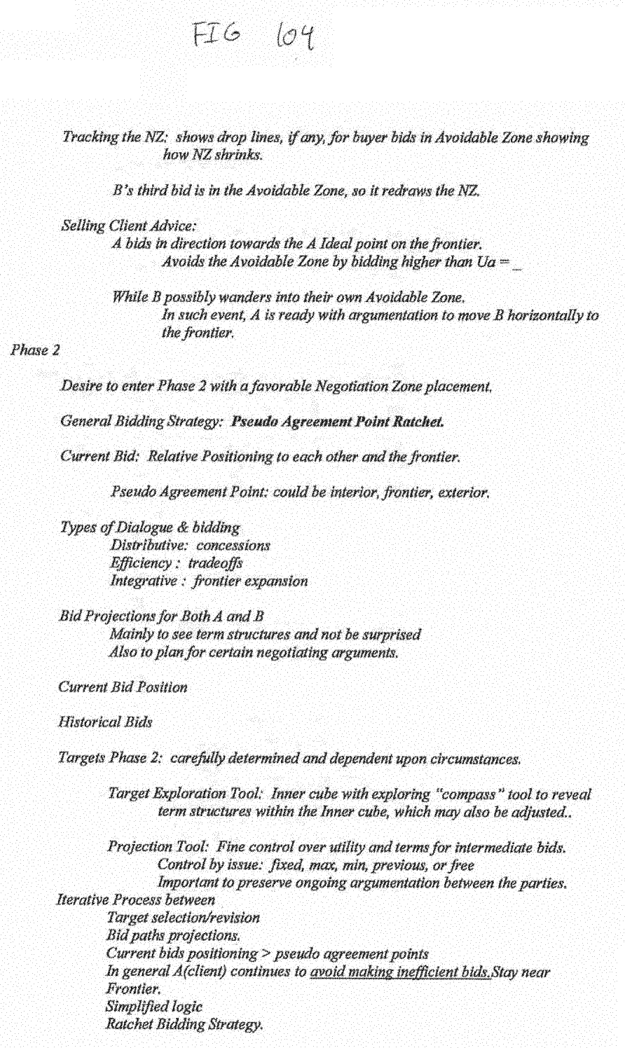

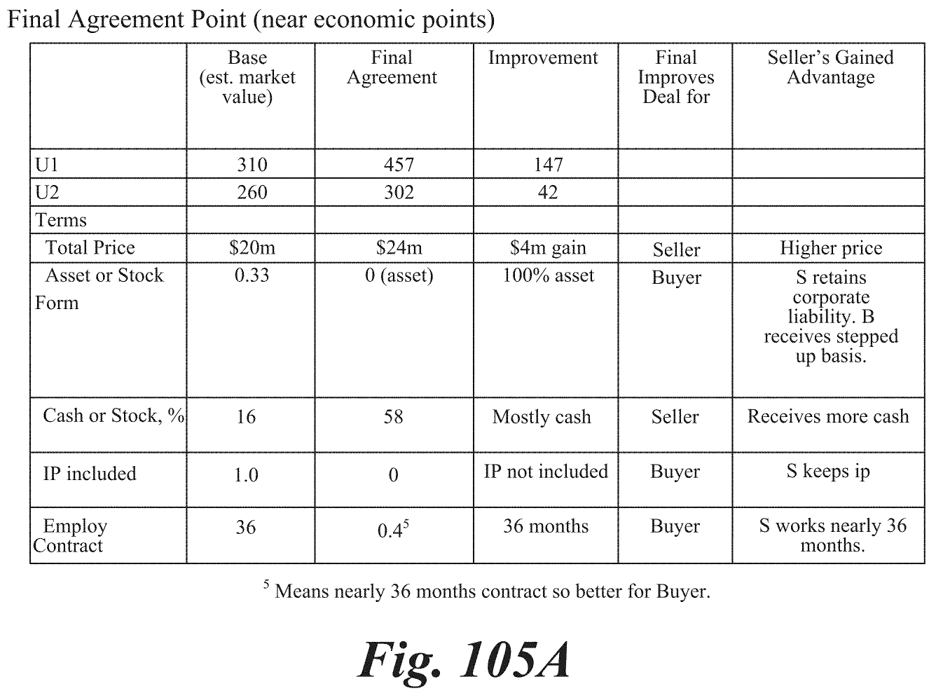

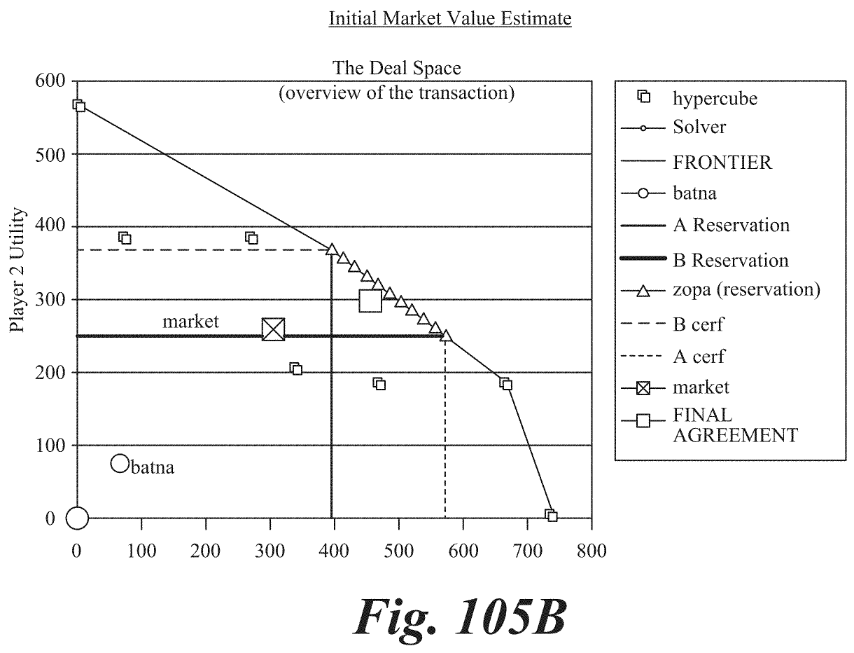

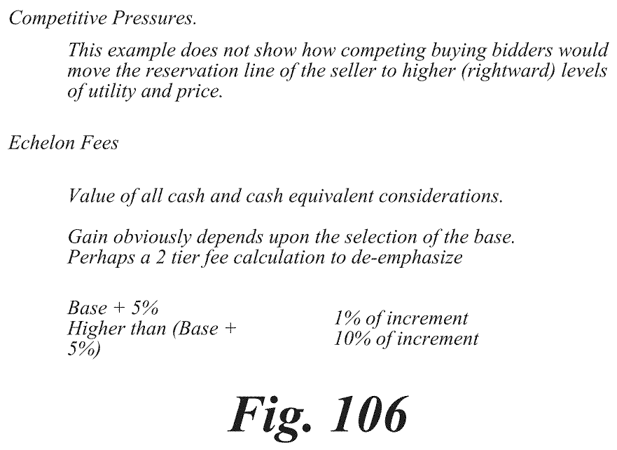

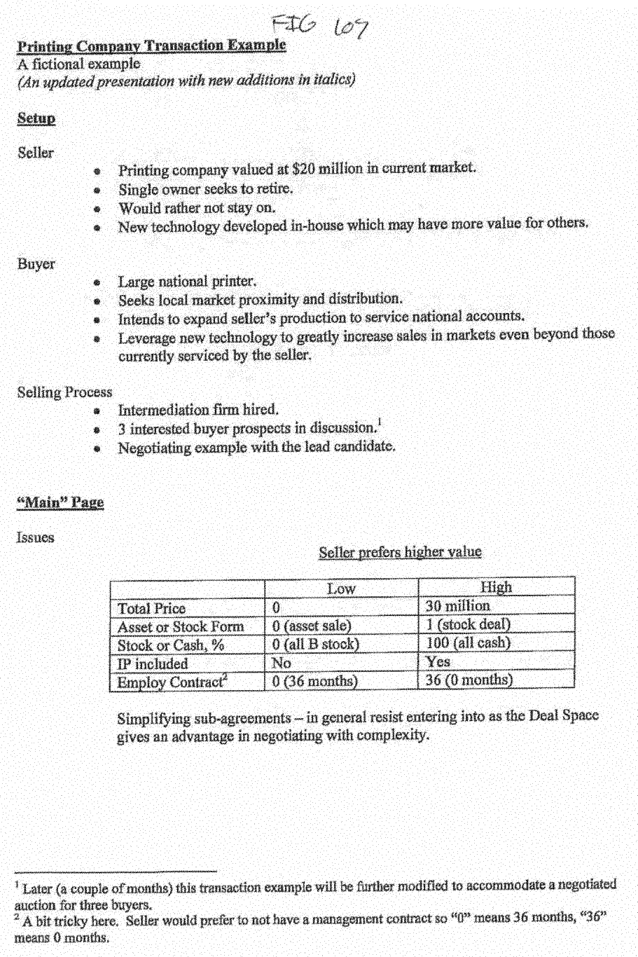

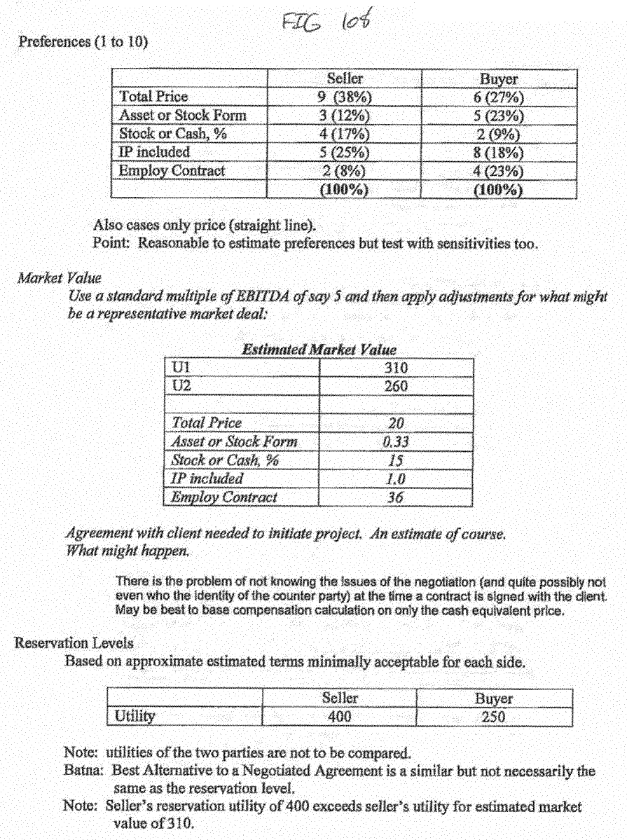

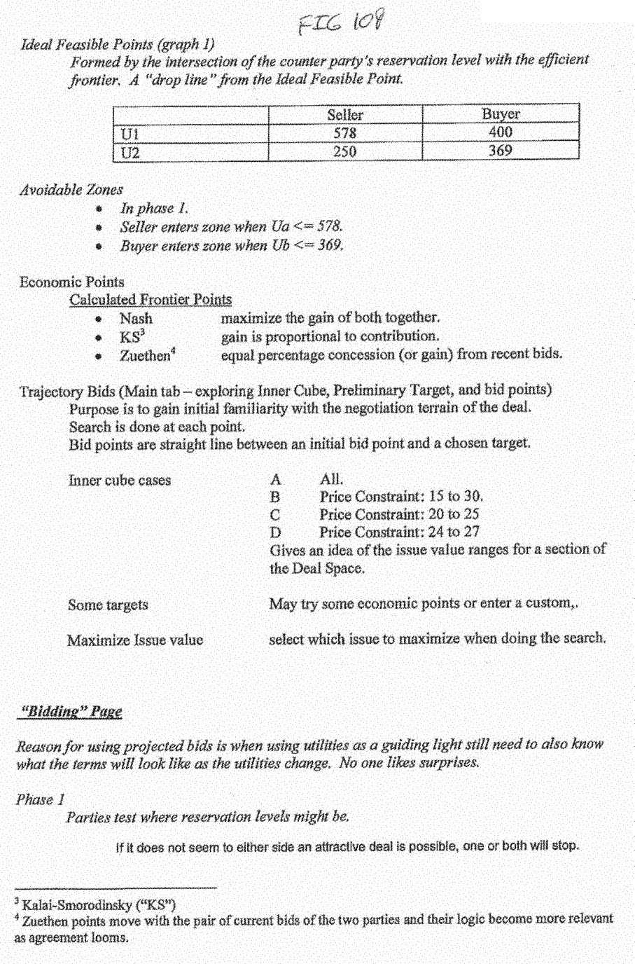

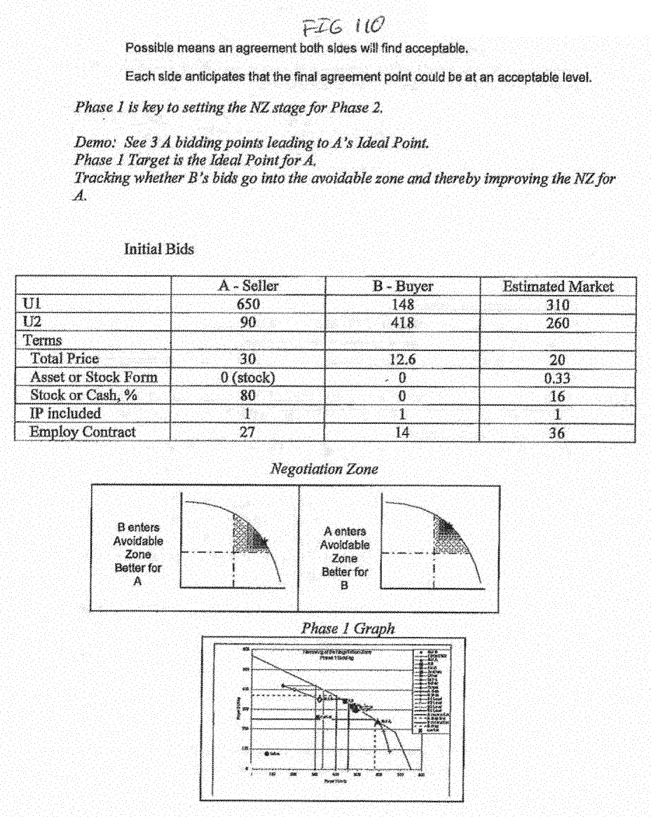

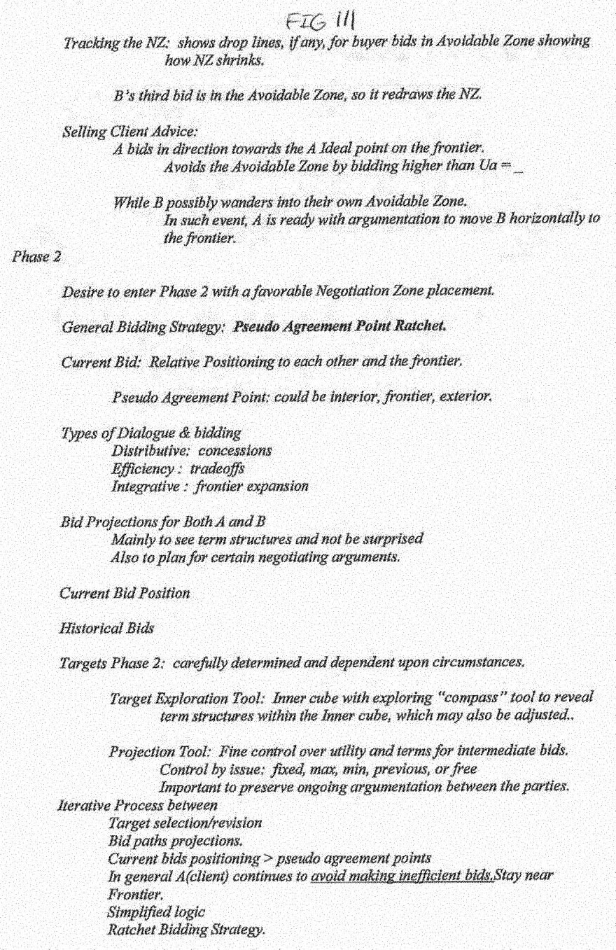

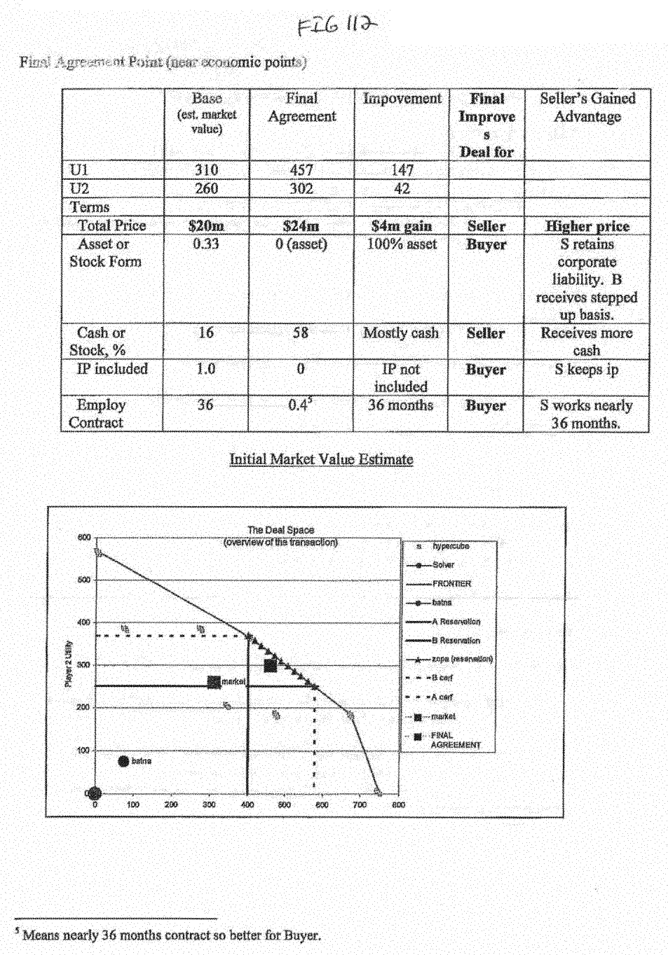

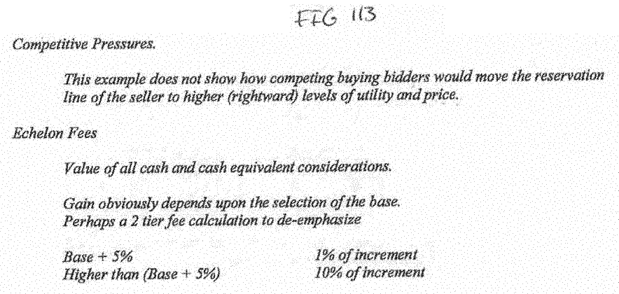

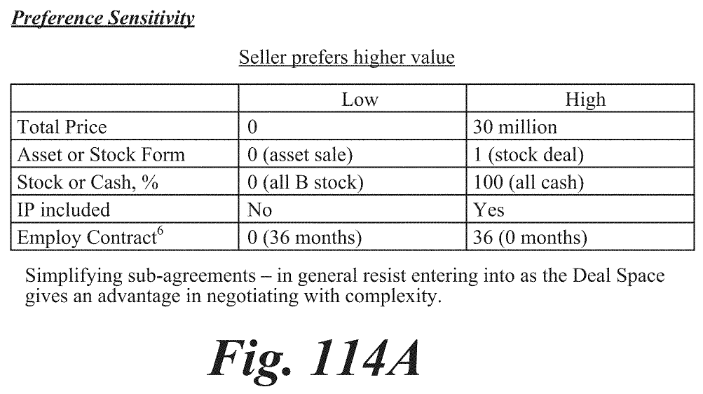

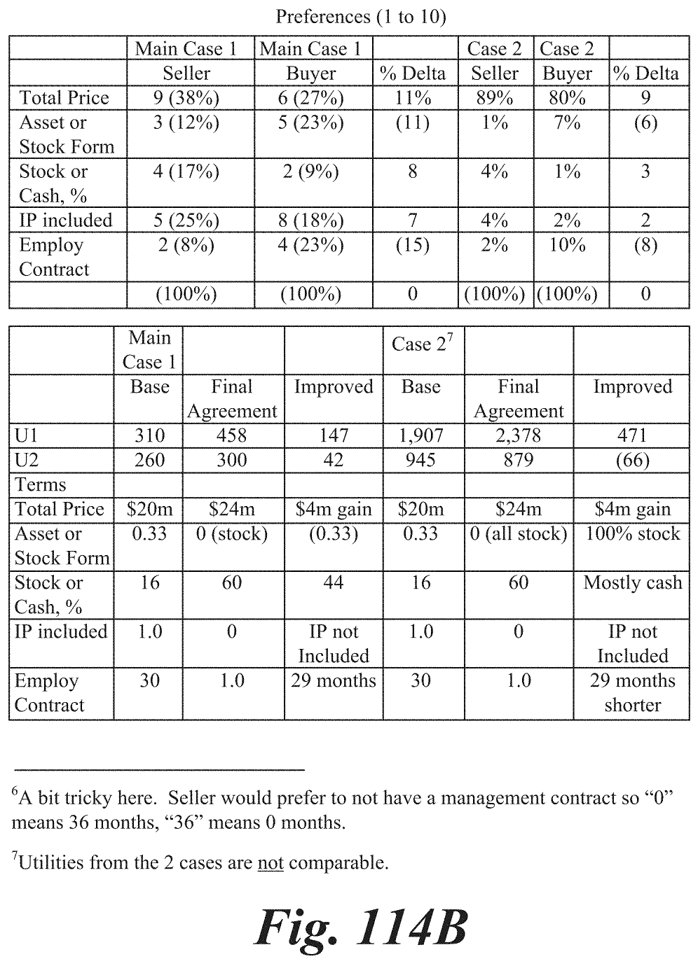

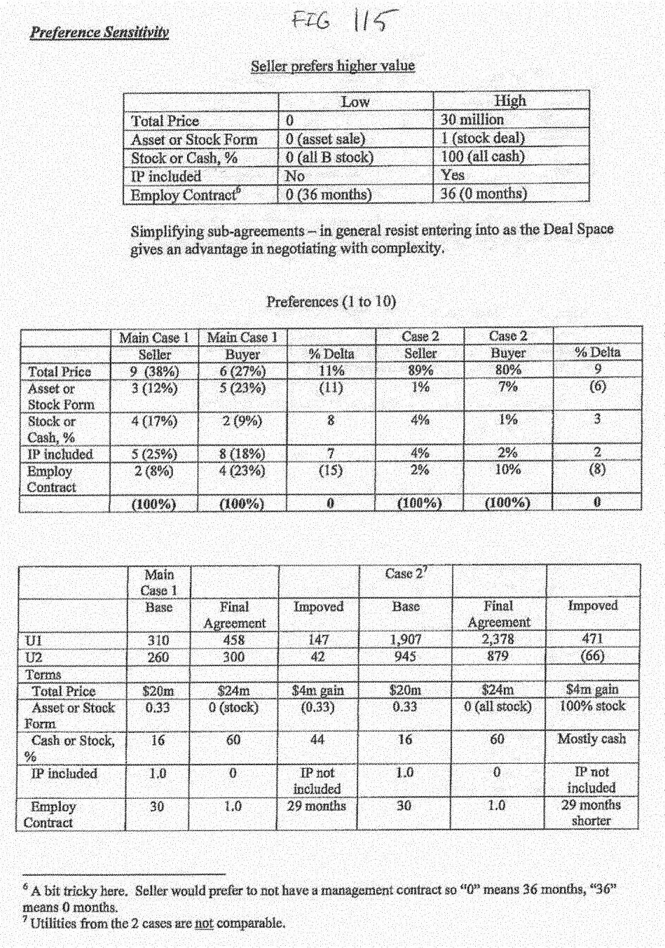

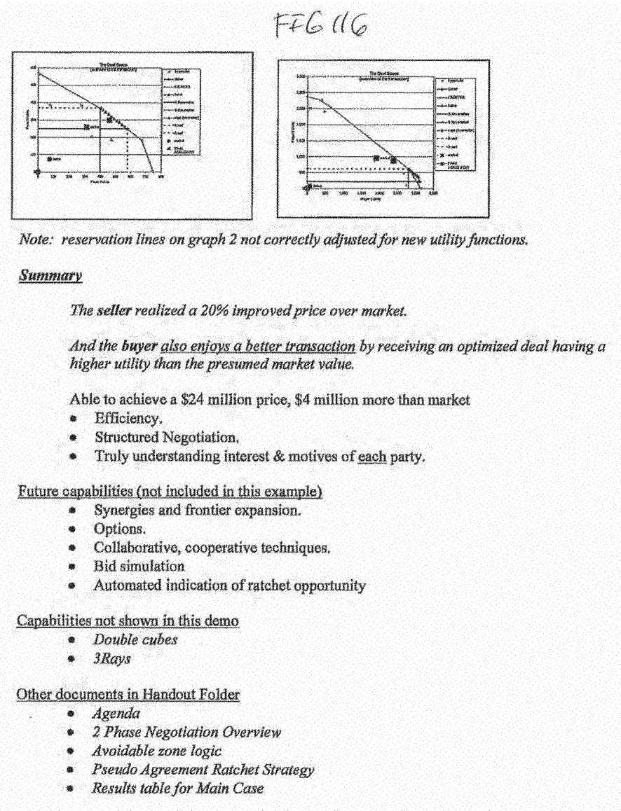

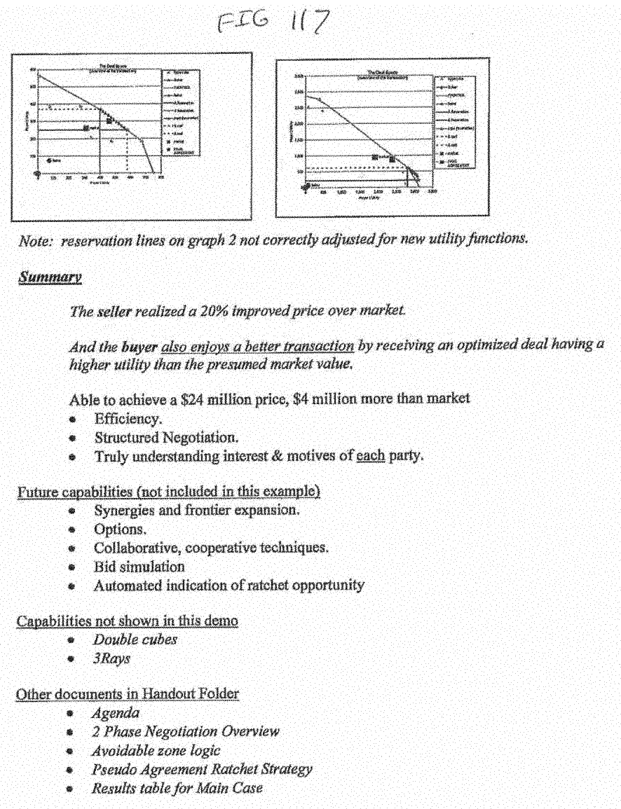

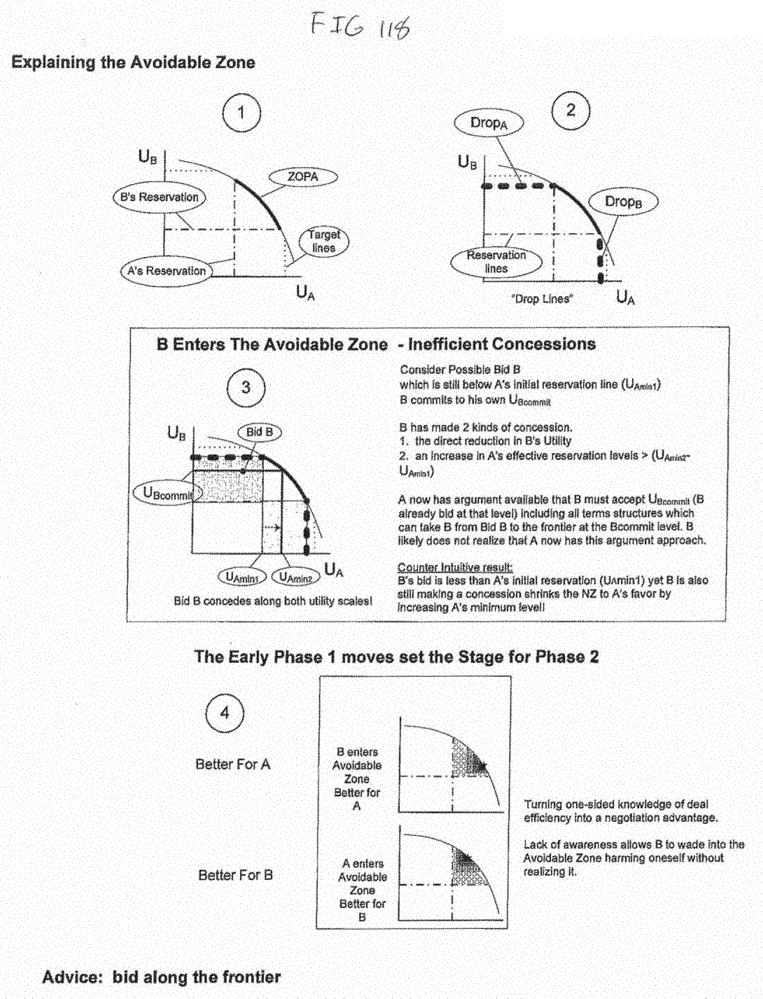

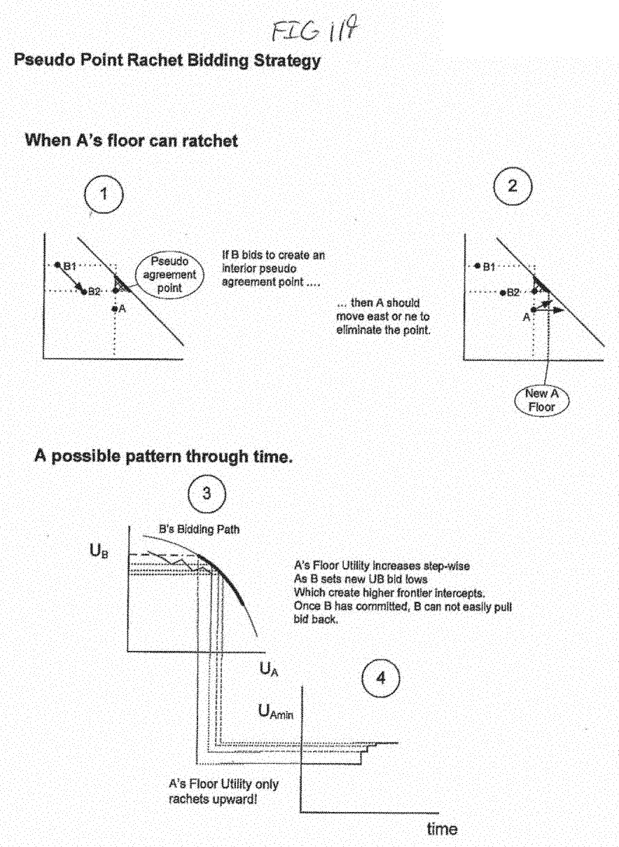

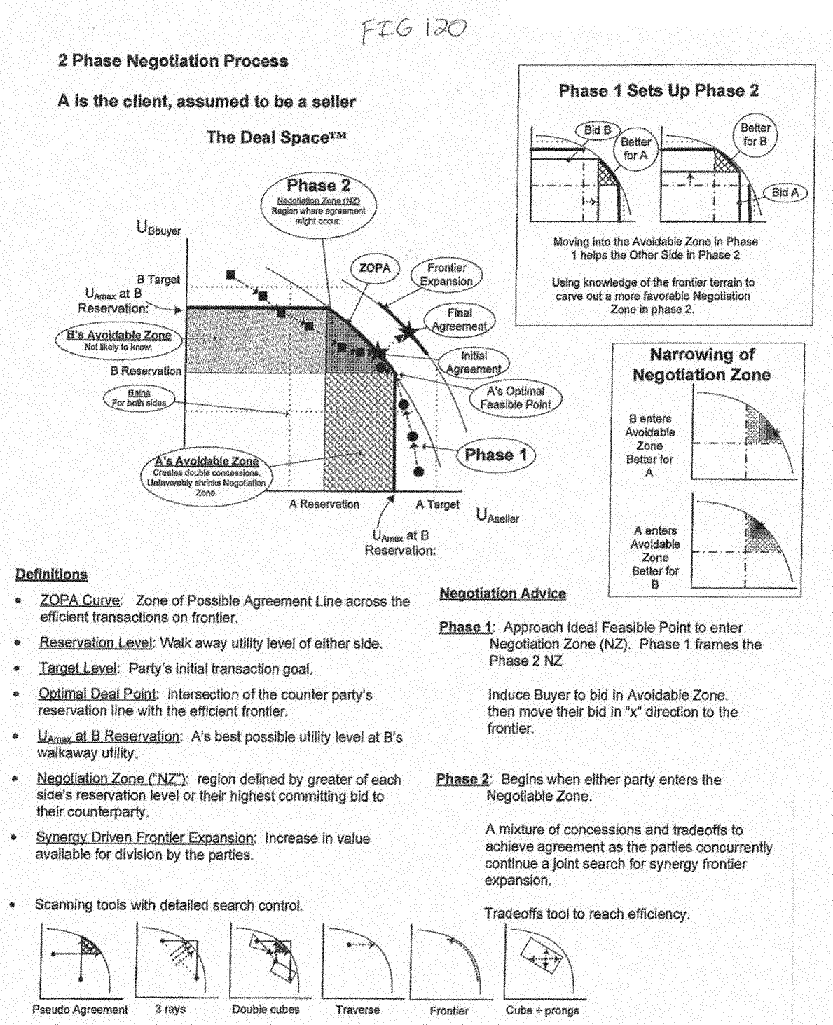

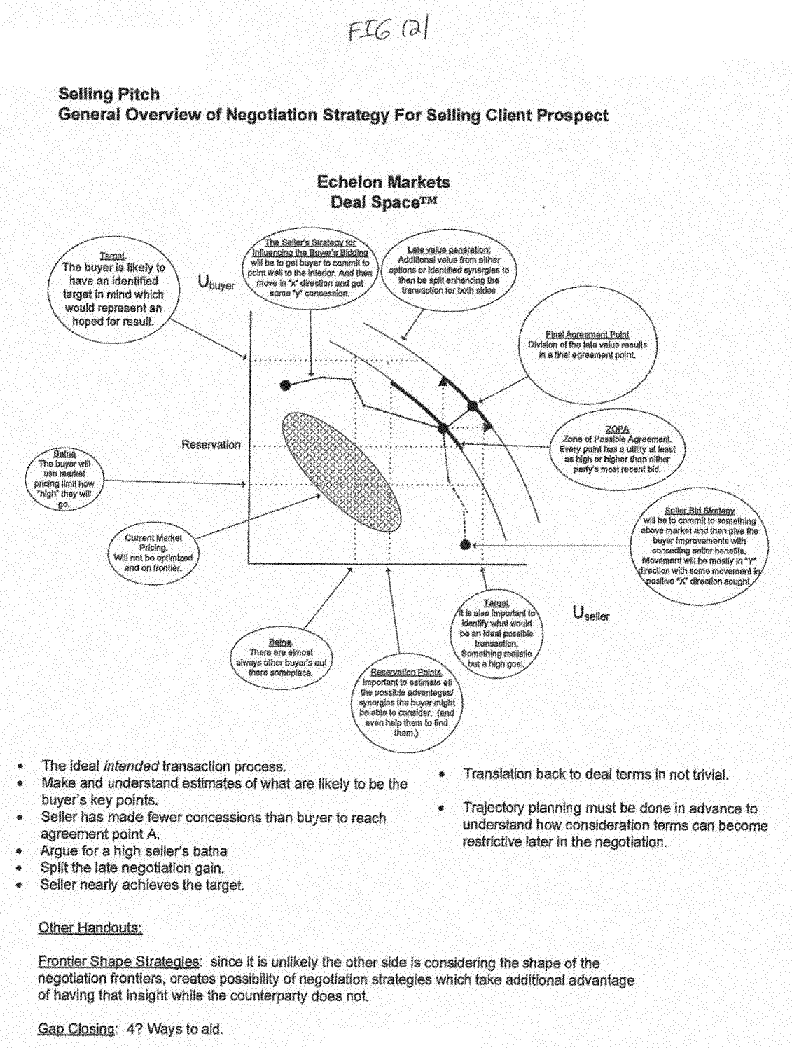

### DETAILED DESCRIPTION OF THE INVENTION

The present invention is directed, inter alia, to provision of computer systems providing graphical presentations which (1) calculate and display total satisfactions and/or utilities of the parties in a negotiation for all possible deal terms, (2) capable of use by one or more parties to a negotiation, (3) provides a holistic perspective of the transaction with frequent prompts reevaluation of goals, (4) provides a 2-phase negotiation process that mirrors actual negotiations, (5) provides bidding strategies by giving a user information concerning both the negotiation terrain and the interest efficient frontier, (6) provides a dashboard graphical user interface for the negotiation process, (7) calculates and displays the interest efficient frontier which is the line of points for which there are no remaining available win-win issue tradeoffs, (8) accommodates human tendencies which block negotiators from achieving optimal agreements.

More particularly, in embodiments of the present invention seven key benefits are provided by the computer system providing graphical presentations where (1) advantageous tradeoffs are identified, (2) the efficient frontier for each transaction is displayed, (3) reservation line term structures are identified for both sides, (4) self-insight comparisons of alternative structures are provided, (5) identification of deal likelihood is provided by showing whether a zone of possible agreement exists, (6) methods of gap closing are displayed, and (7) counter-party bidding actions are anticipated and presented. Basic functions such as user account creation and invitation by user's to negotiating parties are provided by the system software which operates in a networked environment—either a local area network or a network such as the Internet.

In embodiments, a statistical estimate of value shortfalls for a historical or contemplated transaction is provided as against the efficient transaction. Preferably these estimates fall within a 5-10% range.

Negotiated deals are usually composed of some number of negotiable issues, each needing to be agreed upon in order to achieve an overall agreement. Tradeoffs amongst these issues often made during negotiation are able to increase the benefit to a party on one of the issues in exchange for increasing the benefit on another issue to the counter party. Normally after both sides have agreed upon everything, the whole package valued by converting each issue agreement point to a monetary value, all of which are then totaled to yield an objective measure of the transaction's total value or price. In current practices, each issue is valued using a single common measure, almost always a currency.

In embodiments, a two-dimensional deal space graphical presentation is created plotting the overall satisfaction for each party for all possible deal structures. This provides an immediate view of how attractive any proposed deal is to either party. In embodiments the graphical presentation is aided by search tools and makes clear how to alter deal terms so that the overall satisfaction levels of both parties are simultaneously increased. This provides a deal space map of the negotiation terrain. Provision is made for overall subjective value assessments to ensure that individual issue assessments are not lost and are available to drive issue tradeoff decisions during negotiation.

In embodiments deal evaluation is modified by deliberately delaying the reduction of transaction terms to an objective currency value. Temporary currencies for each side, termed utility for each side, are used so that the overall value to each party of any deal may be determined and used in comparisons. Users create said utilities by ranking their preferences for each issue. The culmination of this ranking process is a pair of total subjective views of overall value for all possible transaction terms. Such utility pairs are mapped in the deal space graphical presentation. Secondly, the exchange rate between the utility points is found by negotiated agreement.

Market efficiency generally means that all information is appropriately reflected or taken into account by the market mechanisms setting price. Information may be defined in more or less inclusive manners. Private negotiated markets are not liquid, however as a parallel to a liquid market, in a negotiation all of a party's preferences are taken into account, as much as possible, within the logic of a deal's constraints.

In embodiments, transaction structure is optimized by displaying the combined effect on each side's total utility for any number of modifications to the terms for the issues. Preferably said display is of the impact arising from all possible variations in term structure and is most preferably displayed in a mathematical manner.

In embodiments, in order for a user to utilize the deal space, it is necessary to translate from utility points back into deal terms. When there are a great number of deal issues the translation becomes complicated. For example, each utility pairing point may potentially map to many different deal terms. To overcome these difficulties, embodiments of the present invention provide specially designed search tools capable of allowing a user to search for and select the most desirable available deal terms for any identified utility point and negotiation situation given user objectives and interests.

In further embodiments, a computerized prediction tool is provided which gives a user the ability to predict what term structures for their own offers a counter party will accept or not. Still further the ability to predict counter party bids is provided. Since the deal space interface shows bidding patterns according to overall satisfaction, it reveals counter party bidding strategies.

In embodiments the deal space system is set up for each negotiation. As a first step deal issues are identified as well as the ranges of their possible values. Second, preliminary values are entered about both a user's issue preferences as well as the user's perception of the counter party's issue preferences. Different preference values can be entered when there is uncertainty about the counter party's real interests.

A two-phased negotiation process then begins. Phase one is the determination from early bids by both sides of whether an agreement is possible. Based on the early bids each user judges whether there will be overlap between that they could accept that the other party might also accept. Phase two begins when a user enters the negotiation zone by making a bid that is above the other party's estimated reservation line. This is defined as the region where the respective utilities equal or exceed the reservation or walk-away utility. That is, the position beyond which a party is unwilling to go. The parties then make concessions, seek tradeoffs, or seek win-win gains from integrative considerations.

In embodiments, negotiation bidding strategies are provided to a user. For example, strategies based on the concept that a counter party may be unaware of the negotiation terrain and may unknowingly make concessions to the user's effective minimum. In avoidable zone bidding a user may make a bid which inadvertently raises the other side's reservation minimum. When a party enters its avoidable zone it becomes an unwitting concession to the floor of the counter-party. In ratchet bidding the counter party inadvertently raises the first party's minimum floor price simply from bidding action.

In embodiments, the negotiation dashboard user interface displays on a single screen all important content including bidding advice controls enabling a user to gain insight into negotiation context, historical bidding positions, and anticipated bidding positions.

In embodiments the deal space system begins with the basic assumption that users will act consistently and without violating preference transitivity (e.g. if A is preferred over Band B is preferred over C, A will be preferred over C). Users may modify the basic assumption at any time, for example such that is does violate preference transitivity.

The deal space system presents users with a map of the negotiation terrain where utility is a holistic evaluation of a transaction structure and is used to identify and evaluate tradeoffs among any number or even all issues in a negotiation.

In a yet further embodiment, dynamic bidding simulations may be run with the system. As the negotiation progresses, the bidding model learns from the actual bidding behavior of each side, and continuously updates to further improve the assessment of each bidder's motivation.

### Example 1

Merger & Acquisition Transaction

During an initial meeting between the seller and buyer each side presents to the other their objectives for the transaction. This sets the negotiation issues. Once set the parties proceed to use the system software to assign a range of possible values to each negotiation issue. Preferably both sides set broad ranges with some overlap and are encouraged to do so by the system software and/or user guidance materials. Once the range of possible values is set for each issue (likely the union of both sides' estimates), the issues are then weighed by each of the parties. The weights are assigned by level of importance of each issue to the party setting the weight—thus each issue will have two weights. The frontier line is defined negatively as those points having no other points having both a greater x and y value (nothing in the “northeast direction”). Such opening bids can be done simultaneously. Further bidding then occurs with the system software making suggestions to each party—for example the system software may suggest a reduction of some percentage from a user's own utility. Preferably, such suggestions may be made to align with the frontier and thus be efficient suggestions (e.g. win-win suggestions). The system software may also suggest that an accepted proposal, e.g. an agreement, is not on the frontier and suggest an alternative that would be more efficient for both parties.

### Example 2

Mock Dialogue for Setup of System

On negotiation strategies, the system suggests several possible strategies but the user can also create customized strategies.

Once the deal space is setup, bids are made:
At this point the parties negotiate back and forth, by submitting bids, to see whether they may find a common ground.

There are 3 aspects which help them to find agreement.
1. Expansion into a dispersed cloud of points.
2. Discovery of additional synergies (integrative bargaining)
3. Options to bridge certain gaps.

Reference for the discussion hereinabove is made to the source code appendix appended to this application and incorporated by reference from U.S. Provisional Pat. App. No. 62/276,825, pages 401-530.

While it is apparent that the invention herein disclosed is well calculated to fulfill the objects above stated, it will be appreciated that numerous modifications and embodiments may be devised by those skilled in the art. It is intended that the appended claims cover all such modifications and embodiments as fall within the true spirit and scope of the present invention.

1. A system for optimizing and displaying negotiation information comprising:
(a) at least one computer,
(b) software which generates an interface on said computer wherein said interface displays:
(i) advantageous tradeoffs which are identified by said software,
(ii) an efficient frontier for each transaction is displayed which is calculated by said software,
(iii) reservation line term structures are input to the software for one or more sides to a negotiation,
(iv) self-insight comparisons of alternative structures are displayed by the software,
(v) deal likelihood is provided by displaying whether a zone of possible agreement exists between two parties,
(vi) methods of gap closing are displayed, and
(vii) counter-party bidding actions are anticipated by the software and displayed.

2. The system of claim one where the at least one computer is connected to one or more computers via a network.

3. The system of claim 1 wherein the software employs an artificial intelligence learning algorithm that receives and analyses prior bidding activity to anticipate counter-party bidding actions.
